(19) United States
(12) Patent Application Publication
(10) Pub. No.: US 2025/0178166 A1
(43) Pub. Date: Jun. 5, 2025

(54) CONCENTRATED LONGITUDINAL ACOUSTICAL/ULTRASONIC ENERGY FASTENER DESIGN AND MANIPULATION SYSTEM HAVING AT LEAST ONE OR A PLURALITY OF FLEXIBLE ULTRASONIC JOINTS

(71) Applicant: Gary Lee Ward, Pleasant Hill, OH (US)

(72) Inventor: Gary Lee Ward, Pleasant Hill, OH (US)

(21) Appl. No.: 19/043,846

(22) Filed: Feb. 3, 2025

Related U.S. Application Data
(63) Continuation-in-part of application No. 18/661,890, filed on May 13, 2024.
Application No. 18/661,890 is a continuation-in-part of application No. 18/056,832, filed on Nov. 18, 2022.
Application No. 18/056,832 is a continuation-in-part of application No. 17/324,770, filed on May 19, 2021, now Pat. No. 11,890,728.

(51) Int. Cl. B25B 21/02; B25B 23/00

(52) U.S. Cl. CPC B25B 21/023; B25B 23/0014

(57) ABSTRACT

A system and method and fastening tool that utilizes ultrasonic or acoustic energy and a horn that focuses the energy into the fastener at a predetermined location in order to facilitate tightening or loosening the fastener. The system, method and fastening tool comprise at least one flexible ultrasonic joint that permits a horn in the fastener tool to pivot in at least one or a plurality of planes and at least partially about at least one or a plurality of axes. The at least one flexible ultrasonic joint is adapted to facilitate transfer and focus of the ultrasonic energy through the tool and toward the fastener utilizing specially designed surfaces and a “dry” or “wet” environment.

### CROSS-REFERENCE TO RELATED APPLICATIONS

The present application is a continuation-in-part of U.S. application Ser. No. 18/661,890, filed May 13, 2024, which is a continuation-in-part of U.S. application Ser. No. 18/056,832, filed Nov. 18, 2022, which is a continuation-in-part of U.S. application Ser. No. 17/324,770, filed May 19, 2021, now issued as U.S. Pat. No. 11,890,728, which applications are incorporated herein by reference and made a part hereof.

### BACKGROUND OF THE INVENTION

### 1. Field of the Invention

This invention relates to a system and method for loosening or fastening a fastener using ultrasonic or acoustic energy. This invention also relates to an optimal fastener design feature to accept ultrasonic or acoustic energy. This invention also relates to an optimal fastener design that includes features to accept ultrasonic and acoustic energy and to provide a tool which has a horn that can pivot in at least one or a plurality of axes.

### 2. Description of the Related Art

Various devices for loosening a threaded connection are known from U.S. Pat. Nos. 3,485,307; 3,861,250; 4,771,661; 4,807,349: 4,812,697; 5,083,358; 6,681,663 and U.S. Publication Nos. 2007/0193420; 2009/0229846 and 2012/0024553. As shown, many relate to vibrations/impact mechanisms that are driven by various means, such as compressed air. It is generally known to persons skilled in the art, especially in the automotive, engine, and airplane technology industries, that fasteners, screws, nuts, or bolts are oftentimes seized and are difficult to remove from the part. This is due to a number of factors, such as corrosion occurring between the threads of the fasteners, screws, nuts, or bolts and the threads of the structure to which they are threadably mounted. In some applications, carbon deposits and foreign debris can build up and slowly “eat away” at the various metals, such as aluminum, titanium, and steel. When fasteners, screws, nuts, or bolts are unloosened, there is a risk of the fastener head and/or nut breaking during removal, leaving the remaining fastener in the threaded opening.

Although most attention is paid to the problem of loosening a sticking connection, and in particular threaded connections, until now none of the cited solutions have proven adequate in the airplane engine industry and/or other industries (such as heavy industrial or automotive) to replace or remove fasteners, screws, nuts, or bolts with a high success rate (i.e. without the fasteners, screws, nuts, or bolts breaking during the removal procedure) especially in locations that are subject to severe conditions (i.e. high temperatures, large thermal gradience, corrosion by salt or dissimilar metals, and/or environmental sand/dust). Also, during the repeated heating and cooling cycling the parts grow and shrink at different rates which causes increased strain on the fastener which increases the likelihood of the fastener getting stuck.

There is, therefore, a need for further improvements and to provide further systems and tools particularly for loosening stuck fasteners, screws, nuts, and bolts.

The current available fastener designs are not optimized to receive acoustical or ultrasonic energies. What is also needed, therefore, is an improved design that facilitates acoustical or ultrasonic energy transfer to maximize the energy into the fastener.

While some of the prior art focuses on subjecting the sticking connection to axial and rotational vibrations, such as by an impact wrench and/or hammer, there is a need to provide an improved focused system and tool that increases the chances of successfully removing the fasteners, screws, nuts, and bolts.

The Applicant has found that there are many areas in a structure or part that are difficult to get to with any hand tool, such as the tool of the subject application. It can be difficult to get the ultrasonic energy to the fastener because of the angle or entry of the tool.

What is needed, therefore, is an improved system, tool and method for overcoming one or more of the problems with the prior art tools of the past.

### SUMMARY OF THE INVENTION

One object of the invention is to provide a system and fastening tool that comprises at least one flexible ultrasonic joint adapted to permit a pivoting of a horn so that an acoustic or ultrasonic energy may be applied.

Another object of the invention is to provide a system and fastening tool that comprises an angled extension that can allow for easier access into areas that are difficult to get to.

Another object of the invention is to provide a fastening tool that facilitates transferring the ultrasonic energy into the fastener because of the angle of entry of the extension of the tool which facilitates such transfer of ultrasonic energy.

Another object of the invention is to provide a system and fastening tool that facilitates passing ultrasonic energy to the fasteners by providing a horn having a grain flow pattern in the material from which the extension of the fastening tool is made.

Still another object of the invention is to provide a material comprising a grain flow pattern that facilitates transferring energy through the extension of the tool and into the fastener.

Yet another object of the invention is to provide a material having a grain flow pattern that comprises a material grain size that is small and the flow of the grain flow runs parallel to a rolling direction.

Still another object of the invention is to provide a fastening tool having the extension or horn that has been processed into a predetermined shape between 0 and 360 degrees.

Yet another object of the invention is to provide an extension in the fastener tool that has been processed in a localized area to allow the grain pattern or structure to assume a predetermined size and pattern.

Another object of the invention is to provide a fastening tool having the extension or horn that has been heated in at least one localized area and bent or formed by hand into a predetermined shape.

Still another object of the invention is to provide a fastening tool having an extension that can be non-linear and can assume any predetermined angle in order to give access to the smallest amount of interferences on the part.

Another object of the invention is to provide a fastening tool that comprises a handpiece or handle that houses the piezoelectric components and ceramics. The handle comprises a switch for actuating the fastener tool to loosen or tighten a fastener. In one embodiment, the handpiece or handle is generally perpendicular or not coaxial to the centerline of the fastener while eliminating the need to have a second wrench to turn the horn or extension to loosen or tighten the fastener. It should be understood that the overall look of the tool could be “L” shaped.

Another object of the invention is to provide a system and method and tool that comprises a plurality of flexible ultrasonic joints.

Still another object of the invention is to provide a plurality of horns that may be used with at least one or a plurality of flexible ultrasonic joints.

Yet another object of the invention is to provide a plurality of tips that may be utilized with the fastening tool having at least one or a plurality of flexible ultrasonic joints.

Another object of the invention is to provide a system and fastening tool that may be dry coupled together with surface-to-surface contact.

Still another object of the invention is to provide a flexible ultrasonic coupler or sleeve to surround the at least one or a plurality of flexible ultrasonic joints so that an ultrasonic fluid may be used to facilitate transferring ultrasonic energy from the ultrasonic generator to the fastener.

Still another object of the invention is to provide an ultrasonic and acoustic tool having a plurality of flexible ultrasonic joints that pivot at least partially about different axes and in different planes.

Yet another object of the invention is to provide an ultrasonic fastening tool that comprises a plurality of flexible ultrasonic joints that permit a horn or top to pivot about different axes that are offset by approximately 90 degrees.

One object of the invention is to provide a system and fastening tool that is adapted to loosen or tighten a fastener using focused acoustic or ultrasonic energy.

Another object of the invention is to provide a system and method and a horn that is adapted and sized to transfer focused ultrasonic or acoustic energy to a predetermined location in the fastener.

Another object of the invention is to provide a plurality of horns each of which comprises a socket, screwdriver bit, and/or torque bit that generally have an optimized geometry and or flat areas for performing work on a fastener.

Another object of the invention is to provide a fastening tool and system that utilizes an acoustic/ultrasonic generator for generating ultrasonic or acoustic energy that travels into the fastener and becomes concentrated or focused at a predetermined location in the fastener.

Still another object of the invention is to provide a rotational torque applicator that may be used substantially simultaneously as the ultrasonic or acoustic generator to further facilitate loosening or tightening the fastener.

Another object of the invention is to provide the ability to cycle/alternate between tightening and loosening to facilitate freeing the fastener by breaking up debris and corrosion.

Yet another object of the invention is to provide an ultrasonic or acoustic generator and horn that generates cyclic heating between the threads of the fastener and the threads of a structure that threadably receives the fastener.

Yet another object of the invention is to stretch the fastener with ultrasonic or acoustical energy which in turn raises the fastener head or nut from the surface structure.

Still another object of the invention is to provide a system and fastening tool that decreases the “break away torque or breaking force” necessary to loosen a fastener.

Still another object of the invention is to provide a system and method wherein the ultrasonic or acoustic energy is focused at a predetermined location in the fastener.

Another object of the invention is to provide a system and fastening tool wherein the predetermined targeted location is between the head and/or nut and its mating structure surface(s) along with the mating threads of the fastener and structure(s).

Still another object of the invention is to provide a horn having a horn body that either has a socket, screwdriver bit, and/or torque bit on its end or a threaded aperture adapted to receive at least one of a plurality of replaceable tips that are removably and threadably mounted to the horn body.

Yet another object of the invention is to provide a plurality of interchangeable or replaceable tips for mounting on a horn, wherein the plurality of interchangeable or replaceable tips comprises different shapes or sizes to accommodate fasteners of different shapes or sizes.

Another object of the invention is to provide a horn body that is threaded that receives at least one of the plurality of interchangeable or replaceable tips comprising mating threads and where a thread direction of the horn body threads being a direction or handedness that is generally the opposite thread direction of the threads of the fastener.

Another object of the invention is to provide a horn with at least one of the plurality of interchangeable or replaceable tips that is adapted to cause an acoustic energy in the fastener that results in a vortex or helical energy being applied to the fastener in a predetermined rotational direction.

Yet another object of the invention is to provide a system and tool that may comprise at least one energy transfer facilitator that may comprise, but is not limited to Teflon, oil, water, gel, foam, glycol, glycerin, and/or a polymer film or a non-energy absorbing spacer.

Another object of the invention is to provide a system, method and tool that comprises at least one flexible ultrasonic joint that transmits ultrasonic energy via at least one of a “dry” coupling or a “wet” coupling.

Still another object of the invention is to provide a system, method and tool that comprises a plurality of flexible ultrasonic joints that permits ultrasonic energy to transfer via a “dry” connection or a “wet” connection.

Yet another object of the invention is to provide a system, method and tool that utilizes ultrasonic energy and that focuses and directs the ultrasonic energy through the tool.

Another object of the invention is to provide a sleeve that may encase or envelop at least one flexible universal joint or a plurality of flexible universal joints.

Another object of the invention is to provide a system, method and tool that utilizes a single flexible ultrasonic joint that is either “wet” or “dry”, depending on the application.

Another object of the invention is to provide a system, method and tool that utilizes a plurality of flexible ultrasonic joints that are either “wet” or “dry”, depending on the application.

In one aspect, one embodiment of the invention comprises a fastener tool for loosening or tightening a fastener mounted on a structure, the fastener tool comprising a tool body; a horn adapted and sized to apply an acoustic or ultrasonic energy into the fastener; and an acoustic/ultrasonic generator for generating the acoustic or ultrasonic energy that passes through the horn and into the fastener to facilitate fastening or loosening the fastener; and a flexible ultrasonic joint that couples the tool body to the horn, the flexible ultrasonic joint permitting the horn to pivot about at least one predetermined axis, the flexible ultrasonic joint being adapted to transmit a rotational torque to the horn and permitting the horn to pivot so that an axis of the horn is not coaxial with an axis of the tool body while transmitting the acoustic or ultrasonic energy to the fastener.

In another aspect, another embodiment of the invention comprises a system for rotating a fastener that is fastened to a structure; the system comprising an acoustic/ultrasonic wave generator for generating an acoustic/ultrasonic signal that passes longitudinally through the fastener to elongate the fastener and to introduce a cyclic strain and heating within the fastener to reduce a frictional force between threads on the fastener and mating threads on the structure; a tool having a horn for transmitting the acoustic/ultrasonic signal into the fastener; and a flexible ultrasonic joint that couples the tool body to the horn, the flexible ultrasonic joint permitting the horn to pivot about at least one predetermined axis, the flexible ultrasonic joint being adapted to transmit a rotational torque to the horn and permitting the horn to pivot so that an axis of the horn is not coaxial with an axis of the tool body while transmitting the acoustic or ultrasonic energy to the fastener; wherein the acoustic/ultrasonic wave generator and the horn cooperate to focus or apply the acoustic/ultrasonic signal to a predetermined distance into the fastener in order to reduce a coefficient of friction between the fastener and the structure when the horn is in operative relationship with fastener and the acoustic/ultrasonic signal is applied thereto.

In still another aspect, another embodiment of the invention comprises an ultrasonic fastener tool for loosening or tightening a fastener, the ultrasonic fastener tool comprising a horn body adapted to transmit acoustic or ultrasonic energy; a horn end also adapted to transmit the acoustic or ultrasonic energy, the horn end being sized and adapted to receive at least a portion of the fastener so that the acoustic or ultrasonic energy may be applied to the fastener; and a flexible ultrasonic joint coupling the horn body to the horn end and permitting the horn end to pivot in at least one plane and at least partially about one pivot axis.

In yet another aspect, another embodiment of the invention comprises a fastener tool for loosening or tightening a fastener mounted on a structure, the fastener tool comprising a tool body; a horn adapted and sized to apply an acoustic or ultrasonic energy into the fastener; and an acoustic/ultrasonic generator for generating the acoustic or ultrasonic energy that passes through the horn and into the fastener to facilitate fastening or loosening the fastener; and the horn comprising at least one first elongated portion, at least one second elongated portion, and a joining portion joining the at least one first elongated portion and the at least one second elongated portion such that they are not coaxial and cooperate to define at least one predetermined angle, the at least one second elongated portion having a working end and the horn being adapted to cause the acoustic or ultrasonic energy pass through the at least one first elongated portion, through the joining portion and into the at least one second elongated portion and to the working end; the horn focusing or applying the acoustic or ultrasonic energy a predetermined distance into the fastener in order to reduce a coefficient of friction between the fastener and the structure when the horn is in operative relationship with the fastener and acoustic or ultrasonic energy is applied thereto.

In still another aspect, another embodiment of the invention comprises a system for rotating a fastener that is fastened to a structure; the system comprising an acoustic/ultrasonic wave generator for generating an acoustic/ultrasonic signal that passes longitudinally through the fastener to elongate the fastener and to introduce a cyclic strain and heating within the fastener to reduce a frictional force between threads on the fastener and mating threads on the structure; a tool having a horn for transmitting the acoustic/ultrasonic signal into the fastener; and wherein the acoustic/ultrasonic wave generator and the horn cooperate to focus or apply the acoustic/ultrasonic signal to a predetermined distance into the fastener in order to reduce a coefficient of friction between the fastener and the structure when the horn is in operative relationship with the fastener and the acoustic/ultrasonic signal is applied thereto.

In yet another aspect, another embodiment of the invention comprises a fastener tool for loosening or tightening a fastener mounted on a structure, the fastener tool comprising a horn adapted and sized to apply an acoustic or ultrasonic energy into the fastener the horn having a horn body and horn end; and an acoustic/ultrasonic generator for generating the acoustic or ultrasonic energy that passes through the horn and into the fastener to facilitate fastening or loosening the fastener; and a universal pivot joint coupling the horn body to the horn end, the universal pivot joint enabling the horn end to move freely and pivot in a plurality of predetermined planes wherein the horn end and the horn body have axes that are not co-axial during positioning of the tool, and after placement of the horn end on the fastener, the acoustic/ultrasonic generator may apply the acoustic or ultrasonic energy through the horn body, directly through the universal pivot joint, through the horn end and into the fastener; the horn focusing or applying the acoustic or ultrasonic energy a predetermined distance into the fastener in order to reduce a coefficient of friction between the fastener and the structure when the horn is in operative relationship with fastener and acoustic or ultrasonic energy is applied thereto.

In still another aspect, another embodiment of the invention comprises a system for rotating a fastener that is fastened to a structure; the system comprising an acoustic/ultrasonic wave generator for generating an acoustic/ultrasonic signal that passes longitudinally through the fastener to elongate the fastener and to introduce a cyclic strain and heating within the fastener to reduce a frictional force between threads on the fastener and mating threads on the structure; a tool having a horn for transmitting the acoustic/ultrasonic signal into the fastener; a universal pivot joint coupling the horn body to the horn end, the universal pivot joint enabling the horn end to move freely and pivot in a plurality of predetermined planes wherein the horn end and the horn body have axes that are not co-axial during positioning of the tool, and after placement of the horn end on the fastener, the acoustic/ultrasonic generator may apply the acoustic/ultrasonic signal through the horn body, directly through the universal pivot joint, through the horn end and into the fastener, wherein the acoustic/ultrasonic wave generator and the horn cooperate to focus or apply the acoustic/ultrasonic signal to a predetermined distance into the fastener in order to reduce a coefficient of friction between the fastener and the structure when the horn is in operative relationship with fastener and the acoustic/ultrasonic signal is applied thereto.

In another aspect, another embodiment of the invention comprises a fastener tool for loosening or tightening a fastener mounted on a structure, the fastener tool comprising a horn adapted and sized to apply an acoustic or ultrasonic energy into the fastener the horn having a horn body and horn end; and an acoustic/ultrasonic generator for generating the acoustic or ultrasonic energy that passes through the horn and into the fastener to facilitate fastening or loosening the fastener; and a universal pivot joint coupling the horn body to the horn end, the universal pivot joint enabling the horn end to move freely and pivot in a plurality of predetermined planes wherein the horn end and the horn body have axes that are not co-axial during positioning of the tool, and after placement of the horn end on the fastener, the acoustic/ultrasonic generator may apply the acoustic or ultrasonic energy through the horn body, directly through the universal pivot joint, through the horn end and into the fastener, the horn focusing or applying the acoustic or ultrasonic energy a predetermined distance into the fastener in order to reduce a coefficient of friction between the fastener and the structure when the horn is in operative relationship with fastener and acoustic or ultrasonic energy is applied thereto.

In still another aspect, another embodiment of the invention comprises a system for rotating a fastener that is fastened to a structure; the system comprising an acoustic/ultrasonic wave generator for generating an acoustic/ultrasonic signal that passes longitudinally through the fastener to elongate the fastener and to introduce a cyclic strain and heating within the fastener to reduce a frictional force between threads on the fastener and mating threads on the structure; a tool having a horn for transmitting the acoustic/ultrasonic signal into the fastener; a universal pivot joint coupling a horn body to a horn end, the universal pivot joint enabling the horn end to move freely and pivot in a plurality of predetermined planes wherein the horn end and the horn body have axes that are not co-axial during positioning of the tool, and after placement of the horn end on the fastener, the acoustic/ultrasonic generator may apply the acoustic/ultrasonic signal through the horn body, directly through the universal pivot joint, through the horn end and into the fastener; wherein the acoustic/ultrasonic wave generator and the horn cooperate to focus or apply the acoustic/ultrasonic signal to a predetermined distance into the fastener in order to reduce a coefficient of friction between the fastener and the structure when the horn is in operative relationship with fastener and the acoustic/ultrasonic signal is applied thereto.

In still another aspect, another embodiment of the invention comprises a fastener tool for loosening or tightening a fastener mounted on a structure, the fastener tool comprising a tool body having a horn adapted and sized to apply an acoustic or ultrasonic energy into the fastener; and an acoustic/ultrasonic generator for generating the acoustic or ultrasonic energy that passes through the horn and into the fastener to facilitate fastening or loosening the fastener; the horn comprising a horn end, a horn body and a universal joint for pivotally joining the horn end and the horn body together such that the horn end and the horn body can be manipulated or moved independently of each other and into different planes to define at least one predetermined angle between the horn end and the horn body and the horn end having a working end for receiving a portion of the fastener; the universal joint comprising a pivot coupling for pivotally coupling a first knuckle portion of at least one knuckle to the horn body and pivotally coupling a second knuckle portion of the at least one knuckle to the horn end, the pivot coupling having at least one knuckle comprising a first knuckle portion having a first camming surface, a second knuckle portion having a second camming surface and a joining portion joining the first and second knuckle portions, the first knuckle portion lying in a first plane and the second knuckle portion lying in a second plane, the first and second planes being generally offset or not coplanar with respect to each other by a predetermined offset amount; the pivot coupling causing the first camming surface of the horn end to become situated in operative relationship or engagement with the first camming surface of the first knuckle portion, the pivot coupling simultaneously causing the second camming surface of the horn end to become situated in operative relationship or engagement with the horn end; the pivot coupling enabling or providing a predetermined amount of play or clearance for permitting the at least one knuckle to float and move freely so that the working end can pivot and move in a plurality of different planes during placement of the horn end on the fastener to be tightened or loosened and also permitting the first bearing surface to engage the first camming surface of the horn body and the second bearing surface to engage the horn body when the acoustic/ultrasonic generator is energized to apply ultrasonic energy to the horn body, the ultrasonic energy being transferred through the horn end, through the at least one knuckle, through the horn end, through the working end and into the fastener.

In still another aspect, another embodiment of the invention comprises a knuckle for use in a tool for loosening or fastening parts using an ultrasonic or acoustic energy; the knuckle comprising a first planar portion having a first aperture for receiving a first pivot pin in the tool; a second planar portion having a second aperture for receiving a second pivot pin in the tool; and a joining portion joining the first planar portion to the second planar portion; wherein the first and second planar portions are offset by a predetermined angle relative to each other and the joining portion has cross section smaller than a cross section of at least a portion of both the first and second portion.

This invention, including all embodiments shown and described herein, could be used alone or together and/or in combination with one or more of the features covered by one or more of the following list of features:

The fastener tool wherein the horn body comprises a first projection and a generally opposing second projection and the horn end comprises a third projection generally opposing the second projection; the first knuckle portion having a first knuckle locating aperture for receiving a first pivot pin after the first knuckle portion is received between the first and second projections of the horn body and the second knuckle portion having a second knuckle locating aperture for receiving a second pivot pin after the second knuckle portion is received between the third and fourth projections of the horn end; the first and second knuckle location apertures being sized and dimensioned to be larger than a diameter of the first and second pivot pins, respectively, in order to provide a predetermined amount of play or clearance for permitting the at least one knuckle to float and move freely between a first fork and a second fork of the horn end so that the horn end can be pivoted and moved freely in a plurality of different planes during placement of the horn end on the fastener to be tightened or loosened.

The fastener tool wherein the first projection has a first pivot pin hole and the second projection has a second pivot pin hole that generally opposes the first pivot pin hole, the first and second pivot pin holes each having a first diameter and adapted to received and secure the first pivot pin therebetween, the third projection having a third pivot pin hole and the fourth projection having a fourth pivot pin hole that generally opposes the third pivot pin hole, the third and fourth pivot pin holes each having a second diameter and adapted to received and secure a second pivot pin therebetween; the first locating aperture of the first knuckle portion receiving the first pivot pin after the first knuckle portion is received between the first and second projections of the horn end and the second knuckle portion having a second locating aperture for receiving the second pivot pin after the second knuckle portion is received between the third and fourth projections of the horn body; the diameter of the first and second pivot pin holes being greater than a diameter of the first locating aperture and the third and fourth pivot pin holes being greater in diameter than a diameter of the second locating aperture, thereby enabling or providing the predetermined amount of play or clearance for permitting the at least one knuckle to float and move freely between the horn end so that the horn end may be moved freely in a plurality of different planes during placement of the working end on the fastener to be tightened or loosened.

The fastener tool wherein the first pivot pin and the second pivot pin are spring pins.

The fastener tool wherein the first and second knuckle portions are generally planar and lie in a first plane and a second plane, respectively, the first and second planes being angularly offset by a predetermined angle.

The fastener tool wherein the predetermined angle is at least one of greater than about 45 degrees or greater than about 90 degrees or more.

The fastener tool wherein the first knuckle portion and the second knuckle portion are monolithically formed and adapted and shaped to facilitate transfer of ultrasonic energy between the horn end and the horn body.

The fastener tool wherein the first knuckle portion comprises or defines a first end in the at least one knuckle and defining the first camming surface and the second knuckle portion comprises or defines a second end in the at least one knuckle and defining the second camming surface.

The fastener tool wherein the at least one knuckle has a plurality of recessed or cut out areas in communication with the first and second knuckle portions in order to permit the working end to universally pivot during placement of the working end on the fastener.

The fastener tool wherein the at least one knuckle has a plurality of recessed or cut out areas in communication with the first and second knuckle portions in order to permit the working end to universally pivot.

The fastener tool wherein the first camming surface of the first knuckle portion is generally arcuate and the second camming surface of the knuckle portion is generally arcuate, the first and second camming surfaces lying in different planes.

The fastener tool wherein the first engaging surface and the second engaging surface are both generally arcuate and are adapted to complement a shape of the first camming surface and the second camming surface, respectively.

The fastener tool wherein the first camming surface and the first engaging surface each have a radius of curvature that are generally the same and the second camming surface and the second engaging surface have a radius of curvature that are generally the same.

The fastener tool wherein the radii of curvature of each of the first camming surface, the second camming surface, the first engaging surface and the second engaging surface are generally the same.

The fastener tool as recited in claim 1 wherein the first camming surface of the first knuckle portion is generally arcuate and lies in the first plane and the second camming surface of the second knuckle portion is generally arcuate and lies in the second plane that is different from the first plane.

The fastener tool wherein the first engaging surface of the horn end is generally arcuate and has a radius of curvature that is substantially the same as a radius of curvature of the first camming surface, the second engaging surface of the horn body also being generally arcuate and having a radius of curvature that is substantially the same as a radius of curvature of the second camming surface.

The fastener tool wherein the first engaging surface being adapted and dimensioned to have a radius of curvature that generally complements or is substantially the same as a radius of curvature of the first camming surface, the second engaging surface being adapted and dimensioned to have a radius of curvature that generally complements or is substantially the same as a radius of curvature of the second camming surface.

The fastener tool wherein the first camming surface of the first knuckle portion is generally arcuate and lies in the first plane and the second camming surface of the second knuckle portion is generally arcuate and lies in the second plane.

The fastener tool wherein the predetermined angle is at least 90 degrees.

The fastener tool wherein the first and second camming surfaces are each generally arcuate and complement a shape of the first and second engaging surfaces, respectively.

The fastener tool wherein the at least one knuckle comprises a first end having the first camming surface and a generally opposing second end with the second camming surface, the first and second camming surfaces being generally concave with respect to each other and permitting application of torque and ultrasonic energy serially from the horn body, through the at least one knuckle, through the horn end and ultimately to the fastener when the fastening tool is in energy transfer engagement with the fastener.

The fastener tool wherein the universal joint is adapted to cause a majority of the ultrasonic or acoustic energy through the fastener tool and to the fastener.

The fastener tool wherein the horn comprises a material having a predetermined grain pattern for facilitating transferring the acoustic or ultrasonic energy to the fastener.

The fastener tool wherein the material is normalized at least once to facilitate orienting the grain to the predetermined grain pattern.

The fastener tool wherein the ultrasonic energy generator applies a predetermined amount of ultrasonic energy to the fastener to facilitate breaking up corrosion or chemical deposits on the fastener, thereby facilitating loosening the fastener.

The fastener tool wherein the fastener comprises an end that is directly or indirectly engaged by the working end during loosening or fastening when the acoustic or ultrasonic energy is applied thereto, the acoustic/ultrasonic generator generating the ultrasonic or acoustic energy that travels into the fastener and becomes concentrated or focused at a predetermined location in the fastener.

The fastener tool wherein the fastener tool is adapted to apply a rotational torque to the fastener while the ultrasonic or acoustic energy passes into the fastener; wherein the rotational torque is applied substantially simultaneously as the horn causes the acoustic or ultrasonic energy to pass into the fastener.

The fastener tool wherein the fastener tool is adapted to apply the rotational torque substantially simultaneously as the ultrasonic or acoustic energy passes into the fastener.

The fastener tool wherein the working end comprises a socket, screwdriver bit, and/or torque bit sized and adapted to receive a head and/or nut of the fastener.

The fastener tool wherein the working end comprises an end that mates with a head on the fastener and/or a nut that engages the structure at a head and/or nut engagement area of the structure when the fastener is mounted thereto, the predetermined location being in the fastener.

The fastener tool wherein the fastener comprises a head and/or nut that becomes situated at a head and/or nut engagement area of the structure when the fastener is mounted thereto, the predetermined location being along a length of the fastener and downstream/upstream of the head and/or nut engagement area so that when the ultrasonic or acoustic energy is applied to the fastener, a friction or pressure between the head and/or nut mating surfaces and mating thread surfaces between the fastener and the structure is at least partly reduced.

The fastener tool wherein the fastener comprises threads that mate with mating threads at a thread-engagement location, the predetermined location to be between the head and/or nut and its mating structure surface(s) along with the mating threads of the fastener and structure(s).

The fastener tool wherein the predetermined location is between the head and/or nut and its mating structure surface(s) along with the mating threads of the fastener and structure(s).

The fastener tool wherein the predetermined location is between the head and/or nut and a distal end of a bolt, and a first thread of mating female threads.

The fastener tool wherein the tool body comprises a housing, the acoustic/ultrasonic generator is situated inside the housing.

The fastener tool wherein the fastener has a head and/or nut, the horn being adapted and sized to receive or engage the head and/or nut to apply a tightening or loosening torque to the head and/or nut when the acoustic or ultrasonic energy passes therethrough.

The fastener tool wherein the fastener tool comprises a plurality of replaceable working ends that are sized and adapted for a plurality of fasteners that have a plurality of heads, respectively, of different shapes or sizes.

The fastener tool wherein the fastener tool comprises a plurality of horns that are sized and adapted for a plurality of fasteners that have a plurality of heads, respectively, of different shapes or sizes.

The fastener tool wherein the horn is configured or adapted to receive a plurality of sockets, screwdriver bits, and/or torque bit tips of different sizes so that the horn may be used to apply the ultrasonic or acoustic energy directly into and through the socket, screwdriver bit, and/or torque bit tip and into the fastener when the fastener is being tightened or loosened.

The fastener tool wherein the working end of at least one second elongated portion comprises a male projection adapted to removably secure a at least one of the plurality of sockets, screwdriver bits, and/or torque bit tips.

The fastener tool wherein the horn comprises a horn body; at least one replaceable tip that is removably coupled to the horn body.

The fastener tool wherein the fastener tool comprises a plurality of interchangeable or replaceable tips of different shapes or sizes to accommodate fasteners of different shapes or sizes, respectively, the at least one replaceable tip being selected from the plurality of interchangeable or replaceable tips.

The fastener tool wherein the predetermined direction is at least one of opposite a thread direction of threads on the fastener when loosening the fastener or the thread direction is the same as thread direction of threads when it is desired to tighten the fastener.

The fastener tool wherein the horn comprises a helical or frusto-conical surface for engaging the fastener to apply a longitudinal signal during loosening or tightening of the fastener.

The fastener tool wherein the fastener tool comprises a rotational force generator that is separate from the acoustic/ultrasonic generator, the rotational force generator generates the rotational tortional signal and force to rotate the fastener as the acoustic/ultrasonic generator generates the ultrasonic or acoustic energy that passes into the fastener.

The fastener tool wherein the working end is adapted to create an energy vortex within the fastener that facilitates loosening or fastening the fastener.

The fastener tool wherein the fastener is threaded, the fastener engaging surface comprises an energy vortex, the energy vortex comprising a direction of rotation that opposes a helical direction of the threads of the fastener.

The fastener tool wherein the universal pivot joint comprises a knuckle having a first portion and a second portion; the first portion having a first aperture and the second portion having a second aperture; the first portion being pivotally coupled to the horn body with a first pivot pin; the second portion being pivotally coupled to the horn end with a second pivot pin.

The fastener tool wherein the first and second apertures are larger than a diameter or dimension of the first pivot pin and the second pivot pin, respectively, thereby permitting the loose coupling between the horn body and the horn end to facilitate the user's pivoting and placement of the horn end onto the fastener.

The fastener tool wherein the first pivot pin and the second pivot pin is a spring pin adapted to be secured to the horn body and passing through the first aperture to pivotally support the first portion on the horn body; the second pivot pin and the second pivot pin is a spring pin adapted to be secured to the horn end and passing through the second aperture to pivotally support the second portion on the horn end; the first and second apertures permitting the knuckle to float or move freely to facilitate placement of the horn end on the fastener, the knuckle becoming locked into energizing engagement with both the horn body and the horn end so that ultrasonic and acoustic energy can be passed therethrough after placement of the horn end on the fastener.

The fastener tool wherein the first portion is offset a predetermined offset angle relative to the second portion.

The fastener tool wherein the predetermined offset angle is about 90 degrees.

The fastener tool wherein the horn body has a horn body camming or engaging surface that generally compliments a first portion camming or engaging surface on the knuckle and the horn end has a horn end camming or engaging surface that generally compliments a second portion camming or engaging surface on the knuckle.

The fastener tool wherein a camming or engaging surface of the horn body cams or engages a camming or engaging surface of the first portion and a camming or engaging surface of the horn end cams or engages a camming or engaging surface of the second portion with a tolerance of less than about 0.0005 inch.

The fastener tool wherein during placement of the horn end, the camming or engaging surface of the horn body does not cam or engage the camming or engaging surface of the first portion and the camming or engaging surface of the horn end does not cam or engage the camming or engaging surface of the second portion with a tolerance of less than about 0.0005 inch.

The fastener tool wherein the horn body camming or engaging surface cooperates with the first portion camming or engaging surface to hone such the horn body camming or engaging surface and the first portion camming or engaging surface; horn end camming or engaging surface cooperates with the second portion camming or engaging surface to hone such the horn end camming or engaging surface and the second portion camming or engaging surface.

The fastener tool wherein the horn body, the horn end and the knuckle comprises material that is normalized at least once to facilitate orienting a grain to a predetermined grain pattern. such that the grain flows generally coaxially within the horn.

The fastener tool wherein the knuckle permits the horn end to pivot a predetermined maximum pivot angle relative to sad horn body, the predetermined maximum pivot angle is greater than 90 degrees.

The fastener tool wherein the predetermined maximum pivot angle is at least 110 degrees or more.

The fastener tool wherein the fastener tool comprises a rotational torque applicator for applying a rotational torque to the fastener while the ultrasonic or acoustic energy passes into the fastener; wherein the rotational torque is at least one of mechanical torque or an acoustic/ultrasonic torque that is applied substantially simultaneously as the horn causes the acoustic or ultrasonic energy to pass into the fastener.

The fastener tool wherein the horn is adapted to apply the rotational torque substantially simultaneously as the ultrasonic or acoustic energy passes into the fastener.

The fastener tool wherein the horn end comprises a socket, screwdriver bit, and/or torque bit sized and adapted to receive a head and/or nut of the fastener.

The fastener tool wherein the fastener comprises a head and/or nut, the ultrasonic or acoustic energy being at a predetermined location being along a length of the fastener so that when the ultrasonic or acoustic energy is applied to the fastener, a friction or pressure between the head and/or nut mating surfaces and mating thread surfaces between the fastener and the structure is at least partly reduced.

The fastener tool wherein the fastener comprises threads that mate with mating threads at a thread-engagement location, the predetermined location to be between the head and/or nut and its mating structure surface(s) along with the mating threads of the fastener and structure(s).

The fastener tool wherein the predetermined location is between the head and/or nut and its mating structure surface(s) along with the mating threads of the fastener and structure(s).

The fastener tool wherein the predetermined location is between the head and/or nut and a distal end of the bolt, and a first thread of mating female threads.

The fastener tool wherein the tool comprises a housing, the acoustic/ultrasonic generator is situated inside the housing.

The fastener tool wherein the fastener has a head and/or nut, the horn being adapted and sized to receive or engage the head and/or nut to apply a tightening or loosening torque to the head and/or nut when the acoustic or ultrasonic energy passes therethrough.

The fastener tool wherein the horn comprises a socket, screwdriver bit, and/or torque bit tip that is sized and adapted to engage the head and/or nut and apply a rotational torque when the ultrasonic or acoustic energy passes into the fastener.

The fastener tool wherein the fastener tool comprises a plurality of horns that are sized and adapted for a plurality of fasteners that have a plurality of heads, respectively, of different shapes or sizes.

The fastener tool wherein the fastener tool comprises a plurality of horns that are sized and adapted for a plurality of fasteners that have a plurality of heads, respectively, of different shapes or sizes.

The fastener tool wherein the horn end is configured or adapted to receive a plurality of sockets, screwdriver bits, and/or torque bit tips of different sizes so that the horn may be used to apply the ultrasonic or acoustic energy directly into and through the socket, screwdriver bit, and/or torque bit tip and into the fastener when the fastener is being tightened or loosened.

The fastener tool wherein the horn body comprises at least one replaceable tip that is removably coupled to the horn body.

The fastener tool wherein the fastener tool comprises a plurality of interchangeable or replaceable tips of different shapes or sizes to accommodate fasteners of different shapes or sizes, respectively, at least one interchangeable or replaceable tip being selected from the plurality of interchangeable or replaceable tips.

The fastener tool wherein the horn body comprises a plurality of replaceable tips to accommodate fasteners of different sizes.

The fastener tool wherein the horn body is threaded and at least one of the plurality of replaceable tips comprises mating threads, a thread direction of threads of the horn body being a direction opposite a thread direction of threads of the fastener.

The fastener tool wherein the horn body is threaded and at least one of the plurality of replaceable tips comprises mating threads, mating thread on the horn being of a larger diameter than the mating threads on the fastener.

The fastener tool wherein at least one of the plurality of interchangeable or replaceable tips comprises a generally optimized geometry and or flat fastener-engaging surface.

The fastener tool wherein at least one of the plurality of interchangeable or replaceable tips is adapted to cause the acoustic or ultrasonic energy to cause a vortex or helical energy to be applied internally to the fastener, the vortex or helical energy being in a predetermined direction.

The fastener tool wherein the predetermined direction is at least one of opposite a thread direction of threads on the fastener when loosening the fastener or the thread direction is the same as thread direction of threads when it is desired to tighten the fastener.

The fastener tool wherein the horn end comprises a helical or frusto-conical surface for engaging the fastener to apply a longitudinal signal during loosening or tightening of the fastener.

The fastener tool wherein the acoustic/ultrasonic generator applies the ultrasonic or acoustic energy at a frequency equal to or larger than 1 kHz. The fastener tool wherein the horn comprises a generally flat surface for applying the acoustic or ultrasonic energy to the fastener.

The fastener tool wherein the fastener comprises an end that is directly or indirectly engaged by the horn during loosening or fastening when the acoustic or ultrasonic energy is applied thereto, the acoustic/ultrasonic generator generating the ultrasonic or acoustic energy that travels into the fastener and becomes concentrated or focused at a predetermined location in the fastener.

The fastener tool wherein the fastener tool comprises a rotational torque applicator for applying a rotational torque to the fastener while the ultrasonic or acoustic energy passes into the fastener; wherein the rotational torque is at least one of mechanical torque or an acoustic/ultrasonic torque that is applied substantially simultaneously as the horn causes the acoustic or ultrasonic energy to pass into the fastener.

The fastener tool wherein the horn is adapted to apply the rotational torque substantially simultaneously as the ultrasonic or acoustic energy passes into the fastener.

The fastener tool wherein the horn comprises a socket, screwdriver bit, and/or torque bit sized and adapted to receive a head and/or nut of the fastener. The fastener tool wherein the end comprises an end that mates with a head and/or nut that engages the structure at a head and/or nut engagement area of the structure when the fastener is mounted thereto, the predetermined location being in the fastener.

The fastener tool wherein the end comprises a head and/or nut that becomes situated at a head and/or nut engagement area of the structure when the fastener is mounted thereto, the predetermined location being along a length of the fastener and downstream/upstream of the head and/or nut engagement area so that when the ultrasonic or acoustic energy is applied to the fastener, a friction or pressure between the head and/or nut mating surfaces and mating thread surfaces between the fastener and the structure is at least partly reduced.

The fastener tool wherein the fastener comprises threads that mate with mating threads at a thread-engagement location, the predetermined targeted location to be between the head and/or nut and its mating structure surface(s) along with the mating threads of the fastener and structure(s).

The fastener tool wherein the predetermined targeted location is between the head and/or nut and its mating structure surface(s) along with the mating threads of the fastener and structure(s).

The fastener tool wherein the predetermined location is between the head and/or nut and a distal end of the bolt, and a first thread of mating female threads.

The fastener tool wherein the acoustic/ultrasonic generator applies the ultrasonic or acoustic energy at a frequency equal to or larger than 1 kHz.

The fastener tool wherein the fastener has a head and/or nut, the horn being adapted and sized to receive or engage the head and/or nut to apply a tightening or loosening torque to the head and/or nut when the acoustic or ultrasonic energy passes therethrough.

The fastener tool wherein the horn comprises a socket, screwdriver bit, and/or torque bit tip that is sized and adapted to engage the head and/or nut and apply a rotational torque when the ultrasonic or acoustic energy passes into the fastener.

The fastener tool wherein the fastener tool comprises a plurality of horns that are sized and adapted for a plurality of fasteners that have a plurality of heads, respectively, of different shapes or sizes.

The fastener tool wherein the fastener tool comprises a plurality of horns that are sized and adapted for a plurality of fasteners that have a plurality of heads, respectively, of different shapes or sizes.

The fastener tool wherein the horn is configured or adapted to receive a plurality of sockets, screwdriver bits, and/or torque bit tips of different sizes so that the horn may be used to apply the ultrasonic or acoustic energy directly into and through the socket, screwdriver bit, and/or torque bit tip and into the fastener when the fastener is being tightened or loosened.

The fastener tool wherein the horn comprises a horn body; at least one replaceable tip that is removably coupled to the horn body.

The fastener tool wherein the fastener tool comprises a plurality of interchangeable or replaceable tips of different shapes or sizes to accommodate fasteners of different shapes or sizes, respectively, at least one replaceable tip being selected from the plurality of interchangeable or replaceable tips.

The fastener tool wherein the horn body comprises a plurality of replaceable tips to accommodate fasteners of different sizes.

The fastener tool wherein the horn body is threaded and at least one replaceable tip comprises mating threads, a thread direction of the horn body threads being a direction opposite the thread direction of threads of the fastener.

The fastener tool wherein the horn body is threaded and at least one replaceable tip comprises mating threads, mating thread on the horn being of a larger diameter than the mating threads on the fastener.

The fastener tool wherein at least one of the plurality of interchangeable or replaceable tips comprises a generally optimized geometry of at least a flat, conical, radial or curved fastener-engaging surface.

The fastener tool wherein the horn comprises a helical or frusto-conical surface for engaging the fastener to apply a longitudinal signal during loosening or tightening of the fastener.

The fastener tool wherein the fastener tool comprises a rotational force generator that is separate from the acoustic/ultrasonic generator, the rotational force generator generates the rotational tortional signal and force to rotate the fastener as the acoustic/ultrasonic generator generates the ultrasonic or acoustic energy that passes into the fastener.

The fastener tool wherein the end comprises a head and/or nut that engages a mating surface at a head and/or nut engagement area where the head and/or nut engages the structure when the fastener is mounted thereto, the predetermined location being downstream/upstream of the head and/or nut engagement area so that when the ultrasonic or acoustic energy is applied to the fastener, a friction or pressure between the head and/or nut and the mating surface along with mating threads between the fastener and structure is at least partly reduced.

The fastener tool wherein the fastener tool comprises an energy transfer facilitator for facilitating transferring the ultrasonic or acoustic energy into the fastener.

The fastener tool wherein the energy transfer facilitator comprises of at least one of a fluid or material and is arranged between the horn and at least one of the fastener or a socket, screwdriver bit, and/or torque bit tips mounted on the fastener, the fluid or material absorbing a minimal amount of the acoustic or ultrasonic energy traveling into the fastener.

The fastener tool wherein the energy transfer facilitator may comprise of but not limited to Teflon, oil, water, gel, foam, glycol, glycerin, and/or a polymer film or a minimally energy absorbing spacer.

The fastener tool wherein the fastener tool is “dry coupled” such that any contact that surfaces carry or transmit the acoustic or ultrasonic energy to the fastener tool are in direct contact and without any energy transfer facilitation.

The fastener tool wherein the fastener is a bolt/screw and/or nut but not limited to an airplane component, large industrial, and/or automotive fastener for fastening at least two components together.

The fastener tool wherein the horn comprises a predetermined resonant frequency selected to generally correspond to the fastener resonant frequency.

The fastener tool wherein the fastener comprises at least one of a concave end surface, a convex end surface or a flat end surface.

The fastener tool wherein at least one predetermined axis comprises a first predetermined pivot axis, the flexible ultrasonic joint being adapted to permit the horn to pivot at least partially about the first predetermined pivot axis.

The fastener tool wherein the flexible ultrasonic joint is adapted to permit the horn to pivot at least partially about a plurality of predetermined pivot axes that are not coaxial with either each other or with a tool axis of the fastener tool.

The fastener wherein the flexible ultrasonic joint comprises a first flexible ultrasonic joint and a second flexible ultrasonic joint that enable the horn to pivot in a first predetermined plane and a second predetermined plane, respectively, the second predetermined plane being different from the first plane.

The fastener tool wherein the second predetermined plane is offset generally 90 degrees relative to the first predetermined plane.

The fastener tool wherein the flexible ultrasonic joint comprises a flexible ultrasonic adapter adapted to receive the horn and a flexible ultrasonic coupler adapter coupled to the tool body, the flexible ultrasonic adapter and the flexible ultrasonic coupler being pivotally coupled together to permit the horn to pivot in the first predetermined plane.

The fastener tool wherein the flexible ultrasonic joint comprises a flexible ultrasonic adapter that is adapted to define or receive the horn or at least one tip, a flexible ultrasonic coupler adapted to be coupled to the tool body, and an intermediate flexible ultrasonic coupler adapted to pivotally couple the flexible ultrasonic adapter to the flexible ultrasonic coupler, the flexible ultrasonic adapter, the flexible ultrasonic coupler and the intermediate flexible ultrasonic coupler being adapted to permit the horn to pivot or be pivoted at least partially about each of the plurality of predetermined pivot axes while substantially simultaneously applying the acoustic or ultrasonic energy that passes through the horn and into the fastener to facilitate fastening or loosening the fastener.

The fastener tool wherein the intermediate flexible ultrasonic coupler and the flexible ultrasonic coupler are adapted and configured to provide a second pivot connection to permit the horn to at least partially pivot about the first predetermined axis.

The fastener tool wherein the flexible intermediate ultrasonic adapter and the flexible ultrasonic coupler are adapted, configured and cooperate to provide a first fork and tongue coupling and a second fork and tongue coupling, the first and second fork and tongue couplings permitting the horn to at least partially pivot in the first predetermined plane about the first predetermined axis and also permitting the horn to at least partially pivot in the second predetermined plane about the second predetermined when the acoustic or ultrasonic energy passes through the horn and into the fastener to facilitate fastening or loosening the fastener.

The fastener tool wherein the flexible ultrasonic coupler comprises a first pair of legs that are generally opposed and spaced and that define a first groove therebetween, the flexible ultrasonic adapter comprising a cooperating mating male projection that is adapted and sized to be received in the first groove and to permit the flexible ultrasonic adapter to pivot in the first predetermined plane and at least partially about the first predetermined pivot axis, wherein the first predetermined pivot axis generally intersects a center axis of the fastener tool.

The fastener tool wherein the flexible ultrasonic coupler comprises a first pair of legs that are generally opposed and spaced and that define a first groove therebetween, the intermediate flexible ultrasonic coupler comprising a first end having a mating male projection adapted and sized to be received in the first groove and pivotally secured together with a first pivot pin, the intermediate flexible ultrasonic coupler comprising a second end having a second pair of legs that are generally opposed and spaced and that define a second groove therebetween, the flexible ultrasonic adapter having a first end adapted to receive the horn and a second end having a second male projection adapted and sized to be received in the second groove and pivotally secured together with a second pivot pin.

The fastener tool wherein the fastening tool comprises a sleeve for covering the flexible ultrasonic joint and for defining a fluid storage area about the flexible ultrasonic joint for storing a fluid, the fluid facilitating a transfer of the acoustic or ultrasonic energy through the horn and into the fastener to facilitate fastening or loosening the fastener.

The fastener tool wherein the sleeve is a flexible and adapted to permit the horn to pivot relative to and axis of the fastener tool and when a torque is applied to the horn.

The fastener tool wherein the flexible ultrasonic joint comprises a first pivot joint that permits the horn to pivot in a first plane.

The fastener tool wherein the flexible ultrasonic joint comprises a first pivot joint that permits the horn to pivot in a first plane and a second pivot joint that permits the horn to pivot in a second plane, the second plane being different from the first plane.

The fastener tool wherein the second plane is offset approximately 90 degrees relative to the first plane.

The fastener tool wherein the first and second pivot joints are pivot pin joints.

The fastener tool wherein the fastener tool comprises at least one of a transducer or a booster.

The system wherein the fastener comprises a head and/or nut having a shoulder (if present) that engages the structure at a shoulder engagement area of the structure, the predetermined distance being between the head and/or nut and its mating structure surface(s) along with the mating threads of the fastener and structure(s).

The system wherein an end of the fastener comprises a head and/or nut that becomes situated at a head and/or nut engagement area of the structure when the fastener is mounted thereto, a predetermined location being along a length of the fastener and downstream/upstream of the head and/or nut engagement area so that when the acoustic/ultrasonic signal is applied to the fastener, a friction or pressure between the head and/or nut and its mating surface(s) along with the mating threads of the fastener and structure(s) is at least partly reduced.

The system wherein the system comprises a rotational torque applicator adapted to apply a rotational torque to the fastener substantially simultaneously as the acoustic/ultrasonic signal passes through the fastener.

The system wherein a rotational torque applicator and the acoustic/ultrasonic wave generator are integrated into a common tool body.

The system wherein the horn is sized and adapted to receive a head and/or nut or end of the fastener.

The system wherein the flexible ultrasonic joint comprises a first pivot joint that permits the horn to pivot in a first plane.

The system wherein the flexible ultrasonic joint comprises a first pivot joint that permits the horn to pivot in a first plane and a second pivot joint that permits the horn to pivot in a second plane, the second plane being different from the first plane.

The system wherein the second plane is offset approximately 90 degrees relative to the first plane.

The system wherein the first and second pivot joints are pivot pin joints.

The system wherein the fastening tool comprises a sleeve for covering the flexible ultrasonic joint and for defining a storage area about the pivot joint for storing a fluid, the fluid facilitating a transfer of the acoustic or ultrasonic energy through the horn and into the fastener to facilitate fastening or loosening the fastener.

The system wherein the sleeve is a flexible and adapted to permit the horn to pivot relative to and axis of the fastener tool and when a torque is applied to the horn.

The system wherein the predetermined distance being into the fastener between the head and/or nut and its mating structure surface(s) along with the mating threads of the fastener and structure(s).

The system wherein the horn comprises a socket, screwdriver bit, and/or torque bit tip that is sized and adapted to engage the head and/or nut and apply a rotational torque when the acoustic/ultrasonic signal passes into the fastener.

The system wherein the system comprises a plurality of horns that are sized and adapted for a plurality of fasteners that have a plurality of heads respectively, of different shapes or sizes.

The system wherein the horn is configured or adapted to receive a plurality of sockets, screwdriver bits, and/or torque bit tips of different sizes so that the horn may be used to apply the acoustic/ultrasonic signal directly into and through the socket, screwdriver bit, and/or torque bit tips and into the fastener when the fastener is being tightened or loosened.

The system wherein the horn comprises a horn end; at least one replaceable tip removably coupled to the horn end.

The system wherein the horn body comprises a plurality of replaceable tips to accommodate fasteners of different sizes.

The system wherein the horn body comprises a threaded aperture and the at least one replaceable tip comprises mating threads, a thread direction of the threads of the horn body being a direction opposite a thread direction of threads of the fastener.

The system wherein the horn body is threaded and the at least one replaceable tip comprises mating threads, the horn body threaded diameter being larger than the fastener threaded diameter.

The system wherein the fastener comprises an end that is engaged by the horn during loosening or fastening, the acoustic/ultrasonic generator generating the acoustic/ultrasonic signal that travels into the fastener, the predetermined distance becomes concentrated or focused at a predetermined location in the fastener.

The system wherein the end comprises a head and/or nut that engages a mating surface of the structure at a head and/or nut engagement area where the head and/or nut engages the structure when the fastener is mounted thereto, the predetermined location being downstream/upstream of the head and/or nut engagement area so that when the acoustic/ultrasonic signal is applied to the fastener, a friction or pressure between the head and/or nut and its mating surface(s) along with the mating threads of the fastener and structure(s) is at least partly reduced.

The system wherein the horn is configured or adapted to receive a plurality of sockets, screwdriver bits, and/or torque bit tips of different shapes and sizes so that the horn may be used to apply the acoustic/ultrasonic signal directly into and through the socket, screwdriver bit, and/or torque bit tips and into the fastener when the fastener is being tightened or loosened.

The system wherein the acoustic/ultrasonic generator applies the acoustic/ultrasonic signal at a frequency equal to or larger than 1 kHz.

The system wherein the fastener has a head and/or nut, the horn comprises an end that is adapted and sized to receive the head and/or nut and to apply a tightening or fastening torque to the head and/or nut while the acoustic/ultrasonic signal passes therethrough.

The system wherein the tool comprises a plurality of horns that are sized and adapted for a plurality of fasteners that have a plurality of heads, respectively, of different shapes or sizes.

The system wherein the system comprises an energy transfer facilitator for facilitating transferring the acoustic/ultrasonic signal into the fastener.

The system wherein the fastener tool is “dry coupled” such that any contact surfaces that carry or transmit the acoustic or ultrasonic energy to the fastener tool are in direct contact and without any energy transfer facilitation.

The system wherein the energy transfer facilitator comprises at least one of a fluid or material is arranged between the horn and at least one of the fastener or a socket, screwdriver bit, and/or torque bit tips mounted on the fastener, the fluid or minimally absorbing material of the acoustic/ultrasonic signal traveling into the fastener.

The system wherein the energy transfer facilitator may comprise but not limited to Teflon, oil, water, gel, foam, glycol, glycerin, and/or a polymer film or a minimally energy absorbing spacer.

The ultrasonic fastener tool wherein the flexible ultrasonic joint comprises a single pivot joint that permits the horn end to pivot in a first predetermined plane and at least partially about a first predetermined axis.

The ultrasonic fastener tool wherein the flexible ultrasonic joint comprises a dual pivot joint that permits the horn end to pivot in a first predetermined plane and a second predetermined plane and at least partially about a second predetermined axis, respectively.

The ultrasonic fastener tool wherein the flexible ultrasonic joint comprising a plurality of parts having a plurality of engaging surfaces, respectively, the plurality of engaging surfaces comprising no fluid gap or spacing and defining or providing a “dry” engagement so that the plurality of engaging surfaces engage in order to facilitate transfer of the acoustic or ultrasonic energy to the horn end and ultimately to the fastener when the ultrasonic fastener tool is used to loosen or tighten the fastener.

The ultrasonic fastener tool wherein the plurality of engaging surfaces, respectively, the plurality of engaging surfaces are curved or angled to facilitate focusing the acoustic or ultrasonic energy through the plurality of parts.

The ultrasonic fastener tool wherein the single pivot joint comprises a plurality of parts having a plurality of engaging surfaces, respectively, the plurality of engaging surfaces comprising no fluid gap or spacing and defining or providing a “dry” engagement so that the plurality of engaging surfaces engage in order to facilitate transfer of the acoustic or ultrasonic energy to the horn end and ultimately to the fastener when the ultrasonic fastener tool is used to loosen or tighten the fastener.

The ultrasonic fastener tool wherein the plurality of engaging surfaces, respectively, the plurality of engaging surfaces are curved or angled to facilitate focusing the acoustic or ultrasonic energy through the plurality of parts.

The ultrasonic fastener tool wherein the dual pivot joint comprises a plurality of parts having a plurality of engaging surfaces, respectively, the plurality of engaging surfaces comprising no fluid gap or spacing and defining or providing a “dry” engagement so that the plurality of engaging surfaces engage in order to facilitate transfer of the acoustic or ultrasonic energy to the horn end and ultimately to the fastener when the ultrasonic fastener tool is used to loosen or tighten the fastener.

The ultrasonic fastener tool wherein the plurality of engaging surfaces, respectively, the plurality of engaging surfaces are curved or angled to facilitate focusing the acoustic or ultrasonic energy through the plurality of parts.

The ultrasonic fastener tool wherein the flexible ultrasonic joint comprises plurality of parts having a plurality of engaging surfaces, respectively, each of the plurality of engaging surfaces comprising a fluid gap or spacing therebetween for receiving an ultrasonic fluid and defining or providing a “wet” joint so that the ultrasonic fluid facilitates transferring the acoustic or ultrasonic energy directly between such plurality of engaging surfaces in order to facilitate transfer of the acoustic or ultrasonic energy to the horn end and ultimately to the ultrasonic fastener when the ultrasonic fastener tool is used to loosen or tighten the fastener.

The ultrasonic fastener tool wherein the ultrasonic fastener tool comprises a boot or sleeve that surrounds the flexible ultrasonic joint to retain the ultrasonic fluid about the flexible ultrasonic joint.

The ultrasonic fastener tool wherein the flexible ultrasonic joint comprises a plurality of parts having a plurality of engaging surfaces, respectively, each of the plurality of engaging surfaces comprising a fluid gap or spacing therebetween for receiving an ultrasonic fluid and defining or providing a “wet” joint so that the ultrasonic fluid facilitates transferring the acoustic or ultrasonic energy directly between such plurality of engaging surfaces in order to facilitate transfer of the acoustic or ultrasonic energy to the horn end and ultimately to the ultrasonic fastener when the ultrasonic fastener tool is used to loosen or tighten the fastener.

The ultrasonic fastener tool wherein the ultrasonic fastener tool comprises a boot or sleeve that surrounds the flexible ultrasonic joint to retain the ultrasonic fluid about the flexible ultrasonic joint.

The ultrasonic fastener tool wherein the flexible ultrasonic joint comprises a plurality of parts having a plurality of engaging surfaces, respectively, each of the plurality of engaging surfaces comprising a fluid gap or spacing therebetween for receiving an ultrasonic fluid and defining or providing a “wet” joint so that the ultrasonic fluid facilitates transferring the acoustic or ultrasonic energy directly between such plurality of engaging surfaces in order to facilitate transfer of the acoustic or ultrasonic energy to the horn end and ultimately to the ultrasonic fastener when the ultrasonic fastener tool is used to loosen or tighten the fastener.

The ultrasonic fastener tool wherein the ultrasonic fastener tool comprises a boot or sleeve that surrounds the flexible ultrasonic joint to retain the ultrasonic fluid about the flexible ultrasonic joint.

The ultrasonic fastener tool wherein the horn body and the horn end are adapted and configured to be pivotally coupled together so that the horn end may pivot with respect to the horn body while the acoustic or ultrasonic energy is being applied to the fastener. of engaging surfaces.

The ultrasonic fastener tool wherein a first pivot pin joint pivotally secures the horn body to the horn end.

The ultrasonic fastener tool wherein the ultrasonic fastener tool comprises at least one intermediate coupler for pivotally coupling the horn body to the horn end, the at least one intermediate coupler adapted and configured to pivotally couple the horn body to the horn end so that the horn end may pivot with respect to the horn body in the plurality of planes and at least partially about the plurality of axes.

The ultrasonic fastener tool wherein a first pivot pin joint pivotally secures the horn body to a first end of the intermediate coupler and a second pivot pin joint pivotally secures the horn end to a second end of the intermediate coupler; the first pivot pin joint permitting the horn end to pivot at least partially about a first pivot axis and the second pivot pin joint permitting the horn end to pivot at least partially about a second pivot axis that is not the same as the first pivot axis.

The ultrasonic fastener tool wherein a first pivot axis and the second pivot axis is offset by about 90 degrees.

The ultrasonic fastener tool wherein the intermediate coupler comprises a groove on one end for pivotally receiving a male projection of the horn body and an intermediate coupler male projection for pivotally coupling to an end of the horn body.

The ultrasonic fastener tool wherein the intermediate coupler comprises a first channel or groove on a first end for pivotally receiving a male projection of the horn end and permitting the horn end to at least partially pivot about a first predetermined axis, the intermediate coupler also comprises a second channel or groove on a second end for receiving a second male projection for permitting the horn end to at least partially pivot about a second predetermined axis.

The fastener tool wherein the horn comprises a material having a predetermined grain pattern for facilitating transferring the acoustic or ultrasonic energy to the fastener.

The fastener tool wherein the material is normalized at least once to facilitate orienting the grain to the predetermined grain pattern. such that the grain flows generally coaxially within the horn.

The fastener tool wherein the at least one predetermined angle is acute.

The fastener tool wherein the at least one predetermined angle is obtuse.

The fastener tool wherein the horn is shaped to comprise a plurality of predetermined angles, at least one of which is obtuse.

The fastener tool wherein the horn comprises a horn body that is flexible and can be formed by hand to a shape having at least one angle.

The fastener tool wherein the horn is flexible and can be formed by hand to a shape having a plurality of predetermined angles.

The fastener tool wherein the plurality of predetermined angles comprises at least one angle that is obtuse.

The fastener tool wherein the horn body is tubular and is adapted to receive a fluid for transmitting the acoustic or ultrasonic energy thorough the horn body and to the fastener.

The fastener tool wherein the fluid may be oil, glycerin or water.

The fastener tool wherein the horn comprises a generally flat surface for applying the acoustic or ultrasonic energy to the fastener.

The fastener tool wherein the fastener comprises an end that is directly or indirectly engaged by the horn during loosening or fastening when the acoustic or ultrasonic energy is applied thereto, the acoustic/ultrasonic generator generating the ultrasonic or acoustic energy that travels into the fastener and becomes concentrated or focused at a predetermined location in the fastener.

The fastener tool wherein the fastener tool comprises a rotational torque applicator for applying a rotational torque to the fastener while the ultrasonic or acoustic energy passes into the fastener; wherein the rotational torque is at least one of mechanical torque or an acoustic/ultrasonic torque that is applied substantially simultaneously as the horn causes the acoustic or ultrasonic energy to pass into the fastener.

The fastener tool wherein the horn is adapted to apply the rotational torque substantially simultaneously as the ultrasonic or acoustic energy passes into the fastener.

The fastener tool wherein the horn comprises a socket, screwdriver bit, and/or torque bit sized and adapted to receive a head and/or nut of the fastener.

The fastener tool wherein the end comprises an end that mates with a head and/or nut that engages the structure at a head and/or nut engagement area of the structure when the fastener is mounted thereto, the predetermined location being in the fastener.

The fastener tool wherein the end comprises a head and/or nut that becomes situated at a head and/or nut engagement area of the structure when the fastener is mounted thereto, the predetermined location being along a length of the fastener and downstream/upstream of the head and/or nut engagement area so that when the ultrasonic or acoustic energy is applied to the fastener, a friction or pressure between the head and/or nut mating surfaces and mating thread surfaces between the fastener and the structure is at least partly reduced.

The fastener tool wherein the fastener comprises threads that mate with mating threads at a thread-engagement location, the predetermined location to be between the head and/or nut and its mating structure surface(s) along with the mating threads of the fastener and structure(s).

The fastener tool wherein the predetermined location is between the head and/or nut and its mating structure surface(s) along with the mating threads of the fastener and structure(s).

The fastener tool wherein the predetermined location is between the head and/or nut and a distal end of the bolt, and a first thread of mating female threads.

The fastener tool wherein the tool body comprises a housing, the acoustic/ultrasonic generator is situated inside the housing.

The fastener tool wherein the fastener has a head and/or nut, the horn being adapted and sized to receive or engage the head and/or nut to apply a tightening or loosening torque to the head and/or nut when the acoustic or ultrasonic energy passes therethrough.

The fastener tool wherein the horn comprises a socket, screwdriver bit, and/or torque bit tip that is sized and adapted to engage the head and/or nut and apply a rotational torque when the ultrasonic or acoustic energy passes into the fastener.

The fastener tool wherein the fastener tool comprises a plurality of horns that are sized and adapted for a plurality of fasteners that have a plurality of heads, respectively, of different shapes or sizes.

The fastener tool wherein the fastener tool comprises a plurality of horns that are sized and adapted for a plurality of fasteners that have a plurality of heads, respectively, of different shapes or sizes.

The fastener tool wherein the horn is configured or adapted to receive a plurality of sockets, screwdriver bits, and/or torque bit tips of different sizes so that the horn may be used to apply the ultrasonic or acoustic energy directly into and through the socket, screwdriver bit, and/or torque bit tip and into the fastener when the fastener is being tightened or loosened.

The fastener tool wherein the horn comprises a horn body; at least one replaceable tip that is removably coupled to the horn body.

The fastener tool wherein the fastener tool comprises a plurality of interchangeable or replaceable tips of different shapes or sizes to accommodate fasteners of different shapes or sizes, respectively, the at least one replaceable tip being selected from the plurality of interchangeable or replaceable tips.

The fastener tool wherein the horn body comprises a plurality of replaceable tips to accommodate fasteners of different sizes.

The fastener tool wherein the horn body is threaded and the at least one replaceable tip comprises mating threads, a thread direction of threads of the horn body being a direction opposite a thread direction of threads of the fastener.

The fastener tool wherein the horn body is threaded and the at least one replaceable tip comprises mating threads, mating thread on the horn being of a larger diameter than the mating threads on the fastener.

The fastener tool wherein at least one of the plurality of interchangeable or replaceable tips comprises a generally optimized geometry and or flat fastener-engaging surface.

The fastener tool wherein at least one of the plurality of interchangeable or replaceable tips is adapted to cause the acoustic or ultrasonic energy to cause a vortex or helical energy to be applied internally to the fastener, the vortex or helical energy being in a predetermined direction.

The fastener tool wherein the predetermined direction is at least one of opposite a thread direction of threads on the fastener when loosening the fastener or the thread direction is the same as thread direction of threads when it is desired to tighten the fastener.

The fastener tool wherein the horn comprises a helical or frusto-conical surface for engaging the fastener to apply a longitudinal signal during loosening or tightening of the fastener.

The fastener tool wherein the fastener tool comprises a rotational force generator that is separate from the acoustic/ultrasonic generator, the rotational force generator generates the rotational tortional signal and force to rotate the fastener as the acoustic/ultrasonic generator generates the ultrasonic or acoustic energy that passes into the fastener.

The fastener tool wherein the horn comprises a fastener-engaging surface for engaging the fastener, the fastener engaging surface being adapted to create an energy vortex within the fastener that facilitates loosening or fastening the fastener.

The fastener tool wherein the fastener is threaded, the fastener engaging surface comprises an energy vortex, the energy vortex comprising a direction of rotation that opposes a helical direction of the threads of the fastener.

The fastener tool wherein the end comprises a head and/or nut that engages a mating surface at a head and/or nut engagement area where the head and/or nut engages the structure when the fastener is mounted thereto, the predetermined location being downstream/upstream of the head and/or nut engagement area so that when the ultrasonic or acoustic energy is applied to the fastener, a friction or pressure between the head and/or nut and the mating surface along with mating threads between the fastener and structure is at least partly reduced.

The fastener tool wherein the acoustic/ultrasonic generator applies the ultrasonic or acoustic energy at a frequency equal to or larger than 1 kHz.

The system wherein the fastener comprises a head and/or nut having a shoulder (if present) that engages the structure at a shoulder engagement area of the structure, the predetermined distance being between the head and/or nut and its mating structure surface(s) along with the mating threads of the fastener and structure(s).

The system wherein an end of the fastener comprises a head and/or nut that becomes situated at a head and/or nut engagement area of the structure when the fastener is mounted thereto, a predetermined location being along a length of the fastener and downstream/upstream of the head and/or nut engagement area so that when the acoustic/ultrasonic signal is applied to the fastener, a friction or pressure between the head and/or nut and its mating surface(s) along with the mating threads of the fastener and structure(s) is at least partly reduced.

The system wherein the fastener comprises threads that mate with mating threads, the predetermined location between the head and/or nut and its mating structure surface(s) along with the mating threads of the fastener and structure(s).

The system wherein the predetermined location is between the head and/or nut and its mating structure surface(s) along with the mating threads of the fastener and structure(s).

The system wherein the system comprises a rotational torque applicator adapted to apply a rotational torque to the fastener substantially simultaneously as the acoustic/ultrasonic signal passes through the fastener.

The system wherein a rotational torque applicator and the acoustic/ultrasonic wave generator are integrated into a common tool body.

The system wherein the horn is sized and adapted to receive a head and/or nut or end of the fastener.

The system wherein the horn is sized and adapted to receive a socket, screwdriver bit, and/or torque bit tip that is placed on a head and/or nut or end of the fastener to tighten or loosen the fastener, the socket, screwdriver bit, and/or torque bit tip receiving the acoustic/ultrasonic signal and causing it to pass into the fastener.

The system wherein a universal ultrasonic pivot joint comprises a first pivot joint that permits the horn to pivot in a first plane.

The fastener tool wherein a universal ultrasonic pivot joint comprises a first pivot joint that permits the horn to pivot in a first plane and a second pivot joint that permits the horn to pivot in a second plane, the second plane being different from the first plane.

The fastener tool wherein the second plane is offset approximately 90 degrees relative to the first plane.

The fastener tool wherein the first and second pivot joints are pivot pin joints.

The fastener tool wherein the fastening tool comprises a sleeve for covering a universal ultrasonic pivot joint and for defining a storage area about the pivot joint for storing a fluid, the fluid facilitating a transfer of the acoustic or ultrasonic energy through the horn and into the fastener to facilitate fastening or loosening the fastener.

The fastener tool wherein the sleeve is a flexible and adapted to permit the horn to pivot relative to and axis of the fastener tool and when a torque is applied to the horn.

The system wherein the fastener comprises threads that mate with mating threads, the predetermined location between the head and/or nut and its mating structure surface(s) along with the mating threads of the fastener and structure(s).

The system wherein the predetermined location is between the head and/or nut and its mating structure surface(s) along with the mating threads of the fastener and structure(s).

The system wherein the system comprises a rotational torque applicator adapted to apply a rotational torque to the fastener substantially simultaneously as the acoustic/ultrasonic signal passes through the fastener.

The system wherein a rotational torque applicator and the acoustic/ultrasonic wave generator are integrated into a common tool body.

The system wherein the horn is sized and adapted to receive a head and/or nut or end of the fastener.

The system wherein the horn is sized and adapted to receive a socket, screwdriver bit, and/or torque bit tip that is placed on a head and/or nut or end of the fastener to tighten or loosen the fastener, the socket, screwdriver bit, and/or torque bit tip receiving the acoustic/ultrasonic signal and causing it to pass into the fastener.

The system wherein the horn comprises a socket, screwdriver bit, and/or torque bit tip that is sized and adapted to receive a head and/or nut of the fastener.

The system wherein the predetermined distance being into the fastener between the head and/or nut and its mating structure surface(s) along with the mating threads of the fastener and structure(s).

The system wherein the fastener has a head and/or nut, the horn being adapted and sized to receive or engage the head and/or nut to apply a tightening or loosening torque to the head and/or nut when the acoustic/ultrasonic signal passes therethrough.

The system wherein the horn comprises a socket, screwdriver bit, and/or torque bit tip that is sized and adapted to engage the head and/or nut and apply a rotational torque when the acoustic/ultrasonic signal passes into the fastener.

The system wherein the system comprises a plurality of horns that are sized and adapted for a plurality of fasteners that have a plurality of heads. respectively, of different shapes or sizes.

The system wherein the horn is configured or adapted to receive a plurality of sockets, screwdriver bits, and/or torque bit tips of different sizes so that the horn may be used to apply the acoustic/ultrasonic signal directly into and through the socket, screwdriver bit, and/or torque bit tips and into the fastener when the fastener is being tightened or loosened.

The system wherein the horn comprises a horn body; at least one replaceable tip removably coupled to the horn body.

The system wherein the system comprises a plurality of interchangeable or replaceable tips of different shapes or sizes to accommodate fasteners of different shapes or sizes, respectively, the at least one replaceable tip being selected from the plurality of interchangeable or replaceable tips.

The system wherein the horn body comprises a plurality of replaceable tips to accommodate fasteners of different sizes.

The system wherein the horn body is threaded and the at least one replaceable tip comprises mating threads. a thread direction of the threads of the horn body being a direction opposite a thread direction of threads of the fastener.

The system wherein the horn body is threaded and the at least one replaceable tip comprises mating threads, the horn body threaded diameter being larger than the fastener threaded diameter.

The system wherein at least one of the plurality of interchangeable or replaceable tips comprises a generally optimized geometry and or flat fastener-engaging surface.

The system wherein at least one of the plurality of interchangeable or replaceable tips is adapted to cause the acoustic/ultrasonic signal to cause a vortex or helical energy to be applied internally to the fastener, the vortex or helical energy being in a predetermined direction.

The system wherein the predetermined direction is at least one of opposite a thread direction of threads on the fastener when loosening the fastener or the thread direction is the same as thread direction of threads when it is desired to tighten the fastener.

The system wherein the horn comprises a helical surface.

The system wherein the horn comprises a helical surface that causes the acoustic/ultrasonic signal to vortex in a predetermined direction for either loosening or tightening the fastener.

The system wherein the vortex is counterclockwise for a right-hand threaded fastener or clockwise for a left-hand threaded fastener to facilitate rotating the fastener when the acoustic/ultrasonic signal passes therein to loosen it.

The system wherein the vortex is clockwise for a right-hand threaded fastener or counterclockwise for a left-hand threaded fastener to facilitate rotating the fastener when the acoustic/ultrasonic signal passes therein to tighten it.

The system wherein the fastener comprises an end that is engaged by the horn during loosening or fastening, the acoustic/ultrasonic generator generating the acoustic/ultrasonic signal that travels into the fastener the predetermined distance and becomes concentrated or focused at a predetermined location in the fastener.

The system wherein the end comprises a head and/or nut that engages a mating surface of the structure at a head and/or nut engagement area where the head and/or nut engages the structure when the fastener is mounted thereto, the predetermined location being downstream/upstream of the head and/or nut engagement area so that when the acoustic/ultrasonic signal is applied to the fastener, a friction or pressure between the head and/or nut and its mating surface (s} along with the mating threads of the fastener and structure(s) is at least partly reduced.

The system wherein the horn is configured or adapted to receive a plurality of sockets, screwdriver bits, and/or torque bit tips of different sizes so that the horn may be used to apply the acoustic/ultrasonic signal directly into and through the socket, screwdriver bit, and/or torque bit tips and into the fastener when the fastener is being tightened or loosened.

The system wherein the acoustic/ultrasonic generator applies the acoustic/ultrasonic signal at a frequency equal to or larger than 1 kHz.

The system wherein the fastener has a head and/or nut, the horn being adapted and sized to receive the head and/or nut to apply a tightening or fastening torque to the head and/or nut while the acoustic/ultrasonic signal passes therethrough.

The system wherein the tool comprises a plurality of horns that are sized and adapted for a plurality of fasteners that have a plurality of heads, respectively, of different shapes or sizes.

The system wherein the horn comprises a helical or frusto-conical surface for engaging the fastener to apply a rotational torsional signal or force during longitudinal vibration of the fastener so that both a longitudinal signal and a tortional signal and force are substantially simultaneously applied to the fastener during loosening or tightening of the fastener.

The system wherein the acoustic/ultrasonic generator generates and applies the acoustic/ultrasonic signal, the tool comprising a rotational force generator that is separate from the acoustic/ultrasonic generator, the rotational force generator generates a tortional signal or force to rotate the fastener as the acoustic/ultrasonic generator generates the acoustic/ultrasonic signal passes into the fastener the predetermined distance.

The system wherein the horn comprises a fastener-engaging surface for engaging the fastener, the fastener engaging surface being adapted to create an energy vortex within the fastener that facilitates loosening or tightening the fastener.

The system wherein the fastener is threaded, the fastener engaging surface comprises an energy vortex, the energy vortex comprising a direction of rotation that opposes a helical direction of the threads of the fastener.

The system wherein the fastener comprises a head and/or nut and a shoulder (if present) that engages a mating surface at a head and/or nut engagement area of the structure when the fastener is mounted thereto, the predetermined location between the head and/or nut and its mating structure surface(s) along with the mating threads of the fastener and structure(s).

The system wherein the end comprises a head and/or nut that engages a surface at a head and/or nut engagement area where the head and/or nut engages a structure when the fastener is mounted thereto, the predetermined location being downstream/upstream of the head and/or nut engagement area so that when the acoustic/ultrasonic signal is applied to the fastener, a friction or pressure between the head and/or nut and its mating surface(s) along with the mating threads of the fastener and structure(s) is at least partly reduced.

The system wherein the system comprises an energy transfer facilitator for facilitating transferring the acoustic/ultrasonic signal into the fastener.

The system wherein the energy transfer facilitator comprises at least one of a fluid or material is arranged between the horn and at least one of the fastener or a socket, screwdriver bit, and/or torque bit tips mounted on the fastener, the fluid or minimally absorbing material of the acoustic/ultrasonic signal traveling into the fastener.

The system wherein the energy transfer facilitator may comprise but not limited to Teflon, oil, water, gel, foam, glycol, glycerin, and/or a polymer film or a minimally energy absorbing spacer.

The system wherein the fastener may be but not limited to an airplane, industrial, and/or automotive component fastener for fastening at least two components together.

The system wherein the horn comprises a predetermined resonant frequency selected to generally correspond to a fastener resonant frequency.

The fastener tool wherein the universal pivot joint comprises a knuckle having a first portion and a second portion; the first portion having a first aperture and the second portion having a second aperture; the first portion being pivotally coupled to the horn body with a first pivot pin; the second portion being pivotally coupled to the horn end with a second pivot pin.

The fastener tool wherein the first and second apertures are larger than a diameter or dimension of the first pivot pin and the second pivot pin, respectively, thereby permitting the loose coupling between the horn body and the horn end to facilitate the user's pivoting and placement of the horn end onto the fastener.

The fastener tool wherein the first pivot pin and the second pivot pin is a spring pin adapted to be secured to the horn body and passing through the first aperture to pivotally support the first portion on the horn body; the second pivot pin and the second pivot pin is a spring pin adapted to be secured to the horn end and passing through the second aperture to pivotally support the second portion on the horn end; the first and second apertures permitting the knuckle to float or move freely to facilitate placement of the horn end on the fastener, the knuckle becoming locked into energizing engagement with both the horn body and the horn end so that ultrasonic and acoustic energy can be passed therethrough after placement of the horn end on the fastener.

The fastener tool wherein the first portion is offset a predetermined offset angle relative to the second portion.

The fastener tool wherein the predetermined offset angle is about 90 degrees.

The fastener tool wherein the horn body has a horn body camming or engaging surface that generally compliments a first portion camming or engaging surface on the knuckle and the horn end has a horn end camming or engaging surface that generally compliments a second portion camming or engaging surface on the knuckle.

The fastener tool wherein a camming or engaging surface of the horn body cams or engages a camming or engaging surface of the first portion and a camming or engaging surface of the horn end cams or engages a camming or engaging surface of the second portion with a tolerance of less than about 0.0005 inch.

The fastener tool wherein during placement of the horn end, the camming or engaging surface of the horn body does not cam or engage the camming or engaging surface of the first portion and the camming or engaging surface of the horn end does not cam or engage the camming or engaging surface of the second portion with a tolerance of less than about 0.0005 inch.

The fastener tool wherein the horn body camming or engaging surface cooperates with the first portion camming or engaging surface to hone such the horn body camming or engaging surface and the first portion camming or engaging surface; horn end camming or engaging surface cooperates with the second portion camming or engaging surface to hone such the horn end camming or engaging surface and the second portion camming or engaging surface.

The fastener tool wherein the horn body, the horn end and the knuckle comprises material that is normalized at least once to facilitate orienting a grain to a predetermined grain pattern. such that the grain flows generally coaxially within the horn.

The fastener tool wherein the knuckle permits the horn end to pivot a predetermined maximum pivot angle relative to sad horn body, the predetermined maximum pivot angle is greater than 90 degrees.

The fastener tool wherein the predetermined maximum pivot angle is at least 110 degrees or more.

The fastener tool wherein the fastener tool comprises a rotational torque applicator for applying a rotational torque to the fastener while the ultrasonic or acoustic energy passes into the fastener; wherein the rotational torque is at least one of mechanical torque or an acoustic/ultrasonic torque that is applied substantially simultaneously as the horn causes the acoustic or ultrasonic energy to pass into the fastener.

The fastener tool wherein the horn is adapted to apply the rotational torque substantially simultaneously as the ultrasonic or acoustic energy passes into the fastener.

The fastener tool wherein the horn end comprises a socket, screwdriver bit, and/or torque bit sized and adapted to receive a head and/or nut of the fastener.

The fastener tool wherein the fastener comprises a head and/or nut, the ultrasonic or acoustic energy being at a predetermined location being along a length of the fastener so that when the ultrasonic or acoustic energy is applied to the fastener, a friction or pressure between the head and/or nut mating surfaces and mating thread surfaces between the fastener and the structure is at least partly reduced.

The fastener tool wherein the fastener comprises threads that mate with mating threads at a thread-engagement location, the predetermined location to be between the head and/or nut and its mating structure surface(s) along with the mating threads of the fastener and structure(s).

The fastener tool 8 wherein the predetermined location is between the head and/or nut and its mating structure surface(s) along with the mating threads of the fastener and structure(s).

The fastener tool wherein the predetermined location is between the head and/or nut and a distal end of the bolt, and a first thread of mating female threads.

The fastener tool wherein the tool comprises a housing, the acoustic/ultrasonic generator is situated inside the housing.

The fastener tool wherein the fastener has a head and/or nut, the horn being adapted and sized to receive or engage the head and/or nut to apply a tightening or loosening torque to the head and/or nut when the acoustic or ultrasonic energy passes therethrough.

The fastener tool wherein the horn comprises a socket, screwdriver bit, and/or torque bit tip that is sized and adapted to engage the head and/or nut and apply a rotational torque when the ultrasonic or acoustic energy passes into the fastener.

The fastener tool wherein the fastener tool comprises a plurality of horns that are sized and adapted for a plurality of fasteners that have a plurality of heads, respectively, of different shapes or sizes.

The fastener tool wherein the fastener tool comprises a plurality of horns that are sized and adapted for a plurality of fasteners that have a plurality of heads, respectively, of different shapes or sizes.

The fastener tool wherein the horn end is configured or adapted to receive a plurality of sockets, screwdriver bits, and/or torque bit tips of different sizes so that the horn may be used to apply the ultrasonic or acoustic energy directly into and through the socket, screwdriver bit, and/or torque bit tip and into the fastener when the fastener is being tightened or loosened.

The fastener tool wherein the horn body comprises at least one replaceable tip that is removably coupled to the horn body.

The fastener tool wherein the fastener tool comprises a plurality of interchangeable or replaceable tips of different shapes or sizes to accommodate fasteners of different shapes or sizes, respectively, at least one interchangeable or replaceable tip being selected from the plurality of interchangeable or replaceable tips.

The fastener tool wherein the horn body comprises a plurality of replaceable tips to accommodate fasteners of different sizes.

The fastener tool wherein the horn body is threaded and at least one of the plurality of replaceable tips comprises mating threads, a thread direction of threads of the horn body being a direction opposite a thread direction of threads of the fastener.

The fastener tool wherein the horn body is threaded and at least one of the plurality of replaceable tips comprises mating threads, mating thread on the horn being of a larger diameter than the mating threads on the fastener.

The fastener tool wherein at least one of the plurality of interchangeable or replaceable tips comprises a generally optimized geometry and or flat fastener-engaging surface.

The fastener tool wherein at least one of the plurality of interchangeable or replaceable tips is adapted to cause the acoustic or ultrasonic energy to cause a vortex or helical energy to be applied internally to the fastener, the vortex or helical energy being in a predetermined direction.

The fastener tool wherein the predetermined direction is at least one of opposite a thread direction of threads on the fastener when loosening the fastener or the thread direction is the same as thread direction of threads when it is desired to tighten the fastener.

The fastener tool wherein the horn end comprises a helical or frusto-conical surface for engaging the fastener to apply a longitudinal signal during loosening or tightening of the fastener.

The fastener tool wherein the acoustic/ultrasonic generator applies the ultrasonic or acoustic energy at a frequency equal to or larger than 1 kHz.

The knuckle wherein the predetermined angle is at least 90 degrees.

These and other objects and advantages of the invention will be apparent from the following description, the accompanying drawings and the appended claims.

### BRIEF DESCRIPTION OF THE ACCOMPANYING DRAWINGS

FIG. 1 is a view of the system and fastening tool having a replaceable tip;

FIGS. 2A-2B are views of a system and fastening tool and also a rotational torque applicator example;

FIGS. 3, 3A and 3B are views illustrating a focus of the ultrasonic or acoustic energy passing into the fastener;

FIG. 4 is another view illustrating the focus area and a predetermined focus point, along with an energizing curve;

FIGS. 5A-5D are illustrations showing the cyclic stress and heating that results from applying the ultrasonic or acoustic energy into the fastener;

FIG. 6 is a progressive view illustrating the ultrasonic or acoustic energy traveling into the fastener;

FIG. 7 is a bar diagram illustrating a reduction in the breakaway force required as a result of applying the system to a fastener;

FIG. 8 is a view of a plurality of horns having a plurality of differently shaped sockets, screwdriver bits, and/or torque bits for receiving different shaped fasteners, as well as a horn having a generally optimized geometry and or flat end;

FIG. 9 is an illustration of a plurality of replaceable and interchangeable tips that are threadably mounted onto an end of a horn, with each of the tips having either a socket, screwdriver bit, and/or torque bit adapted to receive and mate with a fastener head and/or nut or a flat tip;

FIGS. 10A-10B illustrate an applied force during loosening or tightening, respectively;

FIG. 11 is an illustration of a plurality of horns or tips that have a helical channel adapted to use a vortex within the fastener that facilitates loosening or tightening the fastener;

FIG. 12 is a view of the horn and fastener further illustrating an energy transfer facilitator for facilitating transfer of energy from the horn into the fastener;

FIG. 13 resonant frequency of the horn corresponding to the resonant frequency of the fastener;

FIG. 14 is a view of various representative bolt head designs used to facilitate energy transfer;

FIG. 15 is a view of another embodiment of other embodiments of the invention comprising a horn having at least one or a plurality of flexible ultrasonic joints that permit the horn end to pivot in at least one or a plurality of planes and at least partially about at least one or a plurality of axes;

FIGS. 16A-16B are views of an embodiment showing a single flexible ultrasonic joint;

FIG. 16C is a view similar to FIG. 16A showing the pivoting horn end adapted to receive a head of the fastener;

FIG. 16D is a view similar to FIGS. 16A-16C showing various features of another embodiment including a horn end receiving a tip and also showing a sleeve for covering the flexible ultrasonic joint and showing a body having a hex working surface;

FIG. 16E is an assembled and partial fragmentary view of the embodiment shown in FIG. 16B illustrating an ultrasonic fluid and/or lubricant situated in a fluid storage area defined by a sleeve;

FIG. 16F is a schematic view of the embodiments of FIGS. 16A-16E;

FIG. 16G is a sectional view along the line 16G-16G in FIG. 16F;

FIG. 16H is a view illustrating how the flexible ultrasonic joint as it would pivot about the axis;

FIG. 17A is a view of another embodiment showing a horn having pivot joints that permit the horn to pivot in a plurality of different planes and at least partially about a plurality of different axes;

FIGS. 17B-17C are exploded views showing various details of the embodiment shown in FIG. 17A;

FIG. 17D is an assembled view illustrating a sleeve mounted around the flexible ultrasonic joint;

FIG. 17E is a partial fragmentary view illustrating a fluid storage area about the flexible ultrasonic joint and showing a universal fluid and/or lubricant therein;

FIGS. 17F-17G are other exploded views showing various details of the embodiments shown in FIGS. 17A-17E showing the use of a tip adapted to receive the head of the fastener;

FIG. 17H is a full view of the embodiments of FIGS. 17A-17G;

FIGS. 18A-18B illustrate at least one flexible ultrasonic joint having a “dry” connection;

FIGS. 18C-18D is a view similar to FIGS. 18A-18B, except it shows at least one flexible ultrasonic joint having spaced relationship between parts for use in a “wet” environment;

FIGS. 19A-19D are similar to the embodiment shown in FIGS. 17A-17H, except that this embodiment is preferably used in a “dry” environment;

FIGS. 20A-20G illustrate another embodiment showing an intermediate coupler having spaced projections or legs on each end and oriented in different planes to provide a flexible ultrasonic joint that comprises a plurality of pivot joints;

FIGS. 21A-21D are views of another embodiment of the invention with a fastener tool with an extension that comprises a predetermined shape which in the embodiment is 90 degrees as illustrated in the figures and having a predetermined grain flow pattern in the armature or horn;

FIGS. 22A-22D are views of another embodiment of the invention illustrating an elongated portion compared to the extension shown in FIGS. 21A-21D;

FIGS. 23A-23C illustrate another embodiment of the invention with the extension having a predetermined angle that is obtuse;

FIGS. 24A-24C also illustrate the fastener tool having an extension having a variable curvature or bend that is obtuse and about 25 degrees;

FIGS. 25A-25C illustrate yet another embodiment of the fastener tool showing an extension having a formed curvature or bend that provides a 110 degree horn assembly;

FIGS. 26A-26E illustrate another embodiment showing a flexible horn assembly having an extension that is flexible and can assume or be manipulated into a plurality of different shapes or predetermined angles so that a socket on the fastener tool can be manipulated into extreme positions such that the business end of the horn is not coaxial with an axis of the handheld portion of the tool, while a liquid conductor resident and sealed in the horn, extension or flexible tubing conducts the ultrasonic energy from the handheld ultrasonic booster to the socket;

FIGS. 27A and 27B illustrate representations of the affective and non-affective manufacturing procedures;

FIG. 28 illustrates a grain flow pattern;

FIG. 29A is a perspective view of the tool having a universal flexible ultrasonic joint;

FIG. 29B is an end view of the tool showing the horn end pivoted downward as viewed in the FIG. 29A;

FIG. 29C is an end view of the tool of FIG. 29A;

FIG. 29D is a partial sectional view taken along the line 20D-20D in FIG. 29B;

FIG. 29E is a partial sectional view taken along line 29E-20E in FIG. 29C;

FIGS. 30A-30E are line drawings showing the horn end pivoting in a plurality of different planes relative to the horn body;

FIGS. 30F-30H are solid works drawings further illustrating the universal pivotal nature of the universal flexible ultrasonic joint;

FIGS. 31A-31B are exploded views showing various details of the universal flexible ultrasonic joint and a knuckle used therein;

FIGS. 32A-32F are sectional views illustrating various features of the tool embodiment having the universal flexible ultrasonic joint; and

FIGS. 32G-32I illustrate the “play” and various gaps G1-G4 that are provided to permit the horn end to be easily placed onto the head of the fastener.

### DETAILED DESCRIPTION OF THE PREFERRED EMBODIMENTS

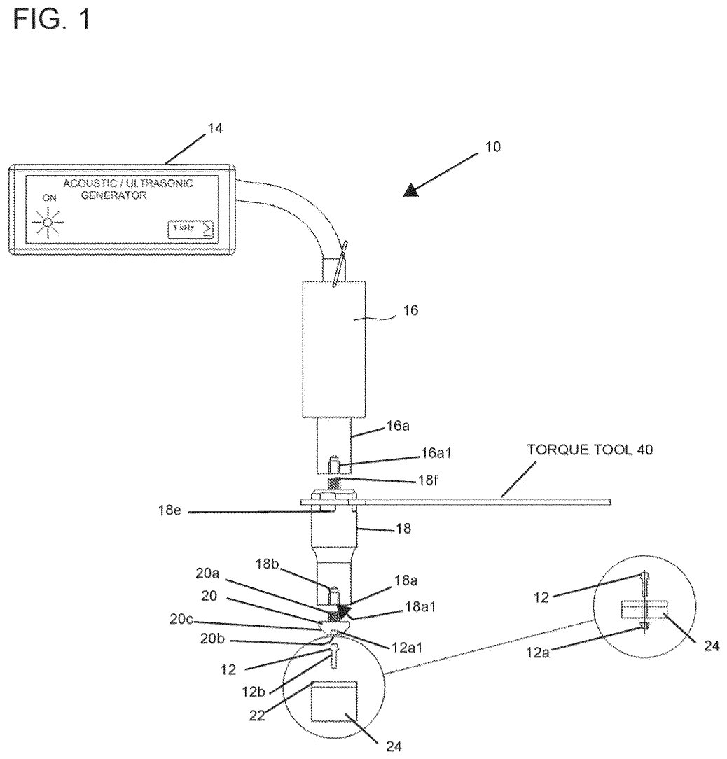

Referring now to FIGS. 1-14 a tool or system 10 and method for loosening or tightening a fastener 12 will now be described. The system 10 (FIG. 1) comprises an acoustic/ultrasonic wave generator 14 for generating an ultrasonic or acoustic energy or signal that passes longitudinally through the fastener 12 to elongate and shorten the fastener 12 and to introduce a cyclic strain and heating within the fastener 12 to reduce a frictional force between the fastener 12 and structures 22 and 24. In this regard, details of the cyclic or acoustic/ultrasonic strain, heating and elongation of the fastener 12 will be described in more detail later herein.

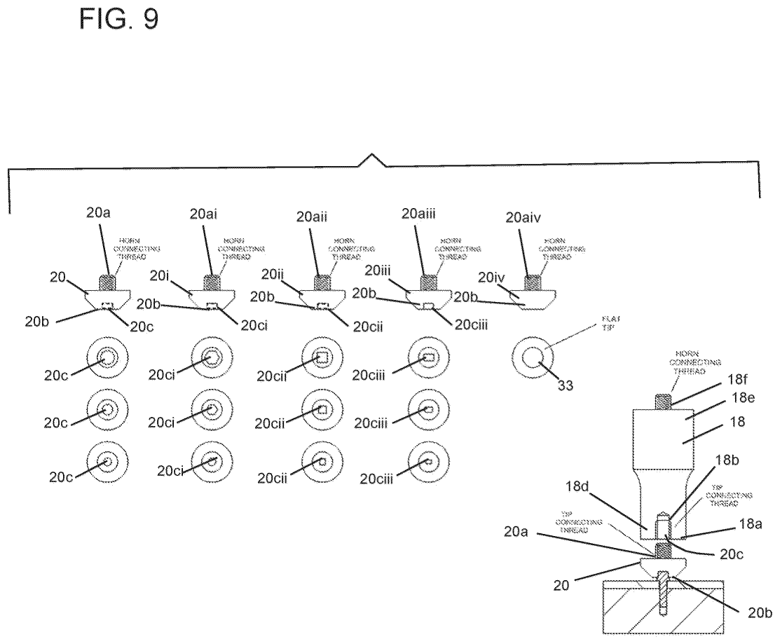

The system 10 comprises the acoustic/ultrasonic generator 14 which, in a preferred embodiment, applies an ultrasonic or acoustic energy at a frequency equal to or larger than 1 KHz. The acoustic/ultrasonic generator 14 is coupled to a fastener tool 16 that comprises an armature 16a, which is coupled to a horn 18 as shown. Note that the horn 18 comprises a socket, screwdriver bit, and/or torque bit tip 20 for receiving a head and/or nut 12a of the fastener 12. The horn 18 comprises a threaded aperture 18a1 that threadably receives a threaded projection 20a of the socket, screwdriver bit, and/or torque bit tip 20. In other embodiments described later relative to FIG. 9, the socket, screwdriver bit, and/or torque bit tip 20 is integrally formed in an end 18a of the horn 18. In other embodiments illustrated in FIGS. 1 and 9, the horn 18 may have an interchangeable or replaceable socket, screwdriver bit, and/or torque bit tip 20 which will be described later herein relative to FIG. 9.

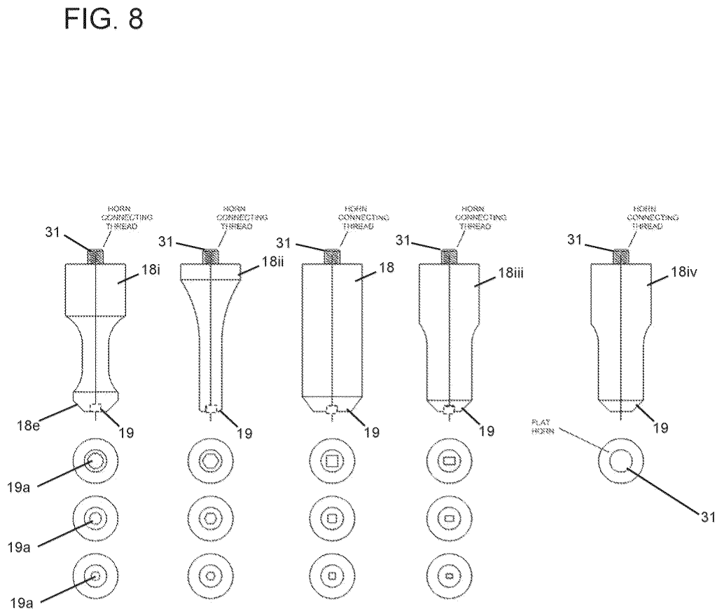

In the illustration being described relative to FIG. 8, the horn 18 comprises the end 19 which is adapted to define the socket, screwdriver bit, and/or torque bit opening 19 and is sized and adapted to complement the size and shape of the head and/or nut 12a of the fastener 12. The horn 18 may engage the fastener 12 and apply a cyclic or acoustic/ultrasonic energy thereto when the acoustic/ultrasonic generator 14 is energized. Thus, it should be understood that the horn 18 may be a uniform, monolithic construction with the end 19 having the socket, screwdriver bit, and/or torque bit opening 19 adapted and sized to mate with and receive the fastener head and/or nut 12a. This is illustrated in FIG. 8.

Alternatively in FIG. 9, the horn 18 may accept a generally optimized geometry and or flat and opposing tool-engaging surfaces that is adapted and sized to threadably receive at least one socket, screwdriver bit, and/or torque bit tip 20 that comprises the threaded projection 20a and on an opposite end 20b the aperture 20c that is adapted and sized to mate with the head and/or nut 12a of the fastener 12. In this regard, a user selects at least one socket, screwdriver bit, and/or torque bit tip 20 that is complimentary and sized to mate with the head and/or nut 12a of the fastener 12 to be worked on so that the tool can apply the cyclic and acoustic/ultrasonic energy described herein, as well as a rotational torque in some embodiments that will also be described later herein. Note that each of the sockets, screwdriver bits, and/or torque bit tips 20 can have the same or a different configuration or shape so that they can each accommodate and receive the head and/or nut 12a of the fastener 12 having a complimentary shape. FIG. 9 shows a plurality of sockets, screwdriver bits, and/or torque bit tips 20 that can be selectively and threadably mounted in the end 20c of the horn 18. Alternatively, and as mentioned herein relative to FIG. 8, the horn 18 may be a monolithic one piece construction that has the socket, screwdriver bit, and/or torque bit opening 19 that is adapted to receive the head and/or nut 12a of the fastener 12.

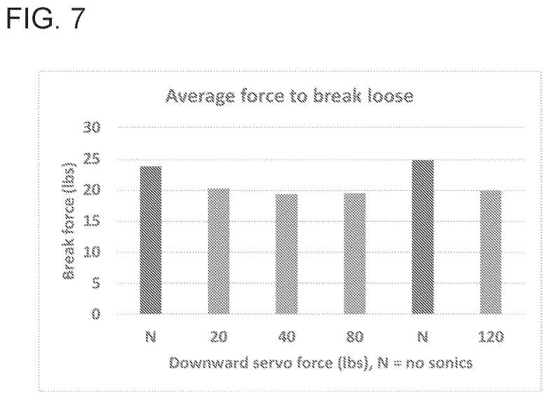

In one embodiment, a plurality of sockets, screwdriver bits, and/or torque bit tips 20 are provided in a set for selection by a user and the appropriate socket, screwdriver bit, and/or torque bit tips 20 for a particular fastener 12 is identified and selected and then threadably mounted in the threaded aperture 20c on the end 18a of the horn 18, as illustrated in FIGS. 1 and 9. FIG. 1 shows an exploded view of the various parts. In this illustration, the fastener 12 is used to secure a first part or structure 22 to the second part or structure 24. It should be understood that one primary feature or function of the system 10 is to unscrew or loosen the fastener 12 that is locked or frozen (i.e., won't loosen/remove without damage) to the structures 22 and 24. It is not uncommon, for example, in the airplane engine industry along with other industries, that the fasteners 12 and structures 22 and 24 are subjected to various environmental conditions, material mismatches, and temperatures during normal operation that can cause the fastener 12 to be seized/locked or difficult to “break” from the structures 22 and 24. When this happens, the fastener 12 cannot be unfastened without either stripping the head and/or nut 12a of the fastener 12 or causing the head and/or nut 12a to break off when a rotational torque is applied to the head and/or nut 12a. The inventor has found that by the selective and focused application of the cyclic and acoustic/ultrasonic energy as described herein by the acoustic/ultrasonic wave generator 14, armature or fastener tool 16 and horn 18, reductions in the “breaking/break away force” have been realized as will be described in more detail later herein relative to FIG. 7.

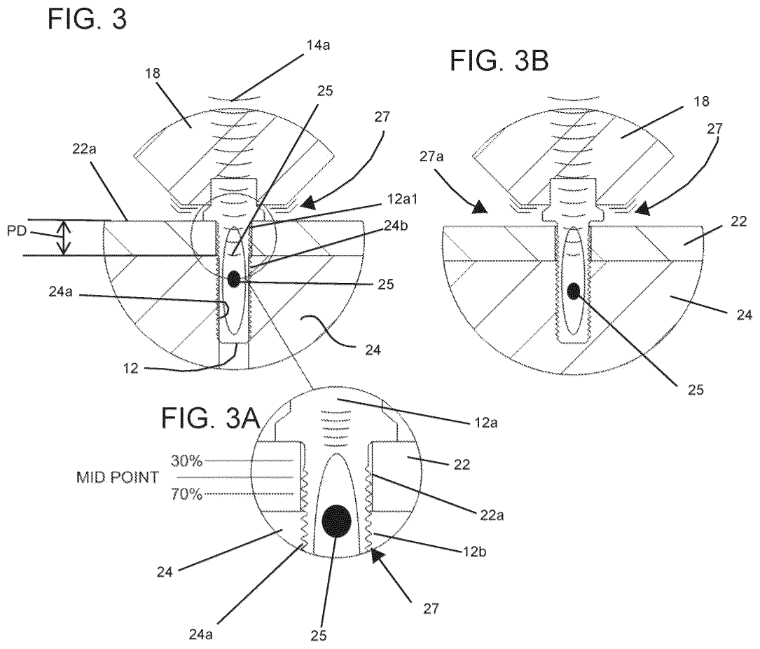

In this regard, the acoustic/ultrasonic wave generator 14 and the horn 18 or the socket, screwdriver bit, and/or torque bit tips 20 for the embodiments of FIGS. 1 and 9 cooperate to focus or apply the acoustic/ultrasonic signal to focus the ultrasonic or acoustic energy at a predetermined focus area 25 (FIG. 3), which is a predetermined distance PD (FIG. 3) into the fastener 12. This, in turn, reduces a coefficient of friction between the threads 12b (FIG. 3) of the fastener 12 and the threads 24b of the structure 24 when the horn 18 is in operative relationship with the fastener 12 and the acoustic/ultrasonic signal from the acoustic/ultrasonic generator 14 is applied thereto.

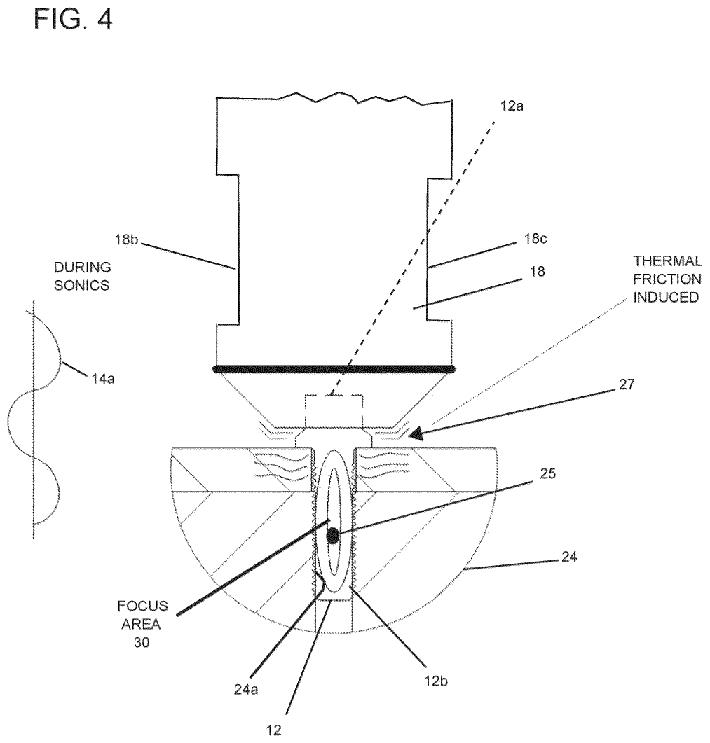

Referring now to FIGS. 3, 3A and 4, the acoustic/ultrasonic signal and the predetermined distance PD will now be described. Note that the fastener 12 secures the structure 22 to the structure 24. The structure 22 has the surface 22a that is sized and adapted to allow the fastener 12 to be inserted therethrough. The structure 24 comprises the threaded opening 24a that is adapted and sized to mate with and receive the threads 12b of the fastener 12. The acoustic/ultrasonic waveform 14a is illustrated in FIGS. 3, 3A and 3B and is generated by the acoustic/ultrasonic generator 14 and transmitted longitudinally (as viewed in FIGS. 3 and 3B) down the longitudinal length of the fastener 12. In one embodiment, the predetermined distance PD is a distance that is below the bolt/screw head and/or nut 12a1 of the head and/or nut 12a of the fastener 12 where it engages a surface 22a and the predetermined focus area or point 25 of concentrated energy applied by the acoustic/ultrasonic generator 14. Note that the predetermined focus area 25 is concentrated energy that is generally situated along a longitudinal length or axis of the fastener 12 and can be throughout the threaded surface 24a of the structure 24.

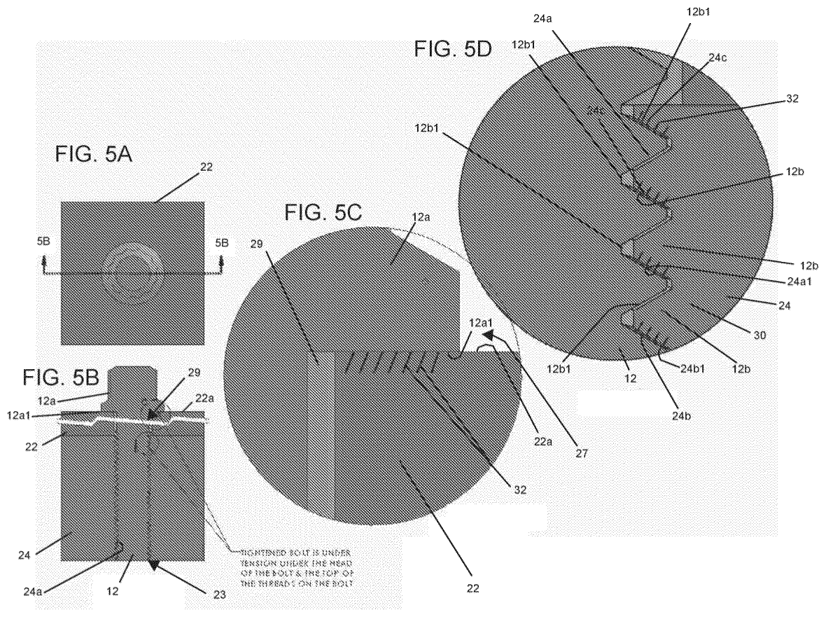

FIGS. 3-3B and 5A-5D illustrate the cyclic and acoustic/ultrasonic energy being applied to the fastener 12. This energy, in turn, causes a cyclic strain between the threads 12b (FIG. 5D) of the fastener 12 and the threads 24a of the structure 24. Notice that the head and/or nut 12a of the fastener 12 and the shoulder (if present) 12a1 become situated at a head and/or nut engagement area 27 (FIG. 5C) of the structure 22 or surface 22a when the fastener 12 is secured or screwed into the structure 24. It should be understood that the predetermined distance PD between the shoulder (if present) 12a1 and the predetermined focus area 25 is such that the predetermined focus area 25 is generally along a longitudinal length of the fastener threads 12 and downstream/upstream of the head and/or nut engagement area 27 so that when the ultrasonic or acoustic energy is applied to the fastener 12, a friction or pressure between the bolt and/or nut 12a1 and a mating surface 22a of the structure 22 (FIG. 5C) along with the frictional reduction between the fastener threads 12b1 and the structure thread 24b1 is at least partially reduced which in turn facilitates loosening the fastener 12, especially if a rotational torque is applied thereto. The inventor has found that the rotational torque necessary to loosen the fastener 12 is reduced compared to the torque that is necessary to loosen the fastener 12 when no acoustic/ultrasonic energy is applied. This will be described in more detail relative to FIG. 7.

Furthermore, during acoustic/ultrasonic energy application the bolt/screw head/nut elongates and a gap 27a becomes present between the bottom of the bolt/screw head 12a1 and the top of the surface of 22a. This gap 27a is illustrated in FIG. 3B. The lifting up the bolt/screw or nut head from the surface of 22 or 24 reduces the surface friction and ultimately the rotational torque require to loosen the fastener.

FIGS. 5A-5D illustrate these features in greater detail. FIGS. 5A-5D illustrate these features in greater detail. For ease of understanding, FIG. 5B shows a simplified fragmented and sectional view showing that the structure 24 has an aperture 23 and internal threads 24a. In FIG. 5B, note that the fastener 12 secures the structure 22, which has the unthreaded aperture 29 (FIGS. 5B and 5C), so that the fastener 12 can pass therethrough. As illustrated in FIG. 5B, the fastener 12 secures the structure 22 to the structure 24. Note that as the fastener 12 is tightened, it places the head and/or nut 12a and shoulder (if present) 12a1 of the fastener 12 under tension (illustrated in FIG. 5C) against the top surface 22a. This is illustrated in FIG. 5C where the shoulder (if present) 12a1 cooperates with the top surface 22a which results in a tension between the surfaces 22a and bottom of the bolt/screw head 12a1. The tension introduces heat in the fastener 12 and is represented by tension or strain lines or curves 32 in FIG. 5C.

FIG. 5D illustrates the resulting tension between the threads 12b of the fastener 12 and the threads 24b of the structure 24. Note the tension and strain at the upper surfaces 12b1 of the threads 12b of the fastener 12 and the bottom surfaces 24b1 of the structure threads 24b.

Referring back to FIG. 4, notice that a focus area 25 is where the ultrasonic or acoustic energy is focused in the fastener 12. FIG. 3B illustrates the acoustic/ultrasonic waveform 14a that is applied to the horn 18 and which causes the acoustic/ultrasonic and cyclic elongation, shortening and strain between the fastener 12 and the structures 22 and 24. The energizing waveform 14a (FIG. 4) causes the acoustic/ultrasonic action, and a thermal friction is induced as illustrated by the tension or strain lines or curves 32 in FIGS. 5C and 5D. As mentioned, the acoustic/ultrasonic energy causes the fastener 12 to elongate and shorten in response to the sinusoidal input energy or waveform 14a which also causes a strain between the upper surfaces 12b1 of the threads 12b and the mating lower surfaces 24b1 of the threads 24b. Again, the tension or strain lines or curves 32 is represented by the tension or strain lines or curves 32 in FIGS. 5C and 5D. It should be understood that the tension or strain lines or curves 32 cause a cyclic heating of the threads 12b and threads 24b which causes an external expansion and contraction of the fastener 12 along its longitudinal length which in turn induces more heating. The application of the acoustic/ultrasonic energy in response to the sinusoidal waveform 14a (FIG. 4), along with the thermal friction inducement between the head and/or nut 12a of the fastener 12 and the structures 22 and 24, all cooperate to reduce or facilitate reducing the amount of torque necessary to unloosen or tighten the fastener 12 from or to, respectively, the structures 22 and 24.

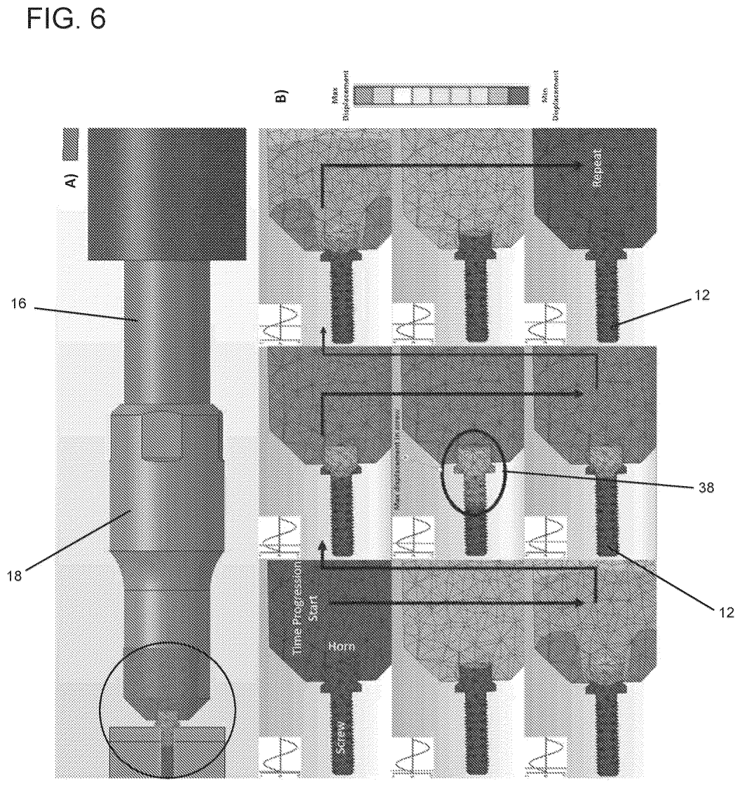

FIG. 6 is a graphic example stress diagram of various stress levels that occur during the application of the acoustic/ultrasonic energy. Notice in the illustration that the stress and application of energy is zero in the bottom left-hand portion of the FIG. 6 and progresses along the progression arrows as illustrated. The sinusoidal waveforms associated with each view illustrate timing diagrams of the application of the energy. Note that as the acoustic/ultrasonic energy is applied, stress increases first from the top of the fastener 12 until the acoustic/ultrasonic energy is applied into the fastener 12 along its length in the area 38 as described earlier herein. Again, the acoustic/ultrasonic energy causes an expansion and contraction in response to the acoustic/ultrasonic waveform 14a which in turn causes the thermal friction to be induced during the application of the acoustic/ultrasonic energy. Preferably, when the acoustic/ultrasonic energy is in the area 38 and along the length of the fastener 12, a rotational torque may be substantially simultaneously applied to the horn 18 in order to rotate the fastener 12 and loosen it from the structures 22 and 24. Ultimately, as the acoustic/ultrasonic generator 14 reduces the application of the acoustic/ultrasonic energy applied to the horn 18 which causes the acoustic/ultrasonic energy to recede from the fastener 12 as illustrated. Note that a maximum heating or displacement, linear motion, longitudinal motion occurs in the central view. Notice that the color red indicates heat generation and blue is relatively cool or cold. The system 10 is energized for as long as it takes to free the fastener 12.

FIG. 7 is an example bar graph showing an average force to break or loosen the fastener 12 from the structure 24 in the illustration being described. These numbers are illustrative only and will change depending on the size of the fastener 12, size of the structures 22 and 24, break force between the fastener 12 and the structures 22 and 24 and the like. The columns identified with the letter “N” illustrate examples of a similar size fastener 12, but where no acoustic/ultrasonic energy is applied through the horn 18 to the head and/or nut 12a of the fastener 12. The other columns illustrate several examples of the break force when sonics were applied. Note that in all examples where the system 10 was used, the break force was reduced by about 5 pounds force as a result of the acoustic/ultrasonic generator 14 applying acoustic/ultrasonic energy to the horn 18 and into the fastener 12. Notice that the break force without the acoustic/ultrasonic energy was roughly 5 pounds force greater.

Referring back to FIG. 3B, it should be understood that the acoustic/ultrasonic generator 14 applies the energizing waveform 14a (FIG. 4) to the fastener tool 16 which in turn imparts the acoustic/ultrasonic energy directly to the horn 18. When the horn 18 is mounted on the head and/or nut 12a of the fastener 12, that energy is transmitted directly into the fastener 12 along its longitudinal length. As was also mentioned earlier herein, this creates tension and thermal friction is induced between the threads 12b of the fastener 12 and the threads 24b of the structure 24. Note that the predetermined location of the predetermined focus area 25 is in the fastener 12 and spaced from the head and/or nut engagement area 27 as illustrated in FIGS. 3, 3A and 3B. The predetermined focus area 25 with focused energy is along the length of the fastener 12 and under the head and/or nut engagement area 27 so that when ultrasonic or acoustic energy is applied to the fastener 12, the friction pressure or break force between the head and/or nut 12a and the mating surface 24a is at least partly reduced. As mentioned earlier, this also causes a reduction in the stress between the shoulder (if present) 12a1 of the head and/or nut 12a and the surface 22a of the structure 22. Moreover, it also causes a reduction in the friction or pressure between the upper surfaces 12b1 and the thread surfaces 12a1 as a result of the application of the ultrasonic or acoustic energy in response to the input waveform 14a.

As mentioned earlier herein, during the application of the ultrasonic or acoustic energy by the acoustic/ultrasonic generator 14, it is preferable to apply a rotational torque to the fastener 12. Accordingly, the system 10 has multiple means and apparatus for generating or performing such rotational torque which will now be described.

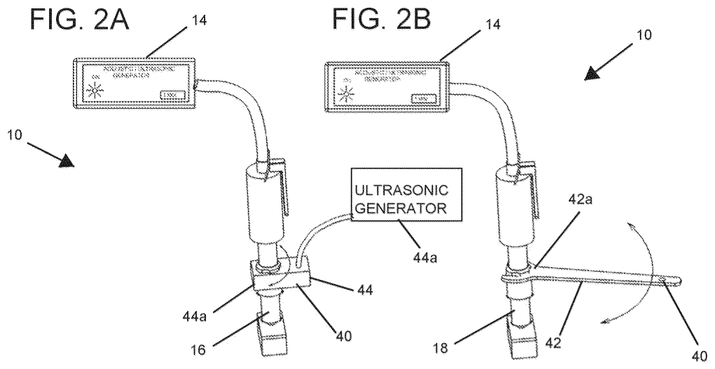

Referring now to FIGS. 2A and 2B, it should be understood that the system 10 may comprise a rotational torque applicator 40 for applying a rotational torque to the fastener 12 substantially simultaneously as the ultrasonic or acoustic energy passes into the fastener 12. The rotational torque applicator 40 may comprise at least one of a mechanical torque applicator in the form of a wrench 42 (FIG. 2B) or tool sized and adapted to engage the generally optimized geometry and or flat and opposing tool-engaging surfaces 18b and 18c (FIG. 4) in order to permit manual rotational torque application. Alternatively, an acoustic/ultrasonic torque applicator 44 that is coupled to an acoustic/ultrasonic generator 44a which generates an acoustic or ultrasonic signal which energizes the wrench 42 to rotationally drive the horn 18 which in turn rotatably drives the fastener 12. The torque applicator may also just provide just a rotational motion without acoustic/ultrasonics as illustrated in item 40 and 44. In this regard, note that the horn 18 may have a plurality of generally optimized geometry and or flat areas and opposing tool-engaging surfaces 18b and 18c (FIGS. 1 and 3B) that are sized and adapted to receive the working end 42a of the wrench 42. Likewise, the tool 40 also has a mating tool end (not shown) that is adapted and sized to engage the generally optimized geometry and or flat and opposing tool-engaging surfaces 18b and 18c in order to rotatably drive the horn 18. Other means for rotatably driving the tool may also be applied, such as pneumatic, electric or other automatic tool.

In one illustrative embodiment, the acoustic/ultrasonic generator 14 and the rotational torque applicator 40 may be either the Dukane IQ 600W handheld or a Dukane IQ 2400W Servo, both of which are available from Dukane Corp. located at 2900 Dukane Drive St. in Charles, Illinois 60174.

It is important to understand that the rotational torque applicator 40 preferably applies the rotational torque to the horn 18 substantially simultaneously as the ultrasonic or acoustic energy from the acoustic/ultrasonic generator 14 passes into the fastener 12. The inventors have found that by causing the acoustic or ultrasonic energy to pass to the predetermined focus area 25 causes the elongation of the fastener 12 in the cyclic heating and stress between the threads 24a and the threads 12b of the fastener 12 as mentioned earlier, which facilitates loosening the fastener 12 when a rotational torque is applied substantially simultaneously.

Referring now to FIGS. 8 and 9, further details of various embodiments of the horn 18 and the at least one replaceable tip socket, screwdriver bit, and/or torque bit tips 20 will be described relative to FIGS. 8 and 9. The inventors have found that the individual horns 18 may be configured and adapted to have a predetermined shape that is selected depending upon the acoustic effect and focus desired Different shapes affect the characteristics of the sonics through the horn such as horn amplitude, the resonance frequency, location of focused energy, internal stress of the horn. Different sizes are also needed for the different sized fasteners and also for fitting in different locations. Helix is a shape as well. In the illustrations being described, the inventors have found that different shapes cause the predetermined focus area 25 of the focused ultrasonic or acoustic energy to be adapted or changed depending on various parameter, such as the size and type of fastener 12, the length of the fastener 12, and the like. For ease of illustration, FIG. 8 shows five different embodiments of horns (18, 18i, 18ii, 18iii, 18iv), but it should be understood that other shapes and sizes of horns 18 with a predetermined working end socket, screwdriver bit, and/or torque bit tips may be selected as well and that these are only exemplary.

In the embodiment illustrated in FIG. 8, the fastener tool 16 comprises a plurality of horns, 18, 18i, 18ii and 18iii that are sized and adapted for a plurality of fasteners 12 that have a plurality of heads of different shapes or sizes, respectively. Note in FIG. 8 that a plurality of each of these shapes and sizes may be provided to accommodate fasteners 12 having heads/nuts 12a that are complementary in shape and size, respectively. Notice in FIG. 8 that each of the horns 18, 18i, 18iv each have an end that has an aperture or socket, screwdriver bit, and/or torque bit tip 19 in order to accommodate different shapes and sizes of heads 12a of different fasteners, respectively. Below each of the horns 18, 18i, 18ii and 18iii is shown illustrative ends of a plurality of horns 18, each of which having different apertures or sockets, screwdriver bits, and/or torque bit tips 19 to accommodate different shapes and sizes of heads 12a of the fasteners 12. Of course, more or fewer horns 18 may be provided. Thus, it should be understood that each of the horns 18, 18i, 18ii and 18iii is configured or adapted to provide a plurality of horns 18 that are sized and adapted for a plurality of different fasteners 12 that have a plurality of heads 12a of different shapes or sizes.

With respect to the horn 18iv, notice that the end does not have the socket, screwdriver bit, and/or torque bit tip 19, but rather, a flat area 31 for engaging a top surface of the head/nut. Although not shown, this horn 18iv is adapted to engage not only the head and/or nut 12a, but it could engage either end of the fastener 12, especially if the fastener 12 does not have a head and/or nut 12a of the type shown and described herein. This particular horn 18iv may also be used to engage a head and/or nut 12a and apply acoustic/ultrasonic energy into the fastener 12, without receiving the fastener head and/or nut 12a. The benefits of a flat horn 19 is for when a bolt/screw is in a place where the full socket cannot or will not fit over the bolt/screw head and/or nut, where one might need to use different torque applicator on the bolt/screw head and/or nut that is not the horn itself, or when access to the bolt/screw head and/or nut face and a nut is on an opposite side, where axis is to an end of the bolt/screw shank.

Referring now to FIG. 9, other embodiments are illustrated. In these embodiments, the horn 18 may be configured or adapted to receive a plurality of sockets, screwdriver bits, and/or torque bit tips 20, 20i, 20ii, 20iii and 20iv of different sizes so that the horn 18 may be used to apply the ultrasonic or acoustic energy into and through the socket, screwdriver bit, and/or torque bit tips 20 and into the fastener 12 when the fastener 12 is being tightened or loosened. Notice in the right-most portion of FIG. 9 that the horn 18 comprises a horn body 18e having a threaded projection 18f which is mounted into the threaded aperture 16a1 (FIG. 1) of the armature 16a of the fastener tool 16. The end 18d (FIG. 9) also comprises a threaded aperture 20c for receiving the threaded projection 20a of at least one of the sockets, screwdriver bits, and/or torque bit tips 20. Again, and similar to FIG. 8, notice that the sockets, screwdriver bits, and/or torque bit tips 20, 20i, 20ii, 20iii and 20iv each have the end 20b having the working apertures 20c, 20ci, 20cii, 20ciii and 20civ that is adapted and sized to receive and mate with the head and/or nut 12a of the fastener 12. As with the embodiments discussed earlier herein, the aperture 20c is adapted and sized to complement a shape of the head and/or nut 12a of the fastener 12. Again, the plurality of sockets or tips 20, 20i, 20ii, 20iii and 20iv may be provided in a set or kit to accommodate fasteners 12 of different shapes and sizes. As with the horn 18iv in FIG. 8, at least one socket, screwdriver bit, and/or torque bit tips 20iv may be provided with a flat area 33 for engaging at least a part or surface of the fastener 12.

As illustrated in FIG. 9, the horn 18 is threadably mounted onto the armature 16a (FIG. 1) and then at least one socket, screwdriver bit, and/or torque bit tip 20 is selected and then threadably mounted to the end 18a of the horn 18 as shown. Accordingly, after a user determines the fastener 12 that needs to be loosened or tightened, the user selects the appropriate socket, screwdriver bit, and/or torque bit tip 20, 20i, 20ii, 20iii and 20iv that mates with the head and/or nut 12a of the fastener 12. Alternatively, the user may select the socket, screwdriver bit, and/or torque bit tip 20iv if it was desired to use a tip with a flat end 33.

Advantageously, the at least one replaceable socket, screwdriver bit, and/or torque bit tip 20 comprises a plurality of interchangeable or replaceable tips or sockets of different sizes and shapes to accommodate fasteners 12 of different sizes and shapes, respectively, with at least one of the replaceable sockets or tips 20 being selected from the plurality of interchangeable or replaceable sockets or tips 20 during use of the system 10. During use, the sockets or tips 20, 20ai, 20aii, 20aiii, and 20aiv are threadably secured to the horn 18 when the threaded projection 20a is mounted into the threaded receiving area 20c as illustrated in FIG. 9. The horn 18 is then used to loosen or tighten the fastener as described herein.

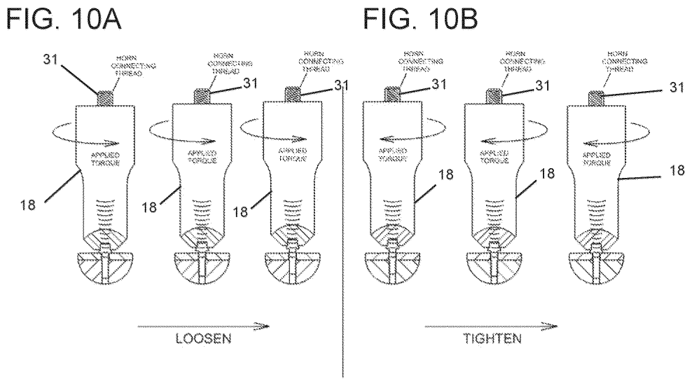

Referring now to FIGS. 10A and 10B, notice the thread direction or thread handedness of the threaded projection 31 on the horn 18 (FIG. 8) and of threaded projection 20a in FIG. 9 are generally in a direction that is directly opposite of a thread direction of the fastener 12. In other words and as illustrated in FIG. 10A, if it is desired to loosen the fastener and rotate the horn 18 in a counter-clockwise direction, then the threads 31 of the horn 18 are provided in a clockwise direction. Alternatively, if the horn 18 is being applied to tighten a fastener 12 by rotating the fastener 12 in a clockwise direction, then the direction of the threads 31 on the horn 18 are in a counter-clockwise direction. One could also use a substantially larger threaded connector that is in the same direction but torqued much higher than the bolt/screw that is being unfastened. Either of these are to prevent the horn/horn tip from becoming unthreaded when applying sonic or acoustic energy.

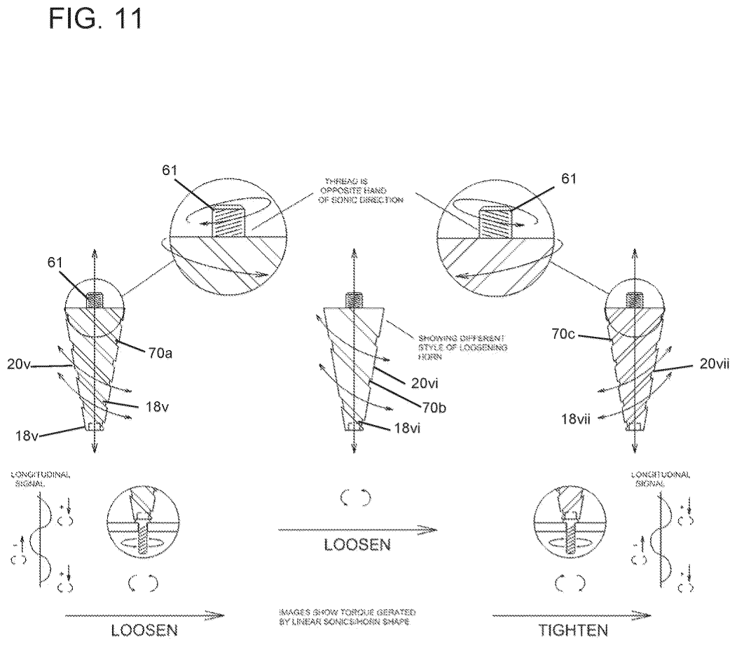

FIG. 11 illustrates still another embodiment of possible horns 18 or sockets or tips 20v, 20vi and 20vii. For ease of illustration, FIG. 11 illustrates both a plurality of horns 18v, 18vi and 18vii and a plurality of sockets or tips 20v, 20vi and 20vii that are adapted to cause an acoustic or ultrasonic energy that causes a vortex or helical energy internally in the fastener 12 which, in turn, facilitates loosening or tightening the fastener 12. In this regard, the vortex or helical energy is selected to be in a predetermined direction which is defined by the shape of the horn 18, three of which are illustrated in FIG. 11. Note that the horns 18v, 18vi and 18vii or sockets or tips 20v, 20vi and 20vii are frusto-conical in shape and each comprise a helical groove 70a, 70b and 70c. FIG. 11 shows three illustrative embodiments of the horns 18v, 18vi and 18vii. Notice that the horns 18 or sockets or tips 20v and 20vi cause a counter-clockwise rotational vortex or helical application of energy to be applied to the screw. The thread of the threaded projection 20a has a thread direction that is opposite hand of the sonic direction caused by the vortex or helical energy. It should be understood that the vortex or helical energy travels into the fastener 12 and causes not only an elongation and shortening of the fastener 12 but also a slight rotational force or movement of the fastener 12 when the horn 18 is energized after it is placed on the head and/or nut 12a of the fastener 12.

In contrast, note that the horn 18viii or socket, screwdriver bit, and/or torque bit or tip 20vii has a helical groove 70b in a clockwise direction which causes an acoustic vortex or helical energy to apply a clockwise rotational and helical force to be applied to the fastener 12 which results in tightening the fastener 12 after the horns 18v, 18vi, 18vii or sockets or tips 20v, 20vi or 20vii are mounted to the horn 18.

Advantageously, the system 10 comprises at least one or a plurality of helical grooves 70a-70c that cause the acoustic/ultrasonic signal to vortex in a predetermined direction that is selected depending on whether or not the user wishes to loosen or tighten the fastener 12. For example, the vortex may be selected to be counter-clockwise for a right-handed threaded fastener 12 or clockwise for left-handed threaded fastener 12 to facilitate rotating the fastener 12 when the acoustic/ultrasonic signal passes therein to loosen it. Likewise, the vortex may be selected to be clockwise for a right-handed threaded fastener 12 or counter-clockwise for a left-handed threaded fastener 12 to facilitate rotating the fastener 12 when the acoustic/ultrasonic signal passes therein to tighten it.

During operation, the horn 18 and/or socket, screwdriver bit, and/or torque bit tips 20 are selected in response to the shape and size of the head and/or nut 12a of the fastener 12. The horn 18 is mounted to the armature 16a. Alternatively and for the embodiment illustrated in FIG. 9, the replaceable socket, screwdriver bit, and/or torque bit tips 20 is selected in response to the fastener head and/or nut 12a and mounted onto the horn 18 as mentioned earlier herein. To accommodate the sockets, screwdriver bits, and/or torque bit tips 20 illustrated in FIG. 9 or, similar to FIG. 8, the horns 18 or sockets, screwdriver bits, and/or torque bit tips 20 may be provided with the helical groove 70a, 70b or 70c as described earlier. Once the appropriate horn 18 and/or socket, screwdriver bit, and/or torque bit tip 20 is selected and assembled together as described herein and the horn 18 and/or socket, screwdriver bit, and/or torque bit tips 20 is mounted directly onto the head and/or nut 12a of the fastener 12. Thereafter, the acoustic/ultrasonic generator 14 is energized and causes the acoustic/ultrasonic input signal 14a to be applied to the horn 18 and/or socket, screwdriver bit, and/or torque bit tips 20 and then ultimately to create the focused energy at the predetermined focus area 25 in the fastener. In a preferred embodiment, the rotational torque applicator 40 described earlier herein is also energized or the wrench 42 is used manually to rotatably drive the fastener 12 substantially simultaneously as the acoustic/ultrasonic energy passes into the fastener 12.

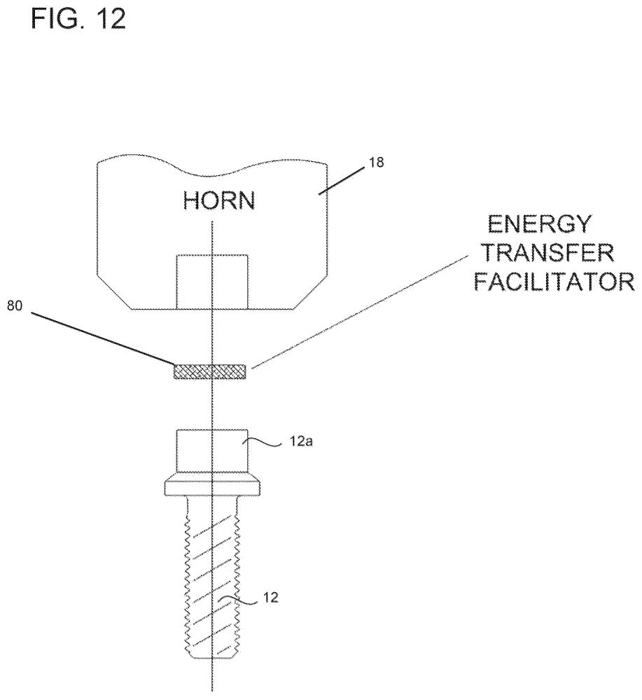

To facilitate the energy transfer, the system 10 may comprise an energy transfer facilitator 80 (FIG. 12) for facilitating transferring the ultrasonic or acoustic energy from the horn 18 and into the fastener 12. In the illustration being described, the energy transfer facilitator 80 may comprise at least one of an acoustic/ultrasonic fluid or material that is arranged between the horn 18 and the head and/or nut 12a of the fastener 12 or a socket, screwdriver bit, and/or torque bit tip that is mounted on the fastener 12. The acoustic/ultrasonic fluid may absorb minimal acoustic energy while traveling into the fastener 12, but it has been found that the use of the energy transfer facilitator 80 does facilitate transferring the acoustic or ultrasonic energy into the fastener 12. In the illustration being described, the energy transfer facilitator 80 may comprise, but not limited to, Teflon, oil, water, gel, foam, glycol, glycerin, and/or a polymer film or a minimally absorbing spacer.

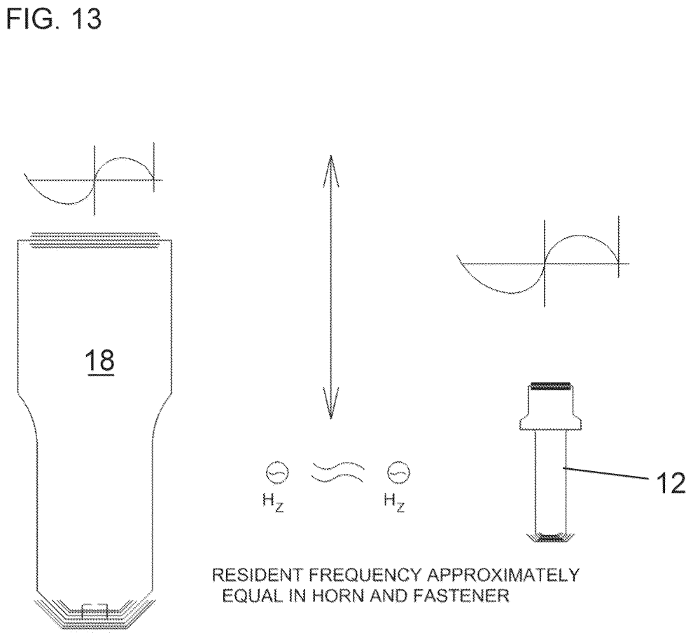

FIG. 13 illustrates still another embodiment of the horn 18 and a mating fastener 12. In this embodiment, it should be understood that the resonant or non-resident frequency of the horn 18 corresponds to the resonant or non-resident frequency of the fastener 12 which also facilitates the transfer of the ultrasonic or acoustic energy into the fastener 12. In FIG. 13 and in this illustration, the resonant or non-resident frequencies are approximately similar in both the horn 18 and the fastener 12. The inventors have found that matching the resonant or non-resident frequency of the horn 18 to the resonant or non-resident frequency of the fastener 12 further facilitates loosening or tightening the fastener 12 as desired.

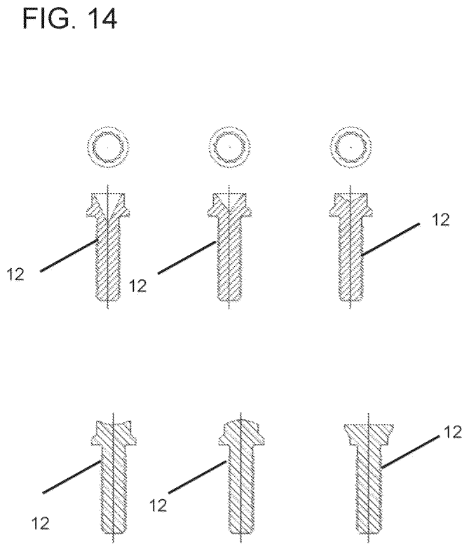

In FIG. 14 the inventor has found that the bolt head designs can be optimized to allow for transfer for acoustic energy. In this regard, the fastener heads may comprise predetermined characteristics, such as at least one of a concave end surface, a convex end surface or a flat end surface.

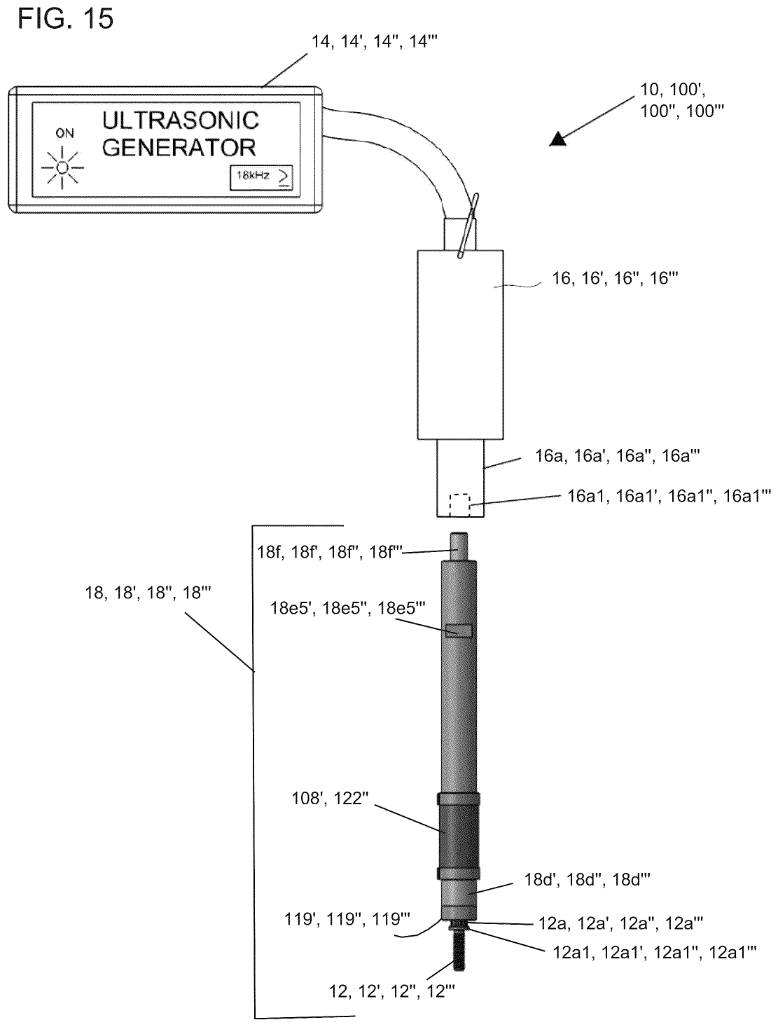

Referring now to FIGS. 15-20G, other embodiments of the ultrasonic fastener tool and system 10 are shown. For ease of illustration and description, like or similar parts in each of the embodiments are identified with the like part numbers, except a prime mark (“′”), a double prime mark (“″”) and a triple prime mark (“′″”) has been added as shown.

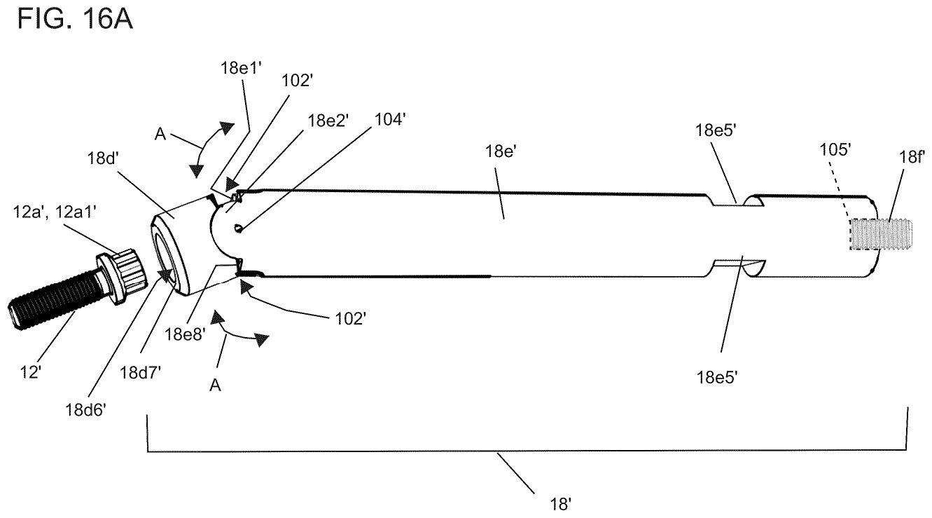

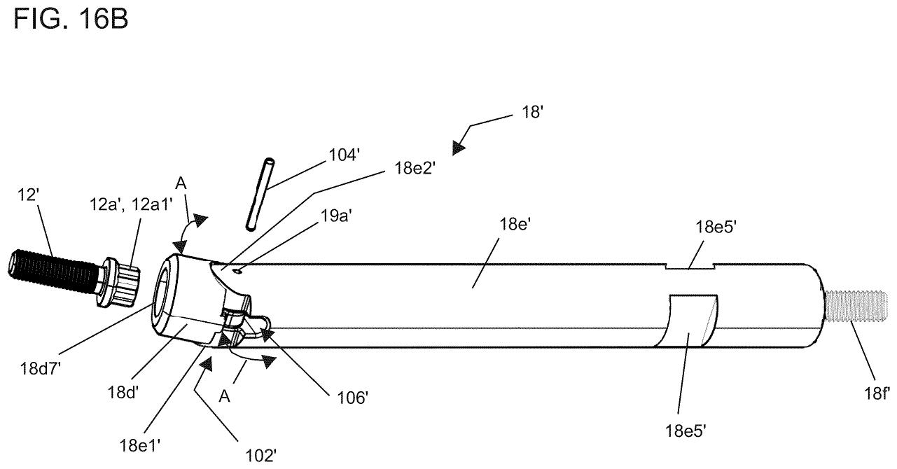

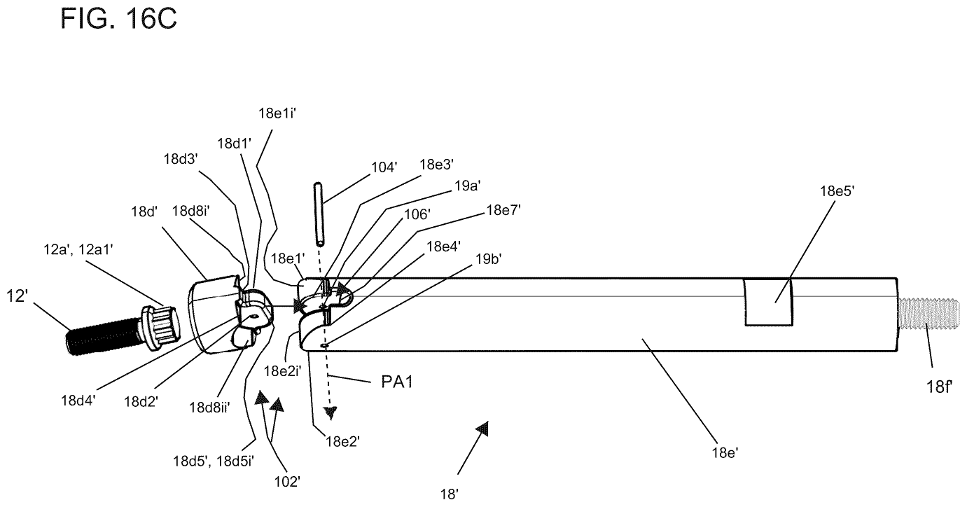

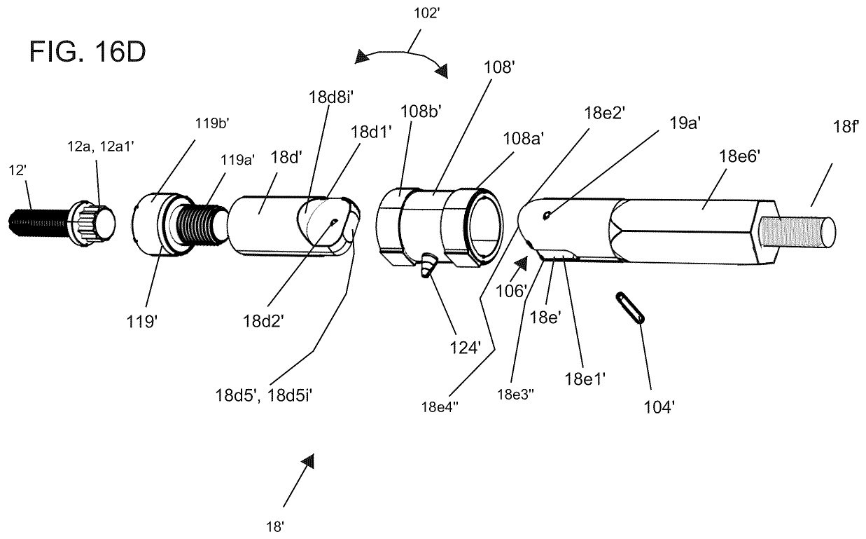

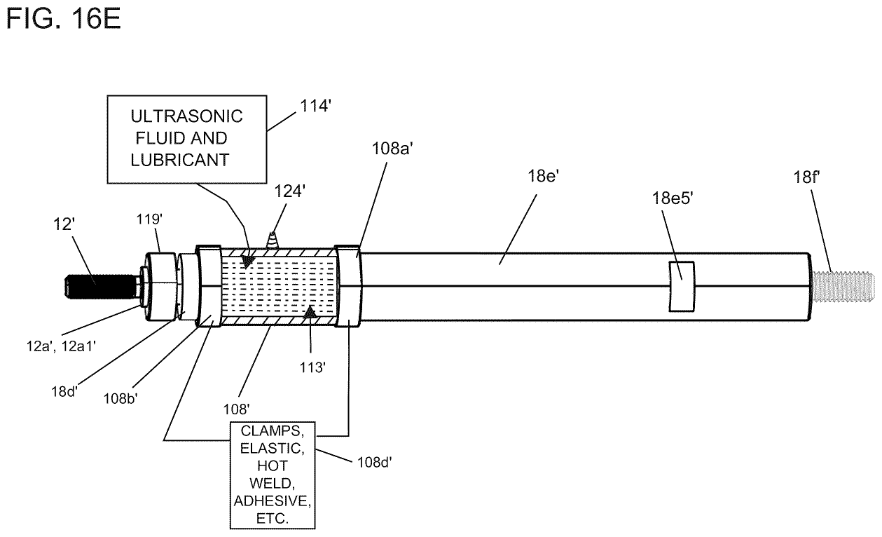

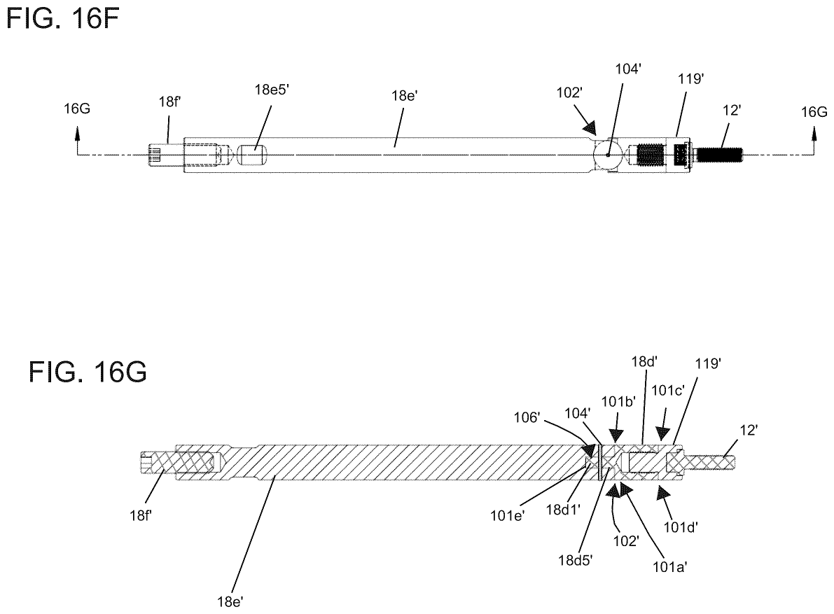

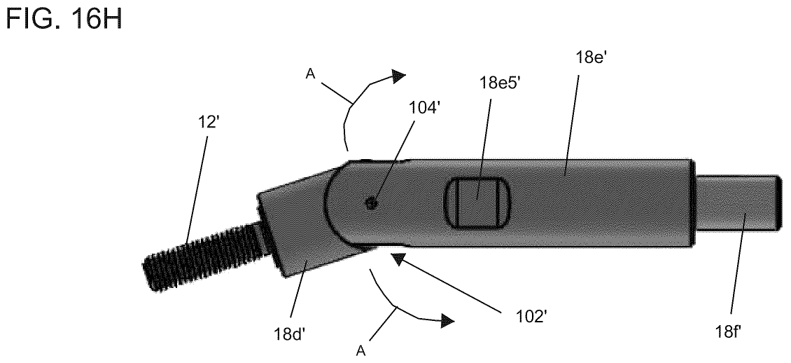

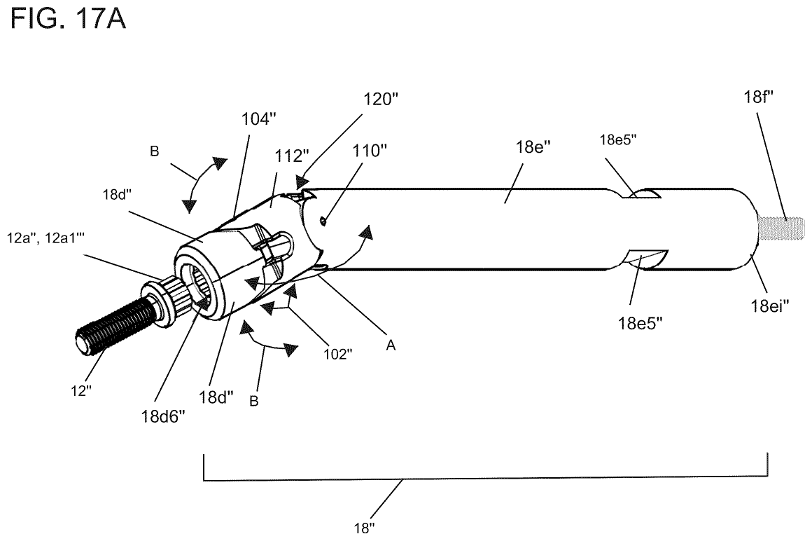

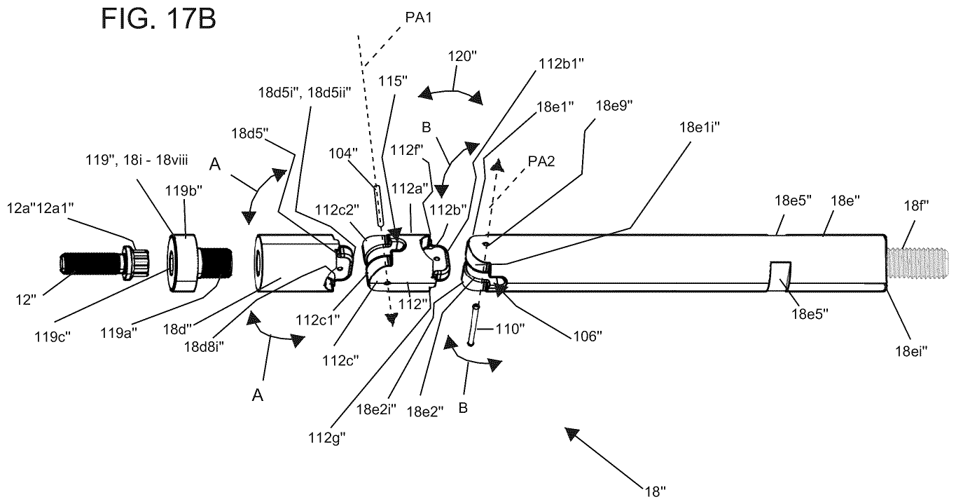

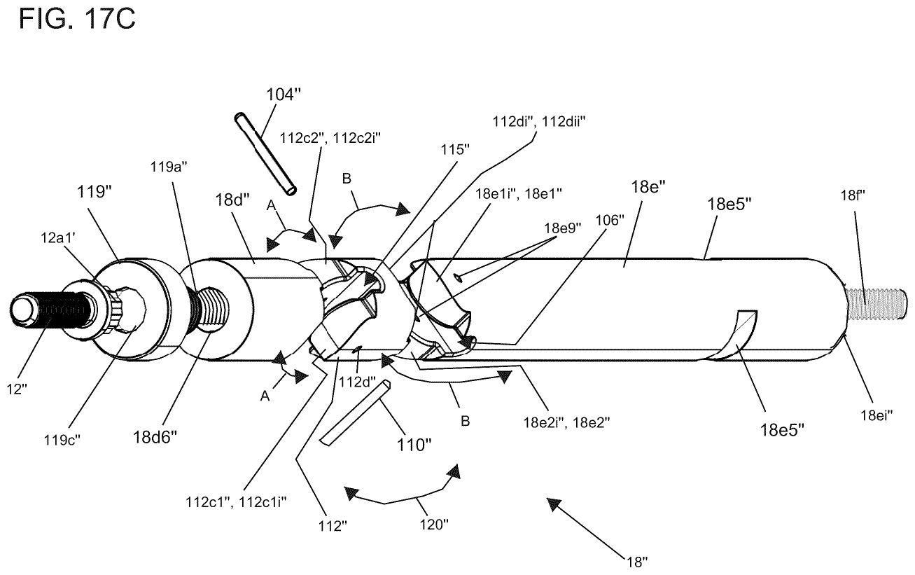

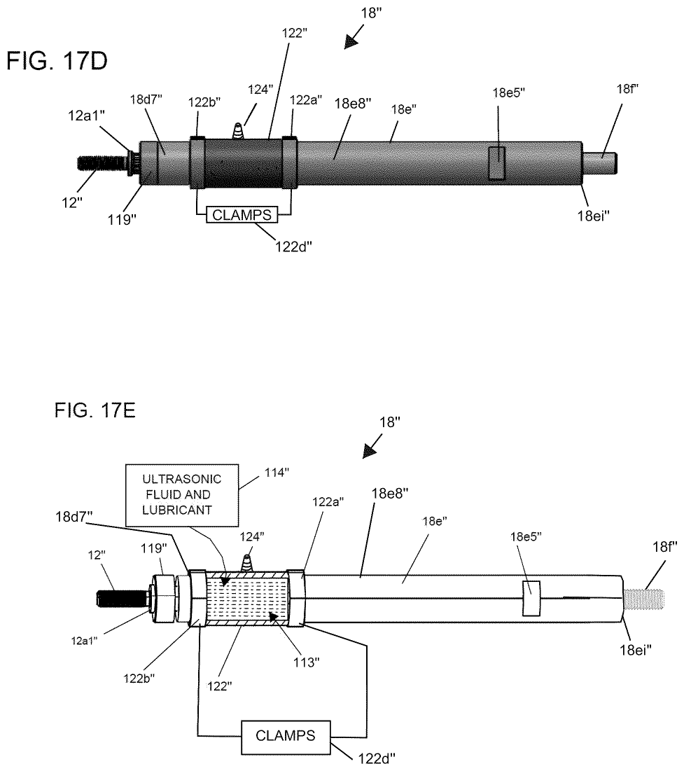

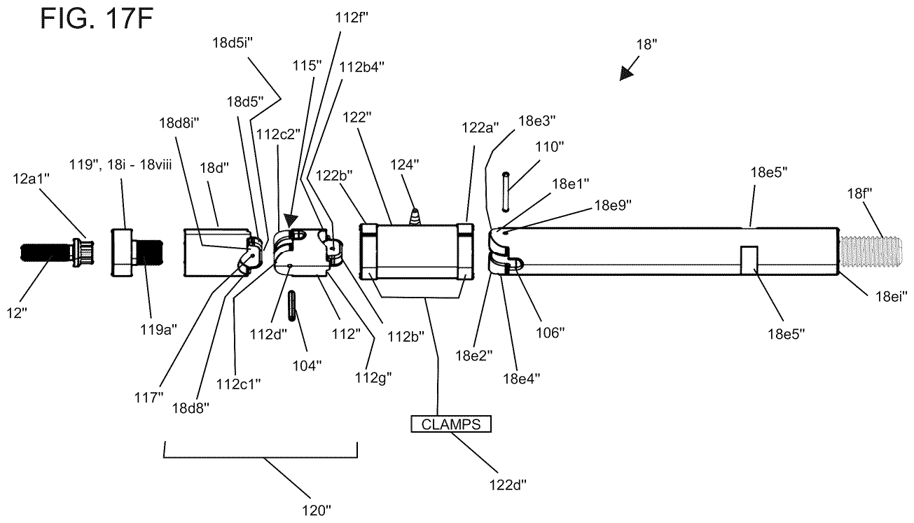

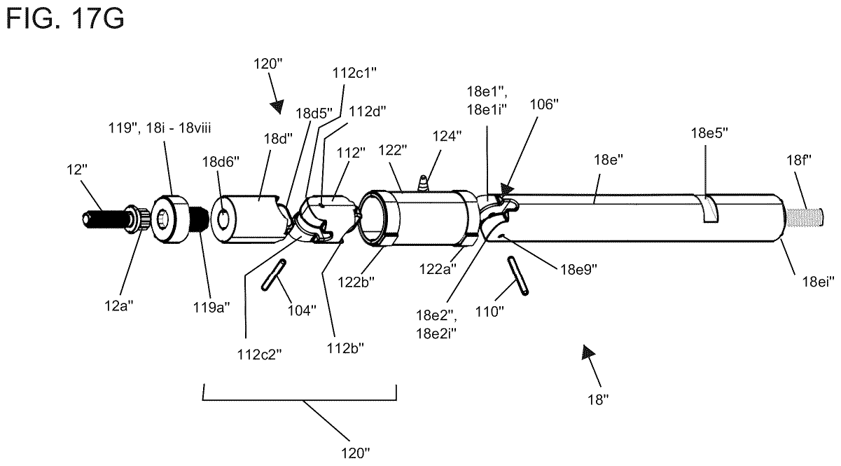

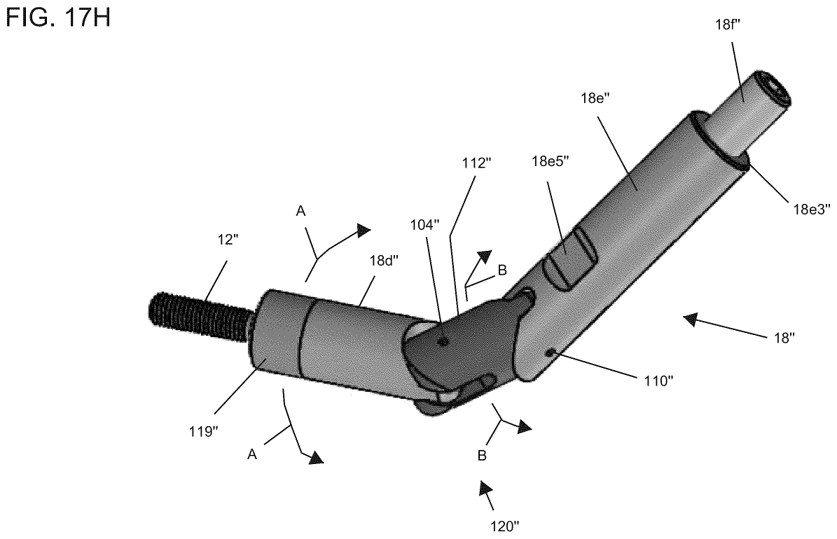

Referring now to FIGS. 15-20G, another system 100′, 100″ is shown that comprises at least one or a plurality of flexible ultrasonic joints 102′, 120″. As with the prior embodiments, the systems 100′, 100″ (FIGS. 16A-16H and 17A-17H, respectively) comprises the ultrasonic generator 14′, 14″ that operates and is adapted to function like the acoustic ultrasonic generator 14 of the prior embodiments of FIGS. 1-14. In the embodiments of FIGS. 15-16H, the system 100′, comprises the fastener tool 16′ having an armature 16a′ and an aperture 16a1′ that is threaded and that threadably receives a mating male threaded projection 18f′ so that an ultrasonic or acoustic energy may be applied through the armature 16a′, through the horn 18′ and ultimately to the fastener 12′ as shown. For ease of illustration, some figures show the male threaded projection 18f′ without threads, but it should be understood that they are also threaded. It should be understood that the embodiments of FIGS. 1-20G permit the selection of an appropriate fastener tool 16, 16′, 16″ and 16′″ (described later herein) in response to whether the application requires a pivoting horn 18′ and 18″ that comprises at least one flexible ultrasonic joint 102′, 120″.

In general, the horn 18′ in FIG. 16A is secured to the armature 16a′ as described earlier herein. In the illustration being described, the fastener tool 16′ and the components described herein relative to the embodiments of FIGS. 15-16H are adapted to provide an ultrasonic tool for loosening or tightening the fastener 12′ that is typically mounted on a structure, such as a jet engine component. As described earlier, the fastener 12′ can become extremely difficult to loosen or tighten during maintenance or repair, and the embodiments described herein facilitate providing an acoustic/ultrasonic generator 14′ for generating an acoustic or ultrasonic energy that passes through the armature 16a′ and ultimately to the fastener 12′ in order to facilitate tightening or loosening the fastener 12′ when the ultrasonic energy is applied. As mentioned herein, a rotational torque may also be applied to the armature 16a′ and horn 18′, either during or separate from the application of the acoustic or ultrasonic energy, to facilitate applying such torque to the fastener 12′.

Advantageously, in the system, method and tool of the embodiments being described, the horn 18′ comprises at least one flexible ultrasonic joint 102′. Notice that the embodiment of FIGS. 16A-16H comprises at least one flexible ultrasonic joint 102′ that permits the horn end 18d′ to pivot in a plane, such as the imaginary plane represented by double arrows A in FIGS. 16A and 16B. Thus, the horn end 18d′ can pivot in the plane and at least partially about at least one predetermined axis PA1, which is defined by the pivot axis PA1 of the pivot pin 104′ (FIG. 16C). These embodiments utilize the at least one flexible ultrasonic joint 102′ between the horn body 18e′ and the horn end 18d′. In this regard, the horn 18′ of the embodiment illustrated in FIGS. 16A-16H comprises the horn body 18e′ and the horn end 18d′ that pivots in the at least one predetermined plane and at least partially about the axis PA1 (FIG. 16C) after the components are assembled and secured together with the pivot pin 104′ as described herein. Details of the at least one flexible ultrasonic joint 102′ will be described later herein. It is important to note that the at least one flexible ultrasonic joint 102′ permits the horn end 18d′ and/or any interchangeable tip 20′ or horns 18i′-18iv′ that may be coupled thereto to pivot at least partially in the predetermined plane, such as the plane represented by the double arrow A in FIGS. 16A and 16B, and at least partially about the axis PA1.

As best illustrated in FIG. 16C, the horn body 18e′ is pivotally coupled to the pivoting horn end 18d′ with the at least one flexible ultrasonic joint 102′ with the at least one flexible ultrasonic joint 102′ and these parts are adapted and configured to mate as illustrated in FIG. 16C. The horn end 18d′ and horn body 18e′ are pivotally secured together with the at least one flexible ultrasonic joint 102′ using the pivot pin 104′ as illustrated. In this regard, note that the horn body 18e′ comprises a fork or pair of legs or projections 18e1′ and 18e2′ that cooperate to define a groove, channel or slot 106′ that is adapted to receive a male projection 18d1′ of the horn end 18d′. The male projection 18d1′ comprises an aperture 18d2′ that generally becomes co-aligned or co-axial with the apertures 19a′ and 19b′ in the projections or legs 18e1′ and 18e2′, respectively of the horn body 18e′. After the male projection 18d1′ is inserted in the slot 106′, and a pivot pin 104′ is inserted in the apertures 18d2′, 19a′ and 19b′ to pivotally fasten or couple the components 18d′ and 18e′ together to create the flexible ultrasonic joint 102′. This permits the working horn end 18d′ to pivot relative to the horn body 18e′ to facilitate accessing tough-to-access fasteners 12′ in a structure or part.

FIGS. 16B, 16C, 16F and 16G illustrate features of the horn end 18d′ and male projection 18d1′. FIG. 16A illustrates a complete assembly with the horn end 18d′ pivotally secured to the body 18e′. Notice in FIG. 16C that the legs or projections 18e1′ and 18e2′ have surfaces 18e1i′ and 18e2i′, respectively, that are radiused or have a radius of curvature to permit smooth pivoting and travel of the horn end 18d′ on the horn body 18e′. These surfaces of the projections or legs 18e1i′ and 18e2i′ mate with the surfaces 18d8i′ and 18d8ii′, respectively. As will be described later, these embodiments will be in direct engagement and contact with no fluid gap or space when used “dry” and without ultrasonic fluid and lubricant 114′ (FIG. 16E) described later. Alternatively, they can be spaced or provided with a fluid gap when a “wet” coupling is desired so that the ultrasonic fluid and lubricant 114′ may be used. The “dry” versus “wet” coupling will be describer later herein. The surfaces of part 18d5′ (FIG. 16C) and the surface of part 18e7′ directly engage in the “dry” embodiment to facilitate permitting the ultrasonic energy to pass therethrough as explained later.

Thus, the horn end 18d′ comprises the radiused surfaces 18d8i′ and 18d8ii′ which are adapted and complementarily sized to mate with and receive the curved ends or surfaces 18e1i′ and 18e2i′, respectively, so that the curved surfaces 18e1i′ and 18e2i′ of the projections 18e1′ and 18e2′ provide a travel guide for and direct contact for ultrasonic wave transmission. This also facilitates permitting the horn end 18d′ to pivot on the horn body 18e′ after the pivot pin 104′ secures the horn end 18d′ to the horn body 18e′. A pair of flat areas 18e3′ and 18e4′ cooperates with the radiused surfaces 18d3′, 18d4′ to provide a travel stop to facilitate preventing unwanted pivot travel of the horn end 18d′ relative to the horn body 18e′.

Once the horn end 18d′ is pivotally secured to the horn body 18e′ with the at least one flexible ultrasonic joint 102′ in the manner described herein, a threaded projection 18f′ is mounted in a threaded aperture 105′ (illustrated in FIG. 16A) and secured into the threaded aperture 16a1′ of the armature 16a′, thereby securing the tips 20′ or horn 18′ to the fastener tool 16′. Once the horn body 18e′ is coupled to the fastener tool 16′, the horn end 18d′ may be placed directly on the nut or fastener head 12a1′. Alternatively, the interchangeable tip 20′ may be secured to the horn end 18d′ and threadably secured in the threaded aperture 18d6′ (FIG. 16A) with the threaded projection 20a′ in a manner similar to the embodiments of FIGS. 1-14. It should be understood that as with the prior embodiments, the threaded projection 20a′ couples the interchangeable tip 20′ or preselected horn 18′ to the horn end 18d′. It should be understood that as with the prior embodiment, features of the horn 18′ shown in FIGS. 8, 9, 10A-10B, 11 and 12-13 may be utilized with the embodiment described herein relative to FIGS. 15-20G. Moreover, the fastener 12′ used with this embodiment can also comprise the predetermined shapes shown and described earlier herein relative to FIG. 14 or other shapes as well. The fasteners 12′ shown in FIGS. 15-16H may also be used.

Notice in FIG. 16A that a pair of generally opposing flat areas 18e5′ may be provided on or in the armature body 18e′ so that a wrench or the torque tool 40′ (shown in FIG. 1) may be used to tighten or loosen the horn body 18e′ to or from the armature 16a′. Alternatively, and as illustrated in FIG. 16D, the horn body 18e′ may be manufactured or machined to provide a hexagonal or polygonal shape or surface 18e6′ (FIG. 16D) to facilitate using a wrench or tool 40′ on the horn body 18e′ to apply a rotational torque.

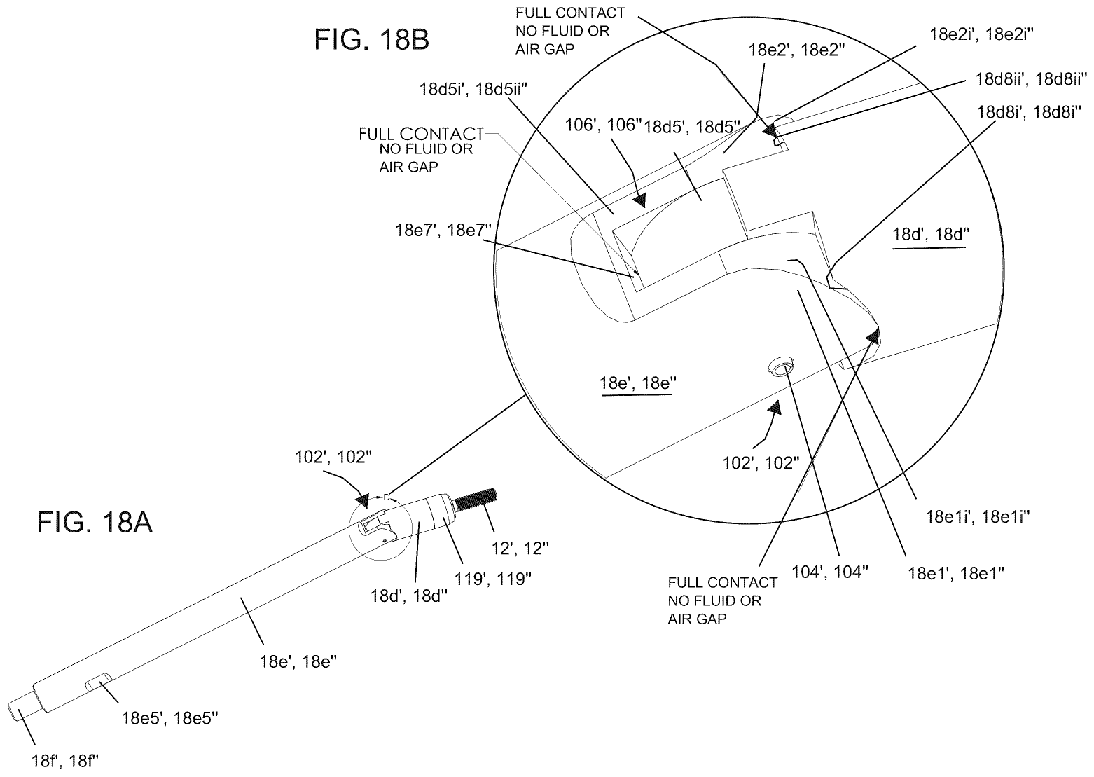

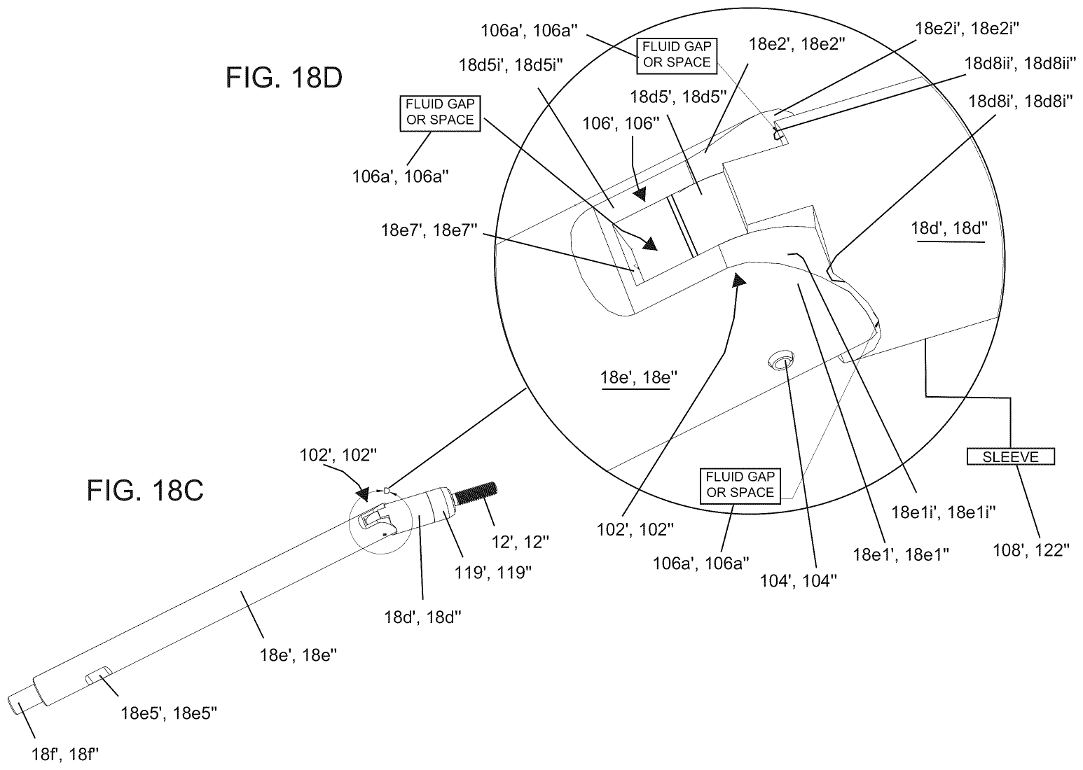

The horn end 18d′ and horn body 18e′ may be “dry” or “hard” coupled together so that the materials of the components engage directly, such as steel on steel, so that there is no fluid gap or material (such as a polymer material) between any of the contact surfaces that carry the ultrasonic or acoustic energy to the fastener 12′, including the at least one flexible ultrasonic joint 102′. The “dry” embodiment is described later herein relative to FIGS. 18A-18C. They may also be coupled using a “wet” coupling which will also be described later.

In the illustration being described, the design and shape of the components (such as the horn body 18e, 18e′, 18e″ and 18e′″, the horn end 18d, 18d′, 18d″ and 18d′″ and the flexible ultrasonic joints 102′, 120″) comprise a predetermined geometric shape that facilitates focusing the acoustic and ultrasonic energy towards the distal tip or horn end 18d′, 18d″ and the fastener 12′. In the prior art, no other tool has a need to focus acoustic or ultrasonic energy within the tool to a fastener, such as fastener 12, 12′, 12″ and 12′″. The mating component surfaces are specially designed surfaces, such as radiused or angled surfaces 18e1′-18d8i′, 18e2i′-18d8ii′ and 18d5i′-18e7′, that are in direct engagement. The direct engagement facilitates permitting the ultrasonic or acoustic energy to pass toward the tip or horn end 18d′, 18d″ and fastener 12′, 12″.

FIGS. 16F-16G are assembled and/or sectional views of the embodiments of FIGS. 16A-16D with FIG. 16G being a sectional view taken along the line 16G-16G in FIG. 16F. Notice that the horn body 18e′ is a solid one-piece construction and all of the components of the flexible ultrasonic joint 102′ are in positive and direct engagement as illustrated so that the acoustic or ultrasonic energy is efficiently passed from the tool armature 16a′ through the horn body 18e′, through the flexible ultrasonic joint 102′, through the horn end 18d′ and ultimately to the fastener 12′. Notice in FIG. 16G that the intersections 101a′, 101b′, 101c′, 101d′ and 101e′ between engaging surfaces may be metal-on-metal or fluid tight to facilitate providing a dry or hard coupling between and among the various components in order to facilitate the transfer of the acoustic or ultrasonic energy to the fastener 12′. Alternatively, they may be spaced and adapted to define a fluid gap for permitting the ultrasonic fluid and lubricant 114′ described later, to pass in and between to facilitate transmission of the ultrasonic energy through the flexible ultrasonic joint 102′.

Alternatively, it should be noted that an optional flexible ultrasonic sleeve 108′ may be provided so that the ultrasonic fluid and lubricant 114′ may be used to facilitate transfer of the ultrasonic energy. The flexible ultrasonic sleeve 108′ is adapted and sized to fit over at least a portion of the body 18e′ and at least a portion of the horn end 18d′ to encase and seal the at least one flexible ultrasonic joint 102′. While optional in the illustration being described, the flexible ultrasonic sleeve 108′ may be comprised of a flexible or elastic material, such as a polymer construction, plastic, rubber or PVC. The sleeve 108′ provides a boot or protective covering for the at least one flexible ultrasonic joint 102′. It should be appreciated and understood that after the flexible ultrasonic sleeve 108′ is mounted on the horn body 18e′ and horn end 18d′, the flexible ultrasonic sleeve 108′ provides a fluid tight seal about the flexible ultrasonic joint 102′. The ends 108a′ and 108b′ of the flexible ultrasonic sleeve 108′ may be secured via heat shrink, an adhesive or weld (not shown) or a plurality of small metallic or plastic clamps 108d′ (FIG. 16E) on both ends 108a′ and 108b′ of the flexible ultrasonic sleeve 108′. In one embodiment, the ends 108a′, 108b′ of the sleeve 108′ are elastic and are adapted to securely fit on the horn body 18e′ and the horn end 18d′. The clamps 108d′ for securing and sealing the ends 108a′, 108b′ of the sleeve 108′ on the horn end 18d′ and horn body 18e′ may be conventional. As mentioned, the ends 108a′, 108b′ of the sleeve 108′ are elastic and sized and adapted to fit on the horn body 18e′ and the horn end 18d′. The clamped or adhered ends 108a′ and 108b′ of the sleeve 108′ provide a fluid-tight seal about the flexible ultrasonic joint 102′. In one embodiment or optionally, the sleeve 108′ may be provided with a fluid nipple 124′ (FIG. 16D) for applying the ultrasonic fluid and lubricant 114′ about the at least one flexible ultrasonic joint 102′ and in an interior fluid storage area 113′ (FIG. 16E) inside the sleeve 108′ and that surrounds and envelops the at least one flexible ultrasonic joint 102′. Notice in FIG. 16E that the interior fluid storage area 113′ is sized or adapted to receive the ultrasonic fluid and lubricant 114′.

Advantageously, the ultrasonic fluid and lubricant 114′ may comprise, but is not limited to, any fluid, grease, Teflon, oil, water, gel, foam, glycol, glycerin or liquid that facilitates transmission of the acoustic and ultrasonic energy from the fastener tool 16′ through the horn body 18e′, through the at least one flexible ultrasonic joint 102′, through the horn end 18d′ and ultimately to the fastener 12′. The ultrasonic fluid and lubricant 114′ not only facilitates transferring ultrasonic and acoustic energy to the fastener 12′, but also provides means for lubricating the components of the at least one flexible ultrasonic joint 102′ during use of the fastener tool 16′. The fluid may have a viscosity similar to oil or grease in one embodiment. Features of a “dry” coupling versus a “wet” coupling, where the sleeve 108′ is most likely to be used, are described in detail later herein.

Advantageously, the flexible ultrasonic joint 102′ is assembled using the pivot pin 104′ so that the horn end 18d′ is pivotally coupled to the horn body 18e′ to provide or use the at least one flexible ultrasonic joint 102′. The fastener tool 16′ may be used in a working environment, such as during the repair of a jet engine component (not shown), other product or where at least one fastener 12′ needs to be loosened or tightened. In this regard, the end 18d′ may be pivoted in the at least one plane and at least partially about the pivot axis PA1 as illustrated in FIG. 16C and aligned with the fastener 12′ to be loosened or tightened. After the horn end 18d′ is pivoted and aligned with the head 12a1′ of the fastener 12′ and the head 12a1′ may then be received in the horn end 18d′ that is serrated or adapted to mate with and receive the head 12a1′. The fastener tool 16′ may then be energized to apply acoustic or ultrasonic energy to the fastener 12′, either during rotation of the horn end 18d′, horn body 18e and fastener 12′ or when it is not rotating, to facilitate loosening or tightening the fastener 12′. It has been found that the at least one flexible ultrasonic joint 102′ enables the fastener tool 16′ to be utilized in environments where the fasteners 12′ are not easily accessed with the tool 16′ and/or where there is a need to pivot the horn end 18d′ (FIGS. 16A-16B) in order to align its axis with an axis of the fastener 12′ to be loosened or tightened.

As mentioned earlier herein, the horn body 18e′ may comprise the generally opposing flat areas 18e5′ (FIG. 16A) for use of a torque tool 40 (FIG. 1). As shown in FIG. 16D, the body 18e′ may be machined to have a hex surface 18e6′ (FIG. 16D) so that the wrench or tool 40′ can be used to rotatably torque and drive the horn body 18e′ either clockwise or counterclockwise during use.

Advantageously, the embodiments of FIGS. 15-16H show the at least one flexible ultrasonic joint 102′ that is adapted to transmit a rotational torque to the horn end 18d′ and permit the horn end 18d′ to at least partially pivot about axis PA1 so that an axis of the horn end 18d′ is not co-axial with an axis of the horn body 18e′ and while substantially simultaneously permitting transmission of the ultrasonic or acoustic energy from the ultrasonic generator 14′ to the fastener 12′. It should be understood that a significant feature of the embodiments is that they permit application of ultrasonic energy when the horn end 18d′ is pivoted. This is significant in that normally ultrasonic waves travel linearly and do not bend or curve easily.

As mentioned earlier, one significant feature of the illustration being described is that the flexible ultrasonic joints 102′, 120″ (described later herein) may be operated in a “dry” environment where no ultrasonic fluid and lubricant 114′, sleeve 108′ or the like is used. In other words, in the illustrations being described, they can be operated with a “wet” flexible ultrasonic joint 102′, 120″ or they can be operated without the optional sleeve 108′, 122″ and operated in a “dry” environment without any ultrasonic fluid and lubricant 114″. Features of the “wet” versus “dry” will be described later herein.

Because surfaces of the parts are in direct contact in a “dry” environment as explained and are made of metal, the horn end 18d″ can be stiff or difficult to move initially until some wear has occurred. In some respects, the stiffness of the flexible ultrasonic joint 102′ is advantageous because the parts remain relatively fixed after the horn end 18d′ has been actuated or articulated to a desired position. This is important because oftentimes the tool 16′ is used in tight quarters when repairing or working on parts, such as a jet engine component.

Advantageously, the “dry” connection of the single flexible ultrasonic joint 102′ enables the acoustic or ultrasonic energy to transfer directly from the armature 16a′ of the tool 16′ through the flexible ultrasonic joint 102′, through the horn end 18d′ and ultimately to the fastener 12′. Again, the direct surface contact between the surfaces of the flexible ultrasonic joint 102′ enable the efficient transmission of the ultrasonic energy to the fastener 12′ even when the flexible ultrasonic joint 102′ is pivoted and the horn end 18d′ is not co-axial with the horn body 18e′. This is explained in more detail later herein in the section of the disclosure entitled “MAINTAINING AND FOCUSING ULTRASONIC ENERGY.”

It should be understood that the ultrasonic energy transfer facilitator 80′ (FIG. 12) may also be utilized in this embodiment in order to facilitate the transmission of the acoustic or ultrasonic waveforms through the fastener tool 16′, the armature 16a′ and into the fastener 12′. Again, the pivotal coupling between the components 18d′ and 18e′ permit the loosening or tightening of the fastener 12′ whose axis is not co-axial with the axis of the horn body 18e′ and after the horn end 18d′ is pivoted. During use, the fastener tool 16′ may apply the ultrasonic and acoustic energy to the fastener 12′ either with or without a rotational torque being applied to the horn body 18e′ and is transmitted directly to the horn end 18d′ while the ultrasonic and acoustic energy is applied to the fastener 12′.

Referring now to 17A-17H, another embodiment(s) of the fastener tool 16″ is/are shown with like parts in each of the embodiments being identified with the like part numbers, except a double prime mark (“″”) has been added thereto.

In these embodiments, it should be apparent that the horn 18″ (FIG. 17A) has the at least one flexible ultrasonic joint 120″ adapted to permit the horn end 18d″ to pivot at least partially about a plurality of predetermined pivot axes that can be moved so that they are neither coaxial with each other nor coaxial with a tool axis of the fastener tool 16″. In this embodiment, similar design features of the embodiment shown in FIGS. 15-16H apply. The horn end 18d″ pivots in the plane represented by the double arrows A (FIGS. 16A and 17A) in a manner described earlier herein. In the embodiment of FIGS. 17A-17H, the at least one universal flexible ultrasonic joint 120″ comprises a second pivot axis PA2 (FIG. 17B) that permits the horn end 18d″ to pivot in a second imaginary plane represented by double arrows B-B (FIG. 17A). Thus, the horn end 18d′ in this embodiment can pivot at least partially in multiple axes and in multiple planes.

In the embodiment of FIGS. 17A-17H, the horn 18″ comprises multiple sections or components that will now be described. In this embodiment, the horn 18″ comprises the at least one flexible ultrasonic joint 120″ that permits the horn end 18d″ to pivot in a plurality of planes and at least partially about a plurality of axes PA1 and PA2. The at least one flexible ultrasonic joint 120″ comprises the horn end 18d″, the horn body 18e″ and an intermediate pivoting coupler 112″ that pivotally couples the horn end 18d″ to the horn body 18e″ as shown. In short, the parts 18d″, 18e″, 120″ and 112″ provide or define the at least one flexible ultrasonic joint 120″ that permits the horn end 18d″ to pivot in a plurality of planes, such as the imaginary planes represented by the double arrows A-A and B-B in FIGS. 17B and 17C. Similar to the embodiment illustrated and described relative to FIG. 16C, the horn body 18e″ of the embodiments of FIG. 17A-17H comprises a pair of opposed and spaced legs 18e1″ and 18e2″ (FIGS. 17B-17C) that define a channel, gap or slot 106″ (FIGS. 17B, 17C) therebetween that is adapted to receive a tongue or male projection 112b″ that projects from a first end 112a″ of the intermediate pivoting coupler 112″. Once the male projection 112b″ is received in the gap or slot 106″, a second pivot pin 110″ is inserted and press fit into the apertures 18e9″ (FIG. 17C) on ends 18e1″ and 18e2″ and in aperture 112b1″ (FIG. 17B) to pivotally secure the two parts together and to provide a pin joint connection that permits the intermediate pivoting coupler 112″ and the horn end 18d″ to pivot at least partially in the direction of double arrow A-A in FIGS. 17B and 17C.

A second end 112c″ (FIG. 17B) of the intermediate pivoting coupler 112″ also comprises a pair of spaced male projections or legs 112c1″ and 112c2″ that cooperate to define a channel, groove or slot 115″ (FIG. 17C) sized and adapted to receive a male projection 18d5″ of the horn end 18d″ and be pivotally secured thereto with the pivot pin 104″ that is inserted into aperture 112d″ (FIG. 17C). The pivot pin 104″ pivotally couples the intermediate pivoting coupler 112″ to the horn end 18d″ to enable it to pivot in a plurality of planes, such as the plane represented by the double arrows A-A and B-B in FIG. 17B. It should be understood that the axes of the pivot pins 104″ and 110″ are not coaxial and therefore permit the horn end 18d″ to at least partially pivot about the axes PA1 and PA2 and in the imaginary planes represented by the double arrows A-A and B-B, respectively. In one embodiment, these axes are offset by approximately 90 degrees.

It should be understood that the legs 18e1″-18e2″ and 112c1″-112c2″ are spaced and define the channels, grooves, gaps or slots 106″ and 115″, respectively, that are sized, spaced and adapted to receive the tongues or male projections 112b″ and 18d5″, respectively, which are pivotally secured therein with the pivot pins 110″, 104″.

As with the embodiment of FIGS. 16A-16H, note that the end surfaces 18e1i″ and 18e2i″ (FIGS. 17B-17C) are curved or have a common radius of curvature that complements a curve and radius of curvature of the walls 112f″ and 112g″ (FIGS. 17B-17C) when the intermediate flexible ultrasonic coupler 112″ is pivoted in the direction of double arrows B-B. Likewise, the horn end 18d″ comprises the male projection 18d5″ received in the channel, groove, gap or slot 115″ and secured therein with the pivot pin 104″ in the manner described herein.

It should be understood that the intermediate flexible ultrasonic joint 120″ enables both the horn end 18d″ and the intermediate flexible ultrasonic coupler 112″ to pivot together or in different planes if desired when the intermediate flexible ultrasonic coupler 112″ is pivoted. In contrast, as illustrated in FIGS. 17A-17D, it should be appreciated that the horn end 18d″ of the embodiments of FIGS. 17A-17D may also at least partially pivot in the direction of double arrow A-A in FIG. 17B without the intermediate flexible ultrasonic coupler 112″ pivoting. Thus, the embodiment of FIGS. 17A-17H permit the horn end 18d″ to pivot at least partially about multiple axes.

As with the prior embodiment, a threaded projection 18f″ is provided on the end 18di″ (FIG. 17A) of the horn body 18e″ and threadably mounted to the threaded aperture 16a1″ of the fastener tool 16″ as with prior embodiments. The assembly may then be used to loosen or tighten the fastener 12″ as shown and described herein.

In the embodiments of FIGS. 15-17H, it should be understood that the horn end 18d″ may define the torque bit tip 20″ that is adapted, sized and dimensioned to receive a fastener head 12a1′, 12a1″ so that the acoustic or ultrasonic energy may be transferred from the tool 16′, 16″ through the horn body 18e′, 18e″, through the intermediate ultrasonic coupler 112″, through the flexible ultrasonic joint 102′, 120″ and into the horn end 18d″ so that the acoustic or ultrasonic energy may be imparted directly to the fastener 12′, 12″. A rotational torque may also be applied by the rotational torque generator to the flexible ultrasonic coupler 112″ or the horn body 18e′, 18e″ either separately or while the acoustic or ultrasonic energy is applied to either loosen or tighten as desired. Thus, as with prior embodiments, it should be appreciated that the acoustic or ultrasonic energy may be applied at the same time that a rotational torque is applied to the horn body 18e′, 18e″ or it may be applied when a rotational torque is not applied during the rotation of the horn body 18e′, 18e″.

Alternatively, and as illustrated in FIGS. 16C-16F and 17B-17H, at least one or a plurality of tips, such as the horns 18i″-18viii″ and/or tips 20ai″-20aiv″, may be mounted on the horn end 18d″ as described earlier herein. In such an event, the tips or a horn, such as horn 119′, 119″ (FIGS. 16E-16F and 17B-17F) may be mounted onto the horn end 18d″. In such embodiment, a threaded aperture 18d6″ (FIG. 17C) provides a threaded female opening for receiving a male threaded projection 119a″ (FIG. 17B) that is integral with the tip or horn 119″. An interior wall 119c″ (FIG. 17C) of the tip or horn 119″ is adapted, sized and shaped to receive the head 12a1″ of the fastener 12″ and to apply acoustic or ultrasonic energy to the fastener nut 12a″. With the embodiments of FIGS. 16A-16H and 17A-17H, either the horn 18d″, another horn 119″ or one of the tips 20″ and its aperture 18d6″ receive the head 12a1″ of the fastener 12″ directly. Alternatively, the horn end 18d″ may have the threaded female aperture 18d6″ (FIG. 17C) that is adapted and sized to receive the threaded projections 119a″ of the tip or horn 119″. Thus, it should be appreciated that the tips 20ai″-20aiv″ of the type shown in the embodiment relative to FIGS. 1-14 may be used with the embodiments of FIGS. 15-17H.

During use of the embodiments of FIGS. 16A-16H and 17A-17H, the user selects the desired horn end 18d″ or he selects the desired tip 20″, horn 18″ or horn 119″ to be mounted by the horn end 18d″ for the fastener 12″ to be loosened or tightened. The horn 18″, tip 20″ or horn 119″ is threadably fastened to the horn end 18d″ and then is guided onto the head 12a1″ of the fastener 12″ to be loosened or tightened. The acoustic or ultrasonic energy is applied thereto by actuating a power switch (not shown) coupled to the ultrasonic generator 14, 14′ and 14″. Optionally, this could occur while a rotational torque is applied to the fastener 12″.

As mentioned earlier, the flexible ultrasonic joints 102′, 120″ can be “dry” or “wet”. In one embodiment, the flexible ultrasonic joints 102′, 120″ and the sleeves 108′ and 122″, mentioned earlier relative to FIGS. 16E and 17E, may retain the ultrasonic fluid and lubricant 114′, 114″ described earlier that conducts the acoustic and ultrasonic energy from the tool fastener 16′, 16″ through the horn end 18d′, 18d″, through the flexible ultrasonic joint 102′, 120″ so that the ultrasonic energy is focused and transmitted through the parts and ultimately to the fastener 12′, 12″. In contrast, in the “dry” embodiment, the various engaging surfaces of the various components, especially the flexible ultrasonic joints 102′, 120″, cause the acoustic or ultrasonic energy to be focused and transmitted without a fluid and through the various components of the system 100′, 100″. The “dry” connection and engagement of the engaging surfaces of the components are selected to comprise a contact surface shape that is conducive to conducting and transmitting the acoustic or ultrasonic energy. In contrast, conventional wrenches do not send or conduct ultrasonic or acoustic energy. This is explained in detail later herein in the section “MAINTAINING AND FOCUSING ULTRASONIC ENERGY.” In this regard, it should be appreciated that the geometry of the components as you move proximal from the fastener tool 16′ to the horn end 18d′, 18d″ is always radiused or angled so that when acoustic or ultrasonic energy is applied, the energy travels and is transmitted from the proximal to the distal horn end 18d′, 18d″ and ultimately to the fastener 12′, 12″. As mentioned earlier, the “dry” connection feature can be used with the embodiments of FIGS. 16A-16H.

Advantageously, the embodiments of FIGS. 16A-17H provide geometrically shaped components and surfaces that cooperate to focus the energy towards the distal tip or horn end 18d′, 18d″ and ultimately to the fastener 12′, 12″.

Alternatively, and as with the sleeve 108′ illustrated and described earlier relative to the embodiment of FIGS. 16A-16F, this embodiment may also comprise a sleeve 122″ that is adapted and sized to fit over the entire flexible ultrasonic joint 120″ as illustrated in FIGS. 17D-17G. Note in FIG. 17D, the sleeve 122″ encases the flexible ultrasonic joint 120″ as shown and the fluid storage area 113″ surrounding it. As with the prior embodiments, a fluid nipple 124″ provides fluid communication with the fluid storage area 113″ (FIG. 17E) inside the sleeve 122″ so that the ultrasonic fluid and lubricant 114″ can be inserted therein. The sleeve 122″ provides a boot or protective covering for the flexible ultrasonic joints 102″ and 120″. The sleeve 122″ is elastic and made of a polymer construction and the ends 122a″ and 122b″ of the sleeve 122″ are elastic and provide a fluid tight seal against the outer surface 18e8″ (FIG. 16A) of the horn body 18e″ and the outer surface 18d7″ of the horn end 18d″, respectively. Alternatively, a pair of conventional clamps 122d″ (FIGS. 17D-17F) may be mounted on the ends 122a″ and 122b″ to secured the sleeve 122″ thereon. Alternatively, elastic ends 112a″ and 122b″, a hot weld, adhesive or other means may be used to secure the sleeve 122″ on the horn body 18e″ and horn end 18d″. Once the sleeve 122″ is mounted thereon, the fluid nipple 124″ may be used to inject or insert the ultrasonic fluid and lubricant 114″ into the fluid storage area 113″ (FIG. 17E) similar to the embodiment shown in FIG. 16F. As with the prior embodiment, the ultrasonic fluid and lubricant 114″ may be a lubricating fluid or a fluid adapted and selected to facilitate transmitting the acoustic and ultrasonic energy from the fastener tool 16″ to the fastener 12″. Thus, it should be understood that the sleeve 122″ not only permits the retention of the ultrasonic fluid and lubricant 114″ in the storage area 113″ but also protects and lubricates the flexible ultrasonic joints 102′ and 120″. As with the prior embodiment, the sleeve 122″ and ultrasonic fluid and lubricant 114″ are optional and are not used in the “dry” embodiment, but they could be.

Thus, the fluid storage area 113″ in FIG. 16E and area 113″ in FIG. 17E both define storage areas for storing the ultrasonic fluid and lubricant 114′, 114″ about the flexible ultrasonic joints 102′ and 120″, respectively, which facilitates the transfer of acoustic or ultrasonic energy through the horn body 18e″ and into the fastener 12″ to facilitate fastening or loosening the fastener 12″. As mentioned earlier herein, the acoustic or ultrasonic energy may be applied separate from a rotational torque on the armature or on the horn body 18e″ or it may be applied substantially simultaneously to the application of the rotational torque on the horn body 18e″.

As with the prior embodiments, the horn body 18e″ comprises a pair of opposing flat areas 18e5″ (FIG. 17C) that are adapted and sized to receive the wrench or tool, such as the torque tool 40″ shown in FIG. 1. Alternatively, and similar to the embodiment shown in FIG. 16D, the exterior horn body 18e″ may be machined or provided to comprise a polygonal working surface, such as a hexagonal shape, for permitting a plurality of different tools to be used to apply a rotational torque, either counterclockwise or clockwise to the horn body 18e″.

Advantageously, the embodiments of FIGS. 17A-17H enable the end 18d″ or any tip 20″ fastened thereto to pivot in both planes and at least partially about multiple axes PA1 and PA2 that are not co-axial. This feature and the pivoting embodiments of FIGS. 15-17H are particularly useful when the embodiments of FIGS. 1-14 cannot easily be used to access a fastener 12. During use, the horn end 18d″, horn 18″ or the tip 20″ are caused to be at least partially pivoted about at least one axis and in at least one plane until it can be maneuvered and aligned to receive the fastener nut 12a″ of the fastener 12″. The acoustic or ultrasonic energy and rotational torque may then be applied to the fastener 12″ either simultaneously or separately thereto. Of course, it should be understood that the devices and embodiments of FIGS. 15-17H can also be used without any or with minimal pivoting at all.

In one embodiment, note that the pivot axes PA1 and PA2 of the embodiment of FIGS. 17A-17H are offset. In a preferred embodiment, they are offset approximately 90 degrees.

### Maintaining and Focusing Ultrasonic Energy

As alluded to earlier, a significant feature of the embodiments shown and described in FIGS. 15-17H Is that the tool and system 100′, 100″ comprises means, apparatus and is adapted and configured to facilitate transferring and focusing the ultrasonic energy as it passes through the fastener tool 16′, 16″ and the horn 18′, 18″. This feature is applicable to both the single flexible ultrasonic joint 102′ as well as the dual flexible ultrasonic joint 120″ embodiments. The inventor has found several approaches to be useful to transfer the ultrasonic energy through the horn 18′, 18″. In general, one approach is to provide a “dry” engagement or coupling between the various components of the flexible ultrasonic joints 102′, 120″ so that when an ultrasonic energy is passed through the horn 18′, it passes and is focused through the horn body 18e′, 18e″, through the flexible ultrasonic joint 102′, 120″, through the horn end 18d′, 18d″ and ultimately to the fastener 12′, 12″.

FIGS. 18A-18B illustrate single flexible ultrasonic joint 102′ that utilizes a “dry” connection, and this same feature and description applies to the flexible ultrasonic joint 120″. In this regard, notice in the enlarged view of FIG. 18B, the components of the flexible ultrasonic joint 102′, the horn body 18e′ and horn end 18d′, are machined and adapted such that engaging surfaces of the components directly engage each other, and this direct engagement facilitates transfer of the ultrasonic energy to the fastener 12′, 12″. Notice in FIG. 18B that the arcuate or curved surfaces 18d8i′ and 18d8ii′ directly engage the end surfaces 18e1i′ and 18e2i′, respectively. Notice that the end 18d5i′ of the male projection 18d5′ directly engages a bottom surface 18e7′ of the channel or slot 106′. It should be appreciated that these components are adapted, designed and manufactured to have zero or close-to-zero tolerances.

Because of this direct engagement and mating of engaging surfaces of the flexible ultrasonic joint 102′, there is full contact engagement at each of the areas labeled “FULL CONTACT” in FIG. 18B. The inventor has found that through this direct engagement of the surfaces of the various components, the ultrasonic waveform transfers through the fastener tool 16′ without interruption and with the waveform and energy being substantially intact and focused toward the horn end 18d′, tip or horn 18′ and the fastener 12′. The inventor has found that the direct engagement of the parts of the flexible ultrasonic joints 102′, 120″, allows the ultrasonic energy pass through the parts and ultimately to the fastener 12′ even when the horn end 18d′, 18d″, the intermediate coupler 112′, 112″ or the like have been pivoted. Notice that there is no fluid or air gap between the engaging surfaces. The inventor has also found that by providing the component parts with arcuate, angled or curved surfaces, as opposed to flat or interrupted surfaces that may reflect the ultrasonic energy, the ultrasonic energy and waves pass through the flexible ultrasonic joint 102′ and pass through the parts and ultimately to the fastener 12″ without interruption, reflection or the like. It should be understood, that the sonics will generally follow a straight path, but can be reflected. The design has minimized any surfaces that can reflect the sonics. The design shows most surfaces angled or radiused pushing or directing the sonics distal, towards the fastener 12′, 12″. The curved surface allows for maximum surface area contact at every angle. If the surface was flat than the surface area would get reduced as you were angled.

In contrast, another embodiment illustrated in FIGS. 18C and 18D illustrates the “wet” environment. As explained earlier herein relative to the embodiments of FIGS. 16E and 17E, the fastener tool 16′, 16″ may use the “wet” environment wherein the ultrasonic fluid and lubricant 114′, 114″ encases and surrounds the flexible ultrasonic joint 102′, 120″. The inventor has found that utilizing an ultrasonic medium, such as the ultrasonic fluid and lubricant 114′, 114″, facilitates transferring the ultrasonic energy toward the horn end 18d′, 18d″ and fastener 12′, 12″. The embodiment may be utilized with the components described in the “dry” environment illustrated in FIGS. 18A-18B and as described herein. In the “wet” environment the sleeves 108′ and 122″ are used. Notice that an intentional spacing between engaging part surfaces is provided or machined between several adjacent working surfaces. In FIG. 18C, notice a spacing or gap between the surfaces of the parts 18d8i′, 18e1i′; 18d8ii′, 18e2i′, 18d5′ and 18e7′ to enable the ultrasonic fluid and lubricant 114′ to pass therebetween so that when ultrasonic energy is passed through the fastener tool 16′, the ultrasonic fluid and lubricant 114′ facilitates transferring the ultrasonic energy to the horn end 18d′ and ultimately to the fastener 12′.

Again, the inventor has found that utilizing the ultrasonic fluid and lubricant 114′, 114″ not only lubricates the flexible ultrasonic joints 102′, 120″, but also facilitates transferring the ultrasonic energy through the fastener tool 16′, 16″. Accordingly, notice in FIG. 16C that the end 18d5i′ of the male projection 18d5′ is truncated and not rounded and is generally flat and cooperates with surface 18e7′ (FIG. 18D) to define a fluid gap or space 106a′ (FIG. 18D). The end 18d5i′ (FIG. 16D) and end 18d5ii′ (FIGS. 17B and 18D) are truncated or not rounded in the “wet” application. For ease of illustration and understanding, the fluid gap or space 106a′ facilitates allowing the ultrasonic fluid and lubricant 114′ to pass between the surfaces of the flexible ultrasonic joint 102′. Likewise, in each area of FIGS. 18C-18D labeled “FLUID GAP OR SPACE”, define a fluid gap between adjacent surfaces as shown. Again, the ultrasonic fluid and lubricant 114′ is received in each fluid gap or space and facilitates transferring and focusing the ultrasonic energy to and through these parts, the flexible ultrasonic joint 102′, the horn end 18d′ and ultimately to the fastener 12′.

Thus, it should be appreciated that flexible ultrasonic joint 102′ may be operated in either a “dry” or “wet” environment. It should also be appreciated that in the “dry” environment, the sleeve 108′ is optional. For ease of illustration, the sleeves 108′ and 122″ are shown schematically in FIG. 18B. Of course, if the “wet” approach is desired, then the sleeve 108′ should be used with the ultrasonic fluid and lubricant 114′ as described earlier herein.

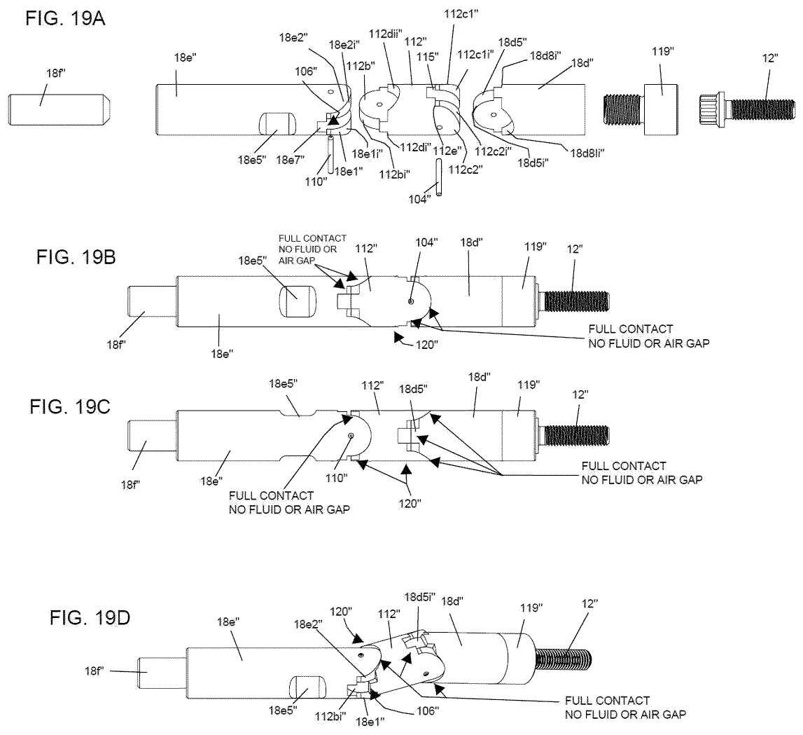

Referring now to FIGS. 19A-19D, the “dry” and “wet” embodiments for the flexible ultrasonic joint 120″ will now be described. In this embodiment of FIGS. 19A-19D, the various surfaces of engaging parts are in direct engagement and contact and facilitate transferring the ultrasonic energy through the flexible ultrasonic joint 120″ in a manner similar to the embodiment shown and described relative to FIGS. 18A-18D.

Notice that the various surfaces of the components directly engage each other with zero or close-to-zero tolerance. In this regard, the end 112bi″ (FIG. 19A) engages the surface 18e7″ of the horn body 18e″. Likewise, the curved surfaces 18e1i″ and 18e2i″ mate with and directly engage the arcuate or curved surfaces 112di″ and 112dii″, respectively. As mentioned, the end 112bi″ of the male projection 112b″ is received in the channel or slot 106″. The end 112bi″ engages directly with the surface 18e7″. Similarly, the end surface 18d5i″ of the male projection 18d5″ directly engages a bottom 112e″ of the channel or slot 115″.

Surfaces 112c1i″ and 112c2i″ directly engage the opposing arcuate or curved surfaces 18d8i″ and 18d8ii″, respectively, as best shown in FIG. 19A. Thus, it should be apparent that the intermediate coupler 112″ and its surfaces directly engage the surfaces of the horn body 18e″ and horn end 18d″ to provide the advantages of the “dry” connection mentioned earlier herein. Again, the inventor has found that through this direct engagement and by providing arcuate or curved surfaces in the various components of the fastener tool 16″ and of the flexible ultrasonic joint 120″, there is an improved transfer of the ultrasonic energy through the fastener tool 16″, the horn body 18e″, flexible ultrasonic joint 120″, horn end 18d″ and ultimately the fastener 12″. It should be understood that the surfaces are curved or angled with respect to the direction of travel of the ultrasonic wave so that minimal or no reflection of the ultrasonic wave occurs before it hits the fastener 12″. This is especially advantageous when the horn end 18d″ has been pivoted.

FIG. 19B is an assembled view of the embodiment shown in FIG. 19A and FIG. 19C is a view showing the horn 18″ rotated (compared to FIG. 19B) approximately 90 degrees so that the pivot pins 104″ and 110″ and the flexible pivot joint 120″ may be viewed. Notice in FIG. 19D, a view of the intermediate coupler 112″ in an exemplary pivoted arrangement is shown. As mentioned earlier, because the horn end 18d″ can be difficult to move or pivot by hand, the direct surface connection between adjacent parts and the flexible ultrasonic joint 120″ can be “stiff”. However, the inventor has found that this stiffness actually facilitates pre-setting the tool 16″ when it is used in difficult-to-access areas, such as when servicing a jet engine component or another device where a straight-line access to the fastener 12″ is not available.

In FIGS. 17D-17G, the embodiment of the dual flexible ultrasonic joint 120″ shows the configuration of the various components of the flexible ultrasonic joint 120″ for use with the ultrasonic fluid and lubricant 114″ and with the sleeve 122″. For ease of illustration and understanding, the sleeve 122″ and its associated clamps or elastic ends 122a″ and 122b″ are shown schematically. Notice in FIG. 17F, the ends 18d5i″ and 112b″ are not curved. As with the embodiment described earlier in FIGS. 18A-18D, fluid gaps are provided or defined between the various component surfaces, including surfaces 18e1i″-112f″ and 18e2i″-112g″, surface 112bi″ of the male projection 112b″ and the surface 18e7″, 112c1i″ and 112c2i″ and surfaces 18d8i″ and 18d8ii″, respectively; and surface 18d5i″ and surface 112e″. As with the prior embodiments, the gap or spacing between these engaging surfaces permit the ultrasonic fluid and lubricant 114″ to surround and transfer the ultrasonic energy, especially when at least one or both of the horn end 18d″ and the intermediate coupler 112″ has been pivoted.

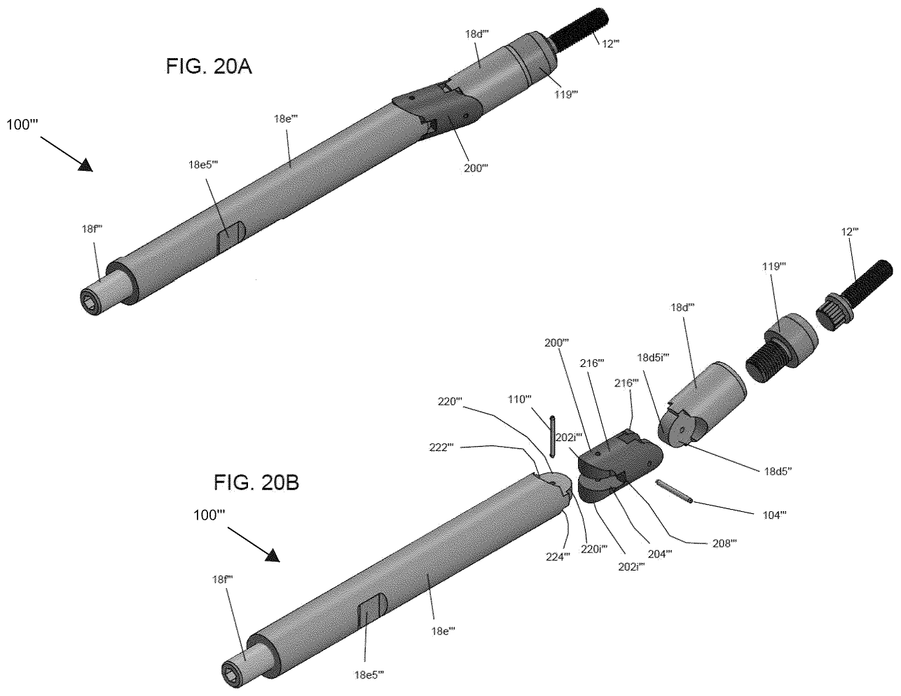

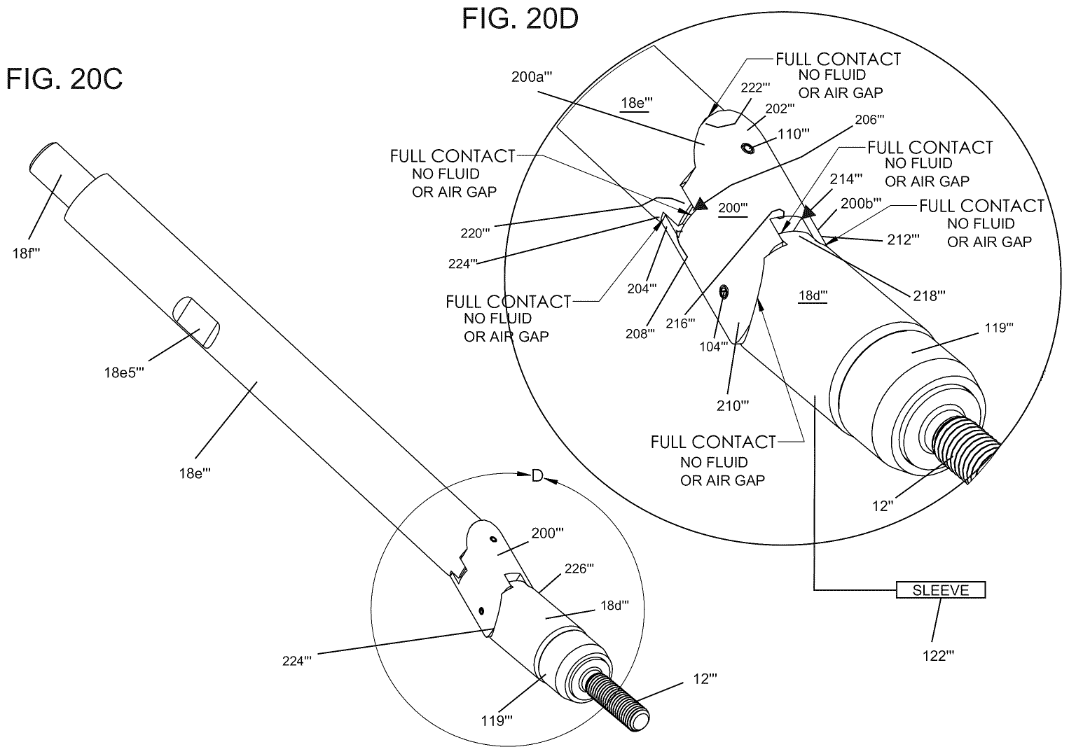

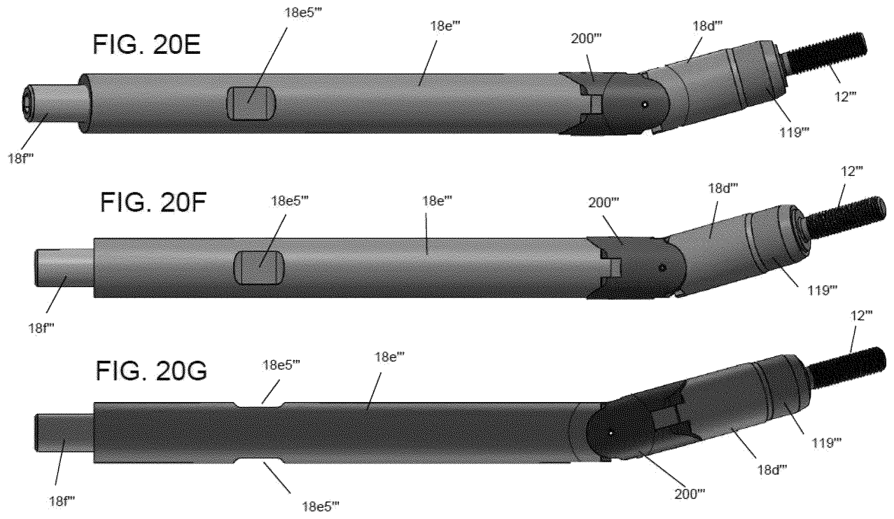

Referring now FIGS. 20A-20G, another embodiment is shown that is particularly useful in the “dry” application. For ease of illustration and description, like or similar parts in each of the embodiments are identified with the like part numbers, except a triple prime mark (“′″”) has been added to the embodiment of FIGS. 20A-20G.

In this embodiment, notice that the horn body 18e′″ and horn end 18d′″ are coupled together by an intermediate coupler 200′″ that functions similar to the intermediate coupler 112′″. Notice in FIGS. 20B and 20D that the intermediate coupler 200′″ comprises a first leg 202′″ and a second leg 204′″ that cooperate with a bottom surface to define a gap or channel 206′″ therebetween. A second end 200b′″ of the intermediate coupler 200′″ comprises a second pair of legs 210′″, 212′″ that are generally opposed and that cooperate to define a channel or groove 214′″ and the intermediate coupler 200′″ comprises a surface 216′″, similar to surface 208′″. The legs 210′″ and 212′″ cooperate with surface 216′″ to define the channel or groove 214′″ (FIG. 20D) and receive a leg or male extension 218′″ that is integral with the horn end 18d′″. The pivot pin 104′″ pivotally couples the horn end 18d′″ to the intermediate coupler 200′″. Likewise, the horn body 18e′″ comprises a leg 220′″ that is received in the channel 206′″. The horn body 18e′″ is pivotally coupled to the intermediate coupler 200′″ with the pivot pin 110′″ and horn end 18d′″ is pivotally coupled to the intermediate coupler 200′″ with the pivot pin 104′″.

Notice how the channels 206′″ and 214′″ are offset by approximately 90 degrees to permit the horn end 18d′″ to pivot in multiple planes and at least partially about multiple axes PA1, PA2 defined by the pivot pins 104′″ and 110′″. As with the embodiment described earlier herein relative to FIGS. 19A-19D, notice that the mating surfaces 202i′″-224′″; 202ii′″-208′″; 18d5i′″-18d6i′″ and 212′″-18d7′″ are rounded or curved and directly engage to provide the “dry” ultrasonic connection between these parts. Notice in FIG. 20D that at each of the intersections between the adjacent components labeled “FULL CONTACT,” there is no gap or space and the parts are in direct contact or engagement to facilitate permitting the ultrasonic energy or waveform to transfer or pass through the flexible ultrasonic joint 120′″.

Advantageously, this embodiment is similar to the embodiment of FIGS. 19A-19D in that the surfaces of these engaging components are in direct engagement and contact in order to facilitate transferring the ultrasonic energy to the horn end 18d′″ and ultimately to the fastener 12′″ in the manner described earlier herein. Of course, this embodiment may also be provided with gaps between the various component parts so that it can be used in a “wet” ultrasonic fluid and lubricant 114′″ environment of the type shown and described earlier herein. Accordingly, the sleeve 122′″ (shown in FIG. 20D) may be used with the embodiment shown in FIGS. 20A-20G.

As mentioned, this embodiment could also be provided similar to the embodiment shown in FIG. 18D wherein gaps or spaces are provided between adjacent components to permit ultrasonic fluid and lubricant 114′″ to pass into the gaps and between the components to facilitate transferring ultrasonic energy through the flexible ultrasonic joint 120′″. The sleeve 122′″ is optional, but is preferred in the “wet” embodiment so that ultrasonic fluid and lubricant 114′″ surrounds, envelops and is retained about the flexible ultrasonic joint 120′″ in the manner discussed and described earlier herein.

After the components are assembled together as illustrated in FIGS. 20A-20G, the horn end 18d′″ may be pivoted as illustrated (FIGS. 20C-20D) in one or a plurality of planes and at least partially about one or a plurality of axes as illustrated in the figures. Notice FIG. 20A, both the intermediate coupler 200′″ and horn end 18d′″ are pivoted with respect to each other and with respect to the horn body 18e′″. In FIG. 20C, which is another view of the embodiment shown in FIG. 20A, the horn end 18d′″ has been pivoted in multiple planes and axes of the intermediate coupler 200′″ and the horn end 18d′″ and they are not co-axial with each other or with the horn body 18e′″. In contrast, note in FIG. 20E that the intermediate coupler 200′″ comprises an axis that is co-axial with the horn body 18e′″, but not the horn end 18d′″ which is pivoted upward in the figure. FIG. 20G illustrates the intermediate coupler 200′″ having an axis coaxial with the axis of the horn end 18d′″ and both the intermittent coupler 200′″ and the horn end 18d′″ pivoted upward as shown. It should be understood that FIG. 20F is similar to FIG. 20G except that the tool 10″ has been rotated about its axis approximately 90 degrees. FIGS. 20C and 20D are similar to FIG. 20A in that the horn end 18d′″ is pivoted in multiple imaginary planes and at least partially about the plurality of axes PA1 and PA2.

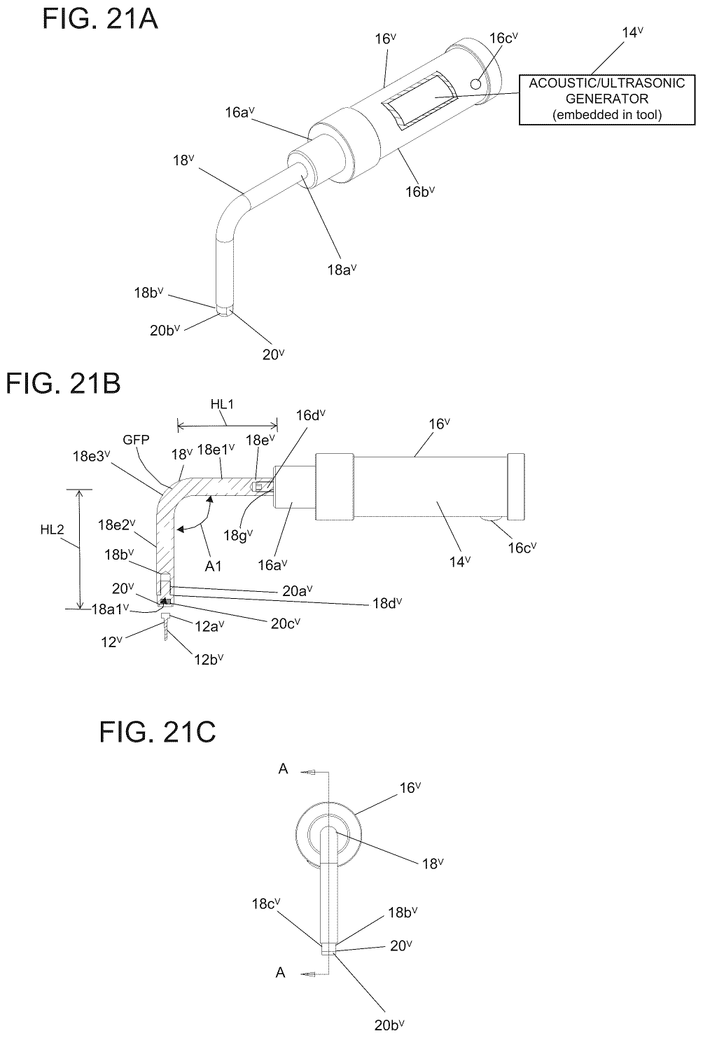

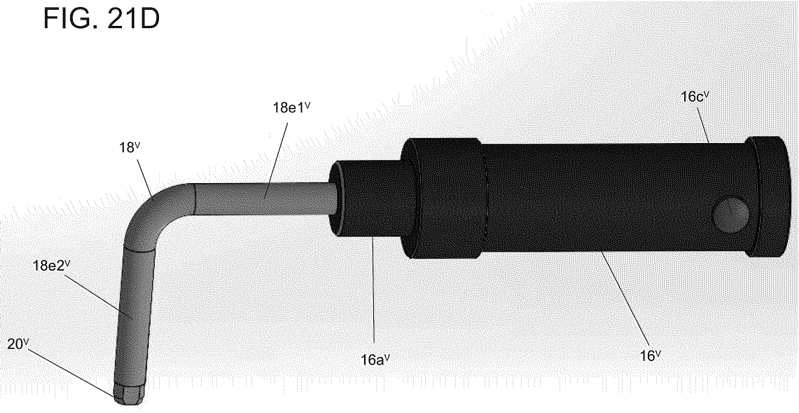

FIGS. 21A-28 illustrate additional embodiments of the invention. Referring now to these embodiments, the same parts are identified with the same part numbers except that one or more additional “prime” or Roman numeral marks have been added to the part number to distinguish among each embodiment.

Referring now to FIGS. 21A-26E, each of these embodiments operate similarly, but the horns 18^{V}, 18^{VI}, 18^{VII}, 18^{VIII}, 18^{IX} and 18^{X} transmit the energy from the fastener tools 16^{V}, 16^{VI}, 16^{VII}, 16^{VIII}, 16^{IX} and 16^{X}, respectively, and ultimately to the fasteners 12^{V}, 12^{VI}, 12^{VII}, 12^{VIII}, 12^{IX} and 12^{X}. In these embodiments, the systems 10^{V}, 10^{VI}, 10^{VII}, 10^{VIII}, 10^{IX} and 10^{X} comprise the fastener tools 16^{V}, 16^{VI}, 16^{VII}, 16^{VIII}, 16^{IX} and 16^{X} that have outer housings 16b^{V}, 16b^{VI}, 16b^{VII}, 16b^{VIII}, 16b^{IX} and 16b^{X} that are configured and shaped to house the acoustic/ultrasonic generators 14^{V}, 14^{VI}, 14^{VII}, 14^{VIII}, 14^{IX} and 14^{X} so that the acoustic/ultrasonic generators 14^{V}, 14^{VI}, 14^{VII}, 14^{VIII}, 14^{IX} and 14^{X} are embedded or housed in the fastener tool housings 16b^{V}, 16b^{VI}, 16b^{VII}, 16b^{VIII}, 16b^{IX} and 16b^{X} as shown. Each fastener tool 16^{V}, 16^{VI}, 16^{VII}, 16^{VIII}, 16^{IX} and 16^{X} comprises power or actuation switches 16c^{V}, 16c^{VI}, 16c^{VII}, 16c^{VIII}, 16c^{IX} and 16c^{X} respectively, that may be activated by the user to energize the acoustic/ultrasonic generators 14^{V}, 14^{VI}, 14^{VII}, 14^{VIII}, 14^{IX} and 14^{X} which are coupled to a conventional power source (not shown).

In these embodiments, armatures 16a^{V}, 16a^{VI}, 16a^{VII}, 16a^{VIII}, 16a^{IX} and 16a^{X} have threaded projections 16d^{V}, 16d^{VI}, 16d^{VII}, 16d^{VIII}, 16d^{IX} and 16d^{X}, respectively, that threadably engage the female threads 18g^{V}, 18g^{VI}, 18g^{VII}, 18g^{VIII}, 18g^{IX} and 18g^{X} of the horns 18^{V}, 18^{VI}, 18^{VII}, 18^{VIII}, 18^{IX} and 18^{X}. After the horns 18^{V}, 18^{VI}, 18^{VII}, 18^{VIII}, 18^{IX} and 18^{X} are threadably mounted on to the projections 16d^{V}, 16d^{VI}, 16d^{VII}, 16d^{VIII}, 16d^{IX} and 16d^{X} of the fastener tools 16^{V}, 16^{VI}, 16^{VII}, 16^{VIII}, 16^{IX} and 16^{X}, the switches 16c^{V}, 16c^{VI}, 16c^{VII}, 16c^{VIII}, 16c^{IX} and 16c^{X} may be activated by the user to cause the acoustic/ultrasonic energy to travel through the horns 18^{V}, 18^{VI}, 18^{VII}, 18^{VIII}, 18^{IX} and 18^{X} and into and through the tips 20^{V}, 20^{VI}, 20^{VII}, 20^{VIII}, 20^{IX} and 20^{X} and ultimately to the fasteners 12^{V}, 12^{VI}, 12^{VII}, 12^{VIII}, 12^{IX} and 12^{X}.

In general, systems 10^{V}, 10^{VI}, 10^{VII}, 10^{VIII}, 10^{IX} and 10^{X} operate substantially the same as the prior embodiments, except that the horns 18^{V}, 18^{VI}, 18^{VII}, 18^{VIII}, 18^{IX} and 18^{X} are different in each of these embodiments. However, the acoustic/ultrasonic energy travels through the horns 18^{V}, 18^{VI}, 18^{VII}, 18^{VIII}, 18^{IX} and 18^{X} and directly to the fasteners 12^{V}, 12^{VI}, 12^{VII}, 12^{VIII}, 12^{IX} and 12^{X} or to the tips 20^{V}, 20^{VI}, 20^{VII}, 20^{VIII}, 20^{IX} and 20^{X} which engage the fasteners 12^{V}, 12^{VI}, 12^{VII}, 12^{VIII}, 12^{IX} and 12^{X}. As mentioned earlier herein, the horns 18^{V}, 18^{VI}, 18^{VII}, 18^{VIII}, 18^{IX} and 18^{X} could be provided in monolithic construction as illustrated in FIG. 8 or they could be threaded with the tips 20^{V}, 20^{VI}, 20^{VII}, 20^{VIII}, 20^{IX} and 20^{X} (FIG. 9) having a predetermined shape that complements the shape of the fasteners 12^{V}, 12^{VI}, 12^{VII}, 12^{VIII}, 12^{IX} and 12^{X} being tightened or loosened.

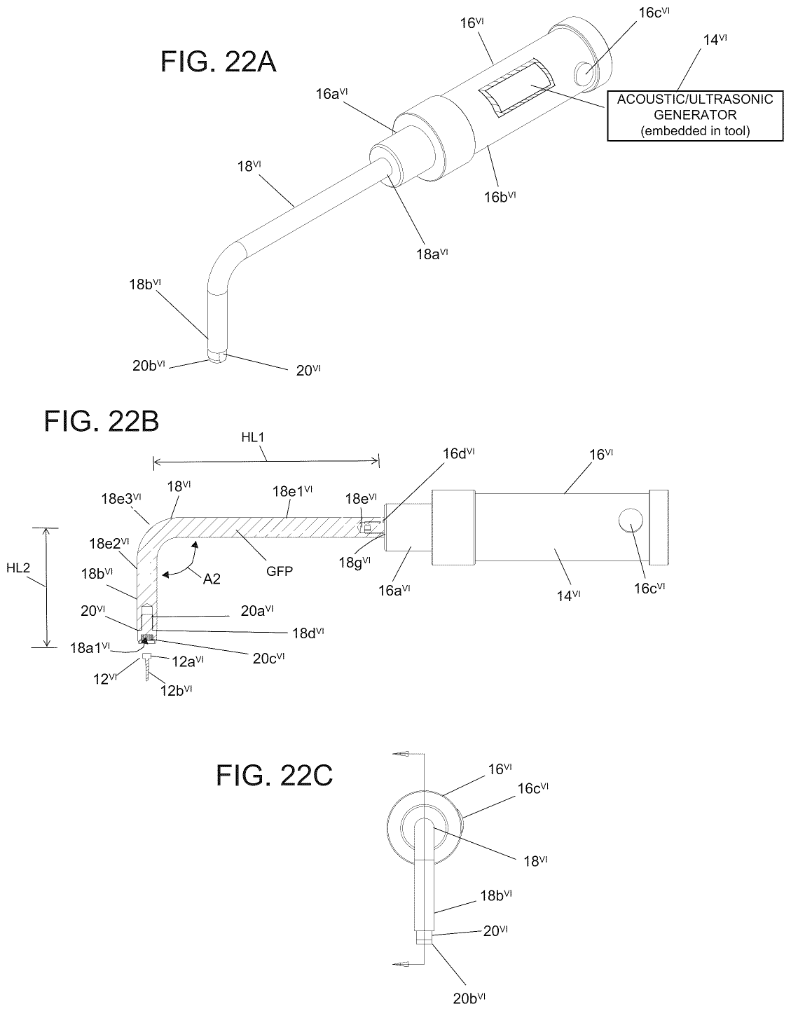

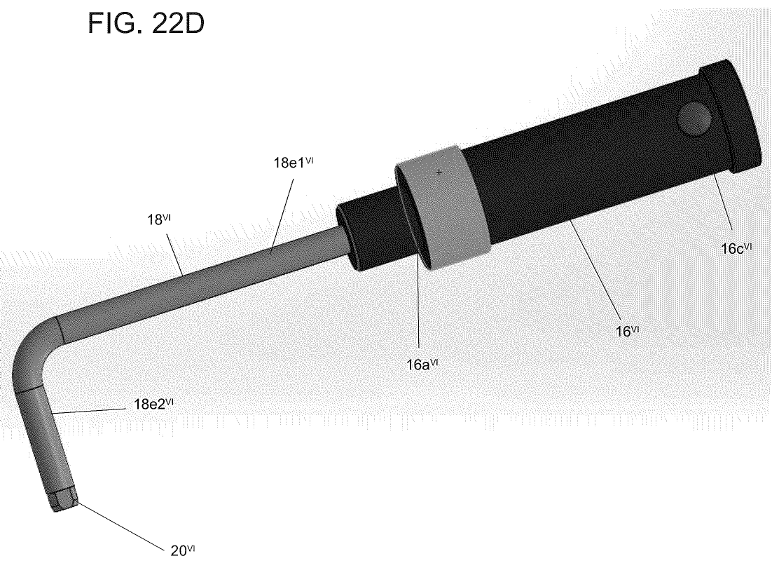

In the embodiment of FIGS. 21A-22D, notice that the horns 18^{V}, 18^{VI} are generally L-shaped with a horn length HL1 and a first portion 18e1^{V} and a second portion 18e2^{V} that has a second horn length HL2 and a joining portion 18e3^{V}. In this embodiment of FIGS. 21A-21D, note that the horn lengths HL1 and HL2 are generally the same and a generally 90-degree angle A1 is formed between the first portion 18e1^{V} and the second portion 18e2^{V}. It should be appreciated that the horn lengths HL1 and HL2 do not have to be the same. FIGS. 22A-22D illustrate where the horn lengths HL1 and HL2 are different. In this embodiment of FIGS. 22A-22D, note that the length HL1 is elongated and longer in length relative to the embodiment of FIGS. 21A-21D and is generally twice the length HL2 of the portions 18e2^{V}, 18e2^{VI}. Note in the embodiments of FIGS. 21A-22D, that the angles A1 and A2 between the first portions 18e1^{V}, 18e1^{VI} and the second portions 18e2^{V}, 18e2^{VI} are substantially 90 degrees.

In the embodiment of FIGS. 21A-25C, the horns 18^{V}, 18^{VI}, 18^{VII}, 18^{VIII}, 18^{IX} and 18^{X} have a predetermined grain pattern that facilitates transferring the ultrasonic energy to the fasteners 12^{V}, 12^{VI}, 12^{VII}, 12^{VIII}, 12^{IX} and 12^{X}, respectively. For example, notice in FIGS. 21B, 22B, 23B, 24B and 25B, that the flow pattern, labeled GFP, of the horns 8^{V}, 18^{VI}, 18^{VII}, 18^{VIII}, 18^{IX} and 18^{X} have the predetermined grain flow. The horns 18^{V}, 18^{VI} are made from a material such as titanium, but it should be understood that other materials, such as 1018 steel, may also be used, and follow a grain flow pattern in the material which facilitates transmitting the acoustic/ultrasonic energy from the tools 16^{V}, 16^{VI} to the fasteners 12^{V}, 12^{VI}. The inventors have found that by increasing the grain size in the material of the horns 18^{V}, 18^{VI} to be small. In this regard, the horns 18^{V}, 18^{VI} may be processed or treated to facilitate making the grain structure which in turn facilitates transferring the acoustic/ultrasonic energy through the horns 18^{V}, 18^{VI} and to the fasteners 12^{V}, 12^{VI}. In one illustrative embodiment, the horns 18^{V}, 18^{VI} are heated in a predetermined area and then bent into the desired shape as illustrated in FIGS. 21A-22D. In another embodiment, the material was normalized three times after bending the horns 18^{V}, 18^{VI} which in turn also made the grain structure in the heated zone in the material small. One unexpected result of such processing is that it was discovered that the horns 18^{V}, 18^{VI} may be bent during such heating at a bend area and that the horns 18^{V}, 18^{VI} may be bent to any predetermined angle and remain fully functional in that they transmit the acoustic/ultrasonic energy from the tools 16^{V}, 16^{VI} and through the bend area to the horns 18^{V}, 18^{VI} and into the fasteners 12^{V}, 12^{VI}.

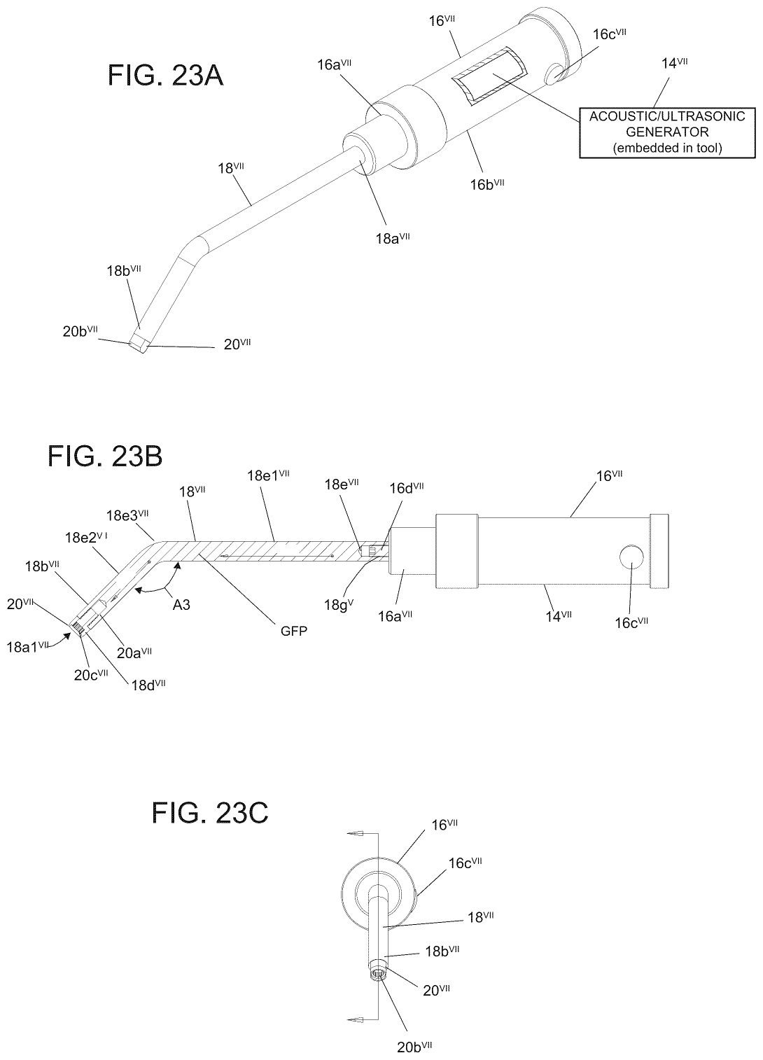

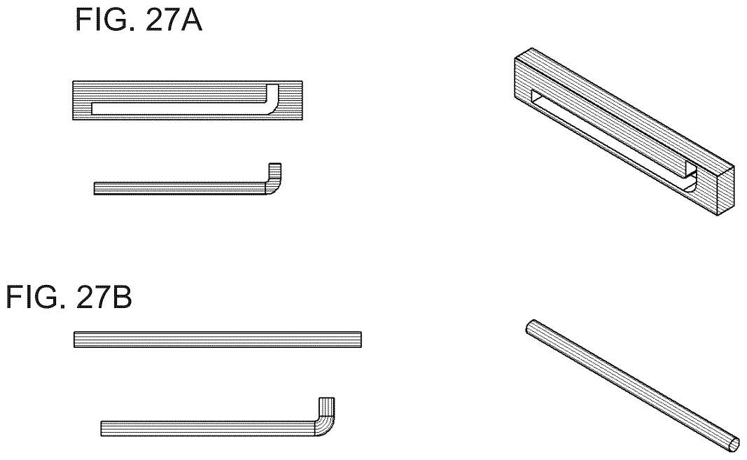

Accordingly, note in FIGS. 23A-25C that the process was applied to the horn 18^{VII}, 18^{VIII} and 18^{IX} of those embodiments. It should be understood that if you cut an L shape from a plate of steel the grain is 90 degrees after the bend. If you use a rod of steel the grain runs the length of the rod. When you bend the rod, the grain follows the shape of the bent rod. Please see FIGS. 27A and 27B.

In FIGS. 23A-23C, note the similar embodiment except that the horn 18^{VII} comprises a first portion 18e1^{VII} and a second portion 18e2^{VII} and an angle A3 that is obtuse as illustrated in the figures. In the embodiment shown in FIGS. 23A-23C, note that the first portion 18e1^{VII} is substantially longer than the second portion 18e2^{VII} and is similar to the embodiment shown in FIGS. 22A-22D except that the angle A2 between the first and second portions 18e1^{VII} and 18e2^{VII} is obtuse and on the order of about 45 degrees.

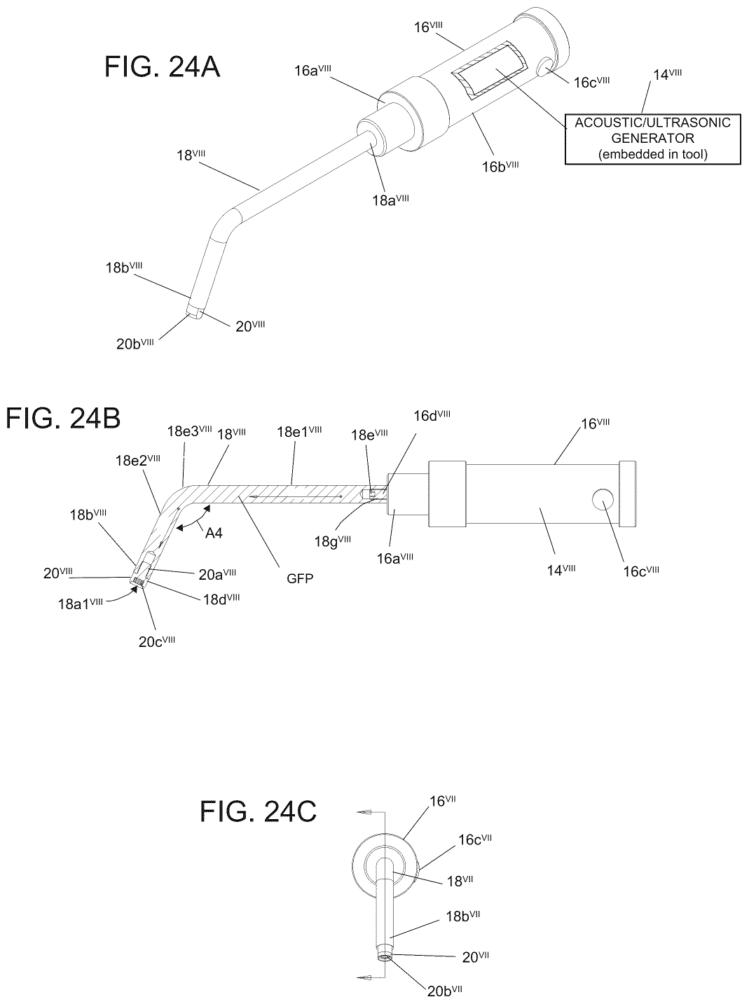

In contrast, note that the embodiment of FIGS. 24A-24C illustrate that the angle A4 between the portions 18e1^{VIII} and 18e2^{VIII} is on the order of about 25 degrees.

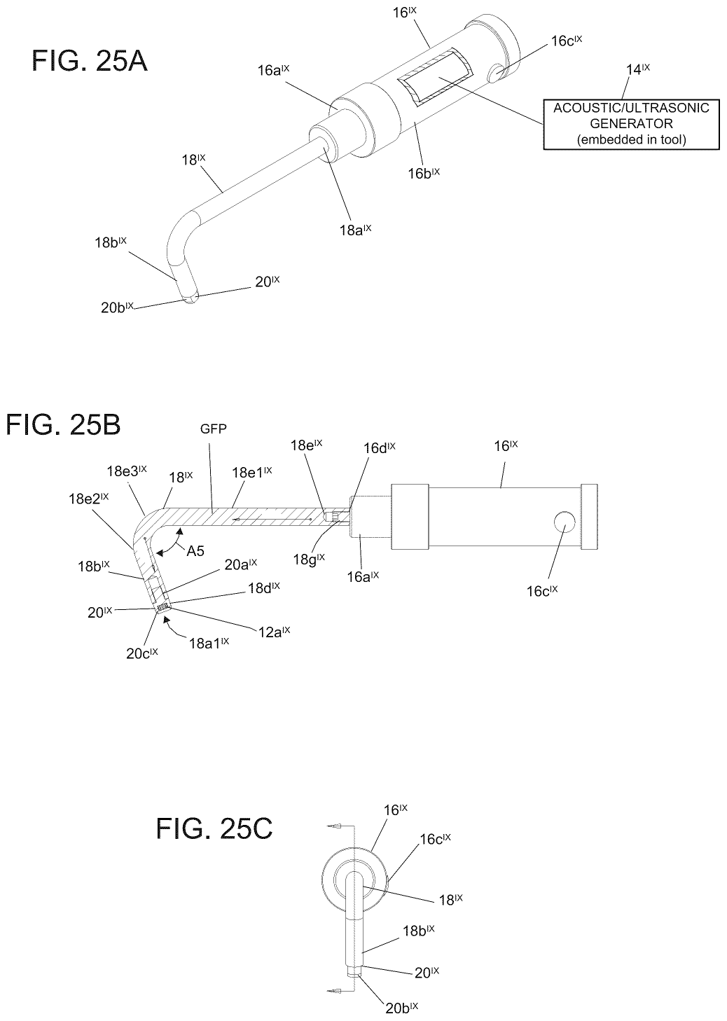

FIGS. 25A-25C illustrate another embodiment of the invention similar to FIGS. 23A-24C, except that the angle A5 (FIG. 25B) between the portions 18e1^{IX} and 18e2^{IX} is about 110 degrees. Thus, the inventors have found that adapting and configuring the portions 18e1^{IX} and 18e2^{IX} that they can be configured into any predetermined obtuse or acute angle as illustrated in FIGS. 21A-25C. By processing the horns 18^{V}, 18^{VI}, 18^{VII}, 18^{VIII}, 18^{IX} and 18^{X} and by normalizing the material making up the horns 18^{V}, 18^{VI}, 18^{VII}, 18^{VIII}, 18^{IX} and 18^{X} at least one or a plurality of times in order to make the grain structure in the heated zone of the material small facilitates transferring the acoustic/ultrasonic energy from the tool 16^{IX} to the fastener 12^{IX}. Note in each of the embodiments that the grain structure flows generally longitudinally along an axis of the horn 18^{IX}. Normalization is a high temperature austenitizing heating cycle followed by cooling in still or agitated air that is performed for a variety of reasons but primarily is performed to homogenize the microstructure and remove any segregation or non-uniformities that may exist at the microscopic level.

In general, the user selects the horns 18^{V}, 18^{VI}, 18^{VII}, 18^{VIII}, 18^{IX}, 18^{X} having the desired shape in response to the fasteners 12^{V}, 12^{VI}, 12^{VII}, 12^{VIII}, 12^{IX}, 12^{X} with the desired predetermined angular relationship between the first portions 18e1^{V}, 18e1^{VI}, 18e1^{VII}, 18e1^{VIII}, 18e1^{IX}, 18e1^{X} and the second portions 18e1^{V}, 18e1^{VI}, 18e1^{VII}, 18e1^{VIII}, 18e1^{IX}, 18e1^{X}, which will depend on the environment where the fasteners 12^{V}, 12^{VI}, 12^{VII}, 12^{VIII}, 12^{IX}, 12^{X} are located. The ends 18a^{V}, 18a^{VI}, 18a^{VII}, 18a^{VIII}, 18a^{IX}, 18a^{X} of the horns 18^{V}, 18^{VI}, 18^{VII}, 18^{VIII}, 18^{IX}, 18^{X} may be adapted to have the size and shape that complements the shape of the heads 12a^{V}, 12a^{VI}, 12a^{VII}, 12a^{VIII}, 12a^{IX}, 12a^{X} of the fasteners 12^{V}, 12^{VI}, 12^{VII}, 12^{VIII}, 12^{IX}, 12^{X}, as in the embodiments with the integral shapes illustrated in FIG. 8. Similar to the embodiments of FIG. 1, the horn ends 18a^{V}, 18a^{VI}, 18a^{VII}, 18a^{VIII}, 18a^{IX}, 18a^{X} may be configured and adapted to receive the tips 20^{V}, 20^{VI}, 20^{VII}, 20^{VIII}, 20^{IX}, 20^{X} having the predetermined shape mentioned earlier herein and as illustrated in FIG. 9. Once the horns 18^{V}, 18^{VI}, 18^{VII}, 18^{VIII}, 18^{IX}, 18^{X} are placed in the desired positions (if the horns 18^{V}, 18^{VI}, 18^{VII}, 18^{VIII}, 18^{IX}, 18^{X} do not have a dedicated configuration), the tips 20^{V}, 20^{VI}, 20^{VII}, 20^{VIII}, 20^{IX}, 20^{X} are mounted on the horn end 18a^{V}, 18a^{VI}, 18a^{VII}, 18a^{VIII}, 18a^{IX}, 18a^{X} and then the user places the tips 20^{V}, 20^{VI}, 20^{VII}, 20^{VIII}, 20^{IX}, 20^{X} onto the fasteners 12^{V}, 12^{VI}, 12^{VII}, 12^{VIII}, 12^{IX}, 12^{X} in the manner described earlier herein.

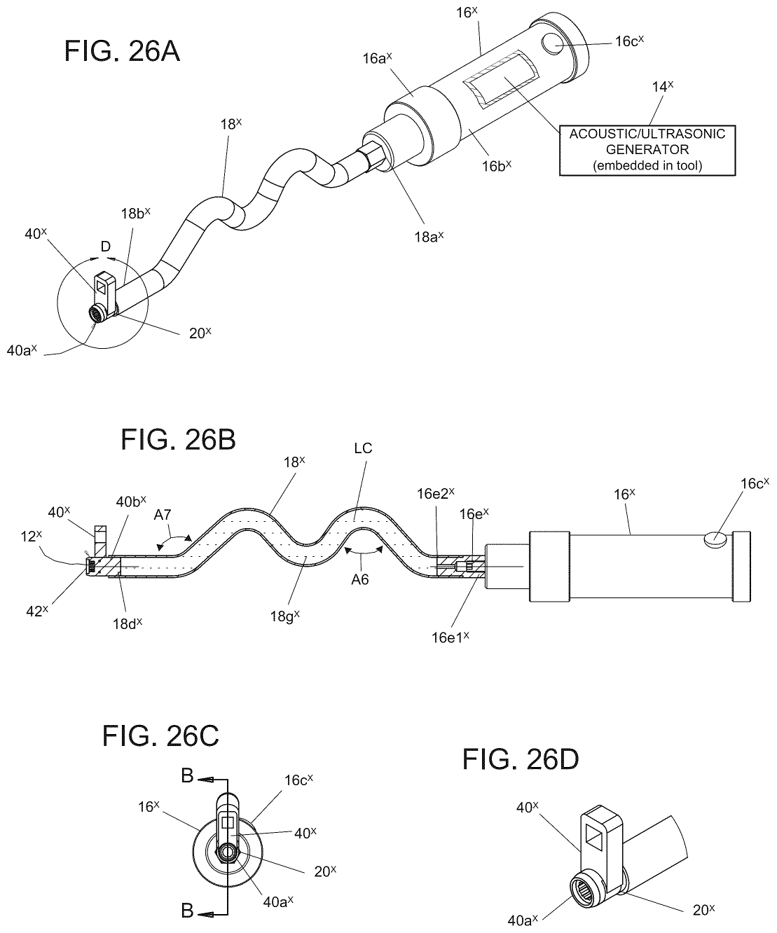

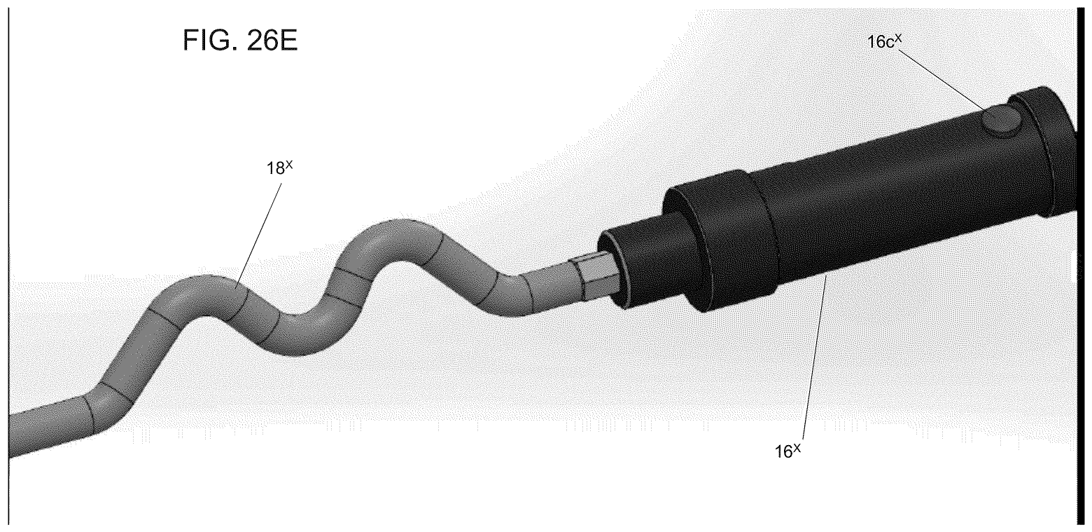

As described earlier herein relative to FIGS. 2A-2B, the systems 10^{V}, 10^{VI}, 10^{VII}, 10^{VIII}, 10^{IX}, 10^{X} may comprise the rotational torque applicator 40^{X} (FIGS. 26A-26E) for applying a rotational torque to the fasteners 12^{V}, 12^{VI}, 12^{VII}, 12^{VIII}, 12^{IX}, 12^{X} substantially simultaneously as the acoustic/ultrasonic energy passes into the fasteners 12^{V}, 12^{VI}, 12^{VII}, 12^{VIII}, 12^{IX}, 12^{X} as also described earlier herein. Alternately, the hand rotational torque applicator 40^{X} may be used. The rotational torque applicator 40^{X} may comprise at least one of a mechanical torque applicator in the form of a wrench 42^{X} or a tool sized and adapted to engage the generally optimized geometry and/or flat and opposing surfaces 18b^{V}, 18b^{VI}, 18b^{VII}, 18b^{VIII}, 18b^{IX}, 18b^{X} and 18c^{V}, 18c^{VI}, 18c^{VII}, 18c^{VIII}, 18c^{IX}, 18c^{X} to permit manual rotational torque application. Alternatively, the acoustic/ultrasonic torque applicator 44 may be coupled to the acoustic/ultrasonic generator 44a which energizes the wrench 42 (as shown in detail in FIGS. 2A and 2B) to rotationally drive the horns 18^{V}, 18^{VI}, 18^{VII}, 18^{VIII}, 18^{IX}, 18^{X} which in turn rotationally drives the fasteners 12^{V}, 12^{VI}, 12^{VII}, 12^{VIII}, 12^{IX}, 12^{X}.

As illustrated in FIGS. 21A-26E, the housings 16a^{V}, 16a^{VI}, 16a^{VII}, 16a^{VIII}, 16a^{IX}, 16a^{X} of the tools 16^{V}, 16^{VI}, 16^{VII}, 16^{VIII}, 16^{IX}, 16^{X} receive and store the acoustic/ultrasonic generators 14^{V}, 14^{VI}, 14^{VII}, 14^{VIII}, 14^{IX}, 14^{X}. Handles, actuation switches or buttons 16c^{V}, 16c^{VI}, 16c^{VII}, 16c^{VIII}, 16c^{IX}, 16c^{X} may be provided for energizing the acoustic/ultrasonic generators 14^{V}, 14^{VI}, 14^{VII}, 14^{VIII}, 14^{IX}, 14^{X}. When the switches 16c^{V}, 16c^{VI}, 16c^{VII}, 16c^{VIII}, 16c^{IX}, 16c^{X} are actuated, the acoustic/ultrasonic generators 14^{V}, 14^{VI}, 14^{VII}, 14^{VIII}, 14^{IX}, 14^{X} pass the acoustic/ultrasonic energy through the horns 18^{V}, 18^{VI}, 18^{VII}, 18^{VIII}, 18^{IX}, 18^{X} and into the fasteners 12^{V}, 12^{VI}, 12^{VII}, 12^{VIII}, 12^{IX}, 12^{X} as described herein. Note in the embodiments being described that the axis of the tools 16^{V}, 16^{VI}, 16^{VII}, 16^{VIII}, 16^{IX}, 16^{X} are generally perpendicular to a center line of the fasteners 12^{V}, 12^{VI}, 12^{VII}, 12^{VIII}, 12^{IX}, 12^{X} and lie at an either an obtuse or acute angle as described herein. By using the torque application 40^{X}, there is no need for a second tool or wrench, such as a “spanner” type wrench, to turn the horns 18^{V}, 18^{VI}, 18^{VII}, 18^{VIII}, 18^{IX}, 18^{X} to loosen or tighten the fasteners 12^{V}, 12^{VI}, 12^{VII}, 12^{VIII}, 12^{IX}, 12^{X}.

During use, the tools 16^{V}, 16^{VI}, 16^{VII}, 16^{VIII}, 16^{IX}, 16^{X} and the ends 18d^{V}, 18d^{VI}, 18d^{VII}, 18d^{VIII}, 18d^{IX}, 18d^{X} are manipulated and placed and the ends 18d^{V}, 18d^{VI}, 18d^{VII}, 18d^{VIII}, 18d^{IX}, 18d^{X} are placed on the fasteners 12^{V}, 12^{VI}, 12^{VII}, 12^{VIII}, 12^{IX}, 12^{X}, respectively, and then either the tools 16^{V}, 16^{VI}, 16^{VII}, 16^{VIII}, 16^{IX}, 16^{X} are rotated or the torque applicator 40^{X} describe earlier is used to apply the rotational torque as described herein.

Referring now to FIGS. 26A-26E, still another embodiment is shown. In this embodiment, the horn 18^{X} is flexible so that the end 18d^{X} can be positioned in any predetermined position relative to the tool 16^{X}. In this embodiment, the horn 18^{X} is tubular or hollow and defines a closed chamber 18g^{X} that is adapted to receive and store or house a liquid conductor LC. In this embodiment, the liquid conductor LC (FIG. 26B) in area 18g^{X} of the horn 18^{X} transmits the acoustic/ultrasonic energy from the tool 16^{X} to the end 18d^{X} and/or tip 20^{X}. In this embodiment, the rotational torque applicator 40^{X} comprises the socket 42^{X} and tip 20^{X} which may be integrally formed therein. As with prior embodiments, the torque applicator 40^{X} may have a threaded female aperture (not shown) for receiving a threaded projection 20a^{X} of one or more of the tips 20, 20ai, 20aii, 20aiii, and 20aiv, for example, as illustrated in FIG. 9. In the illustration shown in FIGS. 26A-26E, note that the socket 40a^{X} and the rotational torque applicator 40^{X} is a custom socket or “crow's foot” as known in the art and is selected or adapted in response to the fastener 12^{X} being tightened or loosened. The socket 40a^{X} may also have the tip 20, 20ai, 20aii, 20aiii, and 20aiv as part of the design, then attached to horn 18^{X}. The rotational torque applicator 40^{X} may be attached to a ratchet wrench (not shown) or it can be used with a open-end wrench on the socket 40a^{X}.

In the illustration being described, the liquid conductor LC is an ultrasonic liquid, such as oil, glycerin or water. It should be understood that the horn 18^{X} is tubular and that the tubing is flexible and may be a silicone flexible tube, but has enough memory to retain its shape once it is configured to a predetermined shape by the user. Thereafter, it can be reconfigured to a different shape. During use, the ultrasonic energy from the tool 16^{X} is transmitted through the horn 18^{X} and the liquid conductor LC conducts the acoustic/ultrasonic energy to the end 18d^{X} and ultimately to the fastener 12^{X}. The tube may be flexible all the time and not rigid. Alternatively, it could be partially flexible and partially rigid, or it could be rigid. In a preferred embodiment, the tube is flexible along its length so that it can be adapted for use in tight environments.

In the embodiments of FIGS. 26A-26E, an end 16e^{X} that defines a male projection that has an outer surface 16e1^{X} that is stepped or has a reduced diameter at the area 16e2^{X} so that the tubing may be press-fit, molded directly to the socket 40a^{x} or a clamp collar can be utilized thereon. Although not shown, this end may be integrally mounted or have a sheath or one or more seals or gaskets for sealing the horn 18^{X}. (Likewise, the diameter of the end 40b^{X} is also sized to receive the end 18d^{X} of the horn 18^{X} as illustrated. It may be permanently fastened to or conventionally sealed with a conventional seal, press-fit, mold or clamp collar.

It should be appreciated that in the embodiment of FIGS. 26A-26E that the horn 18^{X} can be shaped into at least one or a plurality of predetermined angles from 0-360 degrees. Indeed, the horn 18^{X} of this embodiment may also be configured to have no angles. Note that in FIG. 26B, the angle A7 in the first portion of the horn 18^{X} is acute. Note that the angle A6 near the end 18d^{X} is obtuse. The inventor has found that this flexibility makes the invention extremely easy to use in difficult areas where it is hard to use a hand tool. The horn 18^{X} of the embodiment of FIGS. 21A-26E allows easier access into areas that are difficult to get to. The horn 18^{X} and liquid conductor LC also facilitate transferring the acoustic/ultrasonic energy into the fastener 12^{X}, even though the entry to the fastener 12^{X} has an angle of entry into the tool 16^{X} that was not achievable in the past.

By providing a predetermined grain flow pattern in the embodiments of FIGS. 21A-25C in the material and causing that grain to be oriented into a predetermined pattern with the grain flow pattern relatively small In contrast, the embodiment of FIGS. 26A-26E further facilitates use of a non-metallic or liquid conductor LC that transmits the acoustic/ultrasonic energy from the fastener tool 16^{X}, through the horn 18^{X} and ultimately to the fastener 12^{X} as described herein.

Advantageously, the embodiments of FIGS. 21A-26E provide angled or flexible horns 18^{V}, 18^{VI}, 18^{VII}, 18^{VIII}, 18^{IX}, 18^{X} that are adapted for use in tough-to-get-to environments and for ease of use by the operators/mechanics and speed of use for the operators/mechanics.

FIGS. 27A and 27B Shown in the above figures are a direct representation of the affective and non-affective manufacturing procedures for NextGen Aerospace Technologies 90-degree extension.

FIG. 27A displays the non-affective manufacturing procedure, in which the extension is produced from a solid state of material. By doing this, the grain directions as represented by the hatch lines, all remain in the same direction, no matter the shape of the resulting component. Consequently, once the ultrasonic waves reach the 90-degree bend, flowing from the tip of the long end of the extension or horn 18, the flow of the ultrasonic waves are disrupted as they attempt to flow against the grain structure of the material. Following this manufacturing method results in a non-affective extension when the extension is placed into its working state.

FIG. 27B displays the affective manufacturing procedure, in which the extension is manufactured from a solid rod, through a heating and bending process. By doing this, the grain directions as represented by the hatch lines, are able to be changed once the extension is bent during the heating process. Following this manufacturing method results in an affective extension when placed in its working state, as the flow of ultrasonics are able to easily follow the directional grain pattern, as the grain pattern now follows the features of the extension.

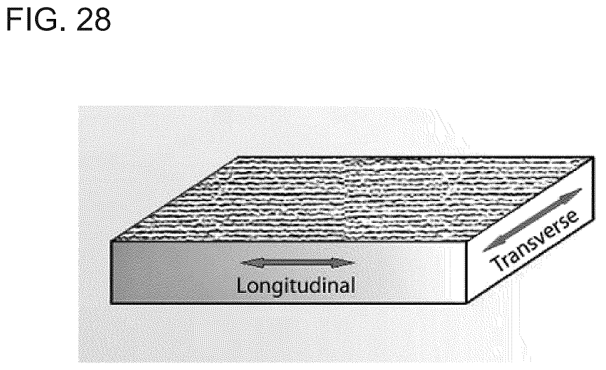

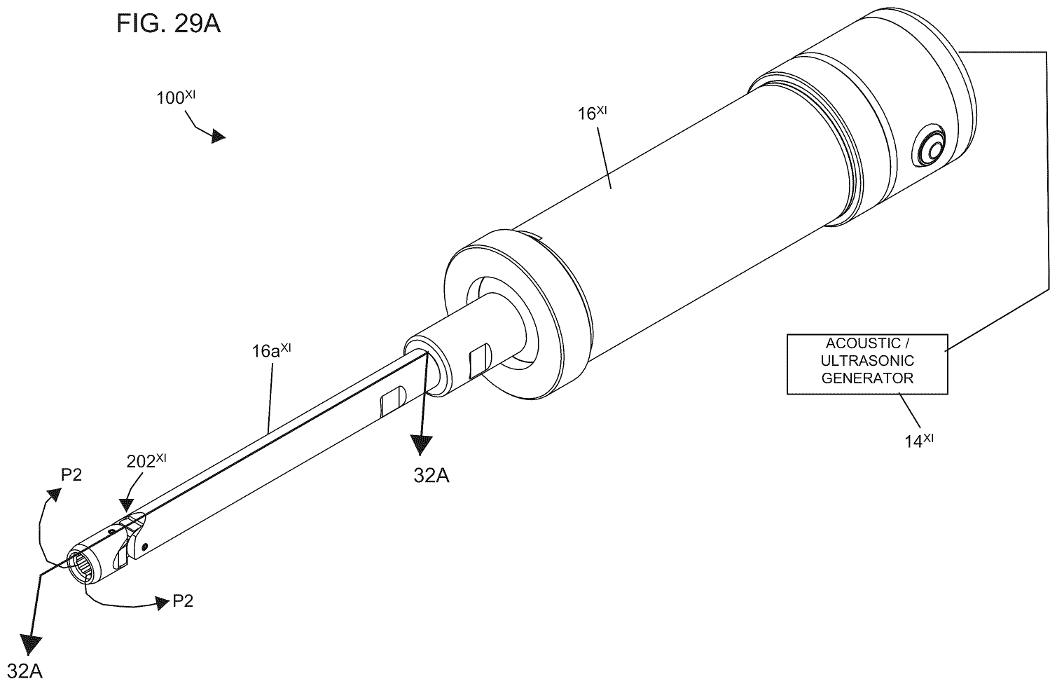

FIG. 28 illustrates a grain flow pattern. Notice in this figure that the grain flow pattern in the horn 18 is formed to become generally co-axial with the axis of the horn 18. The inventors have found that this grain alignment facilitates the transfer of the ultrasonic energy.

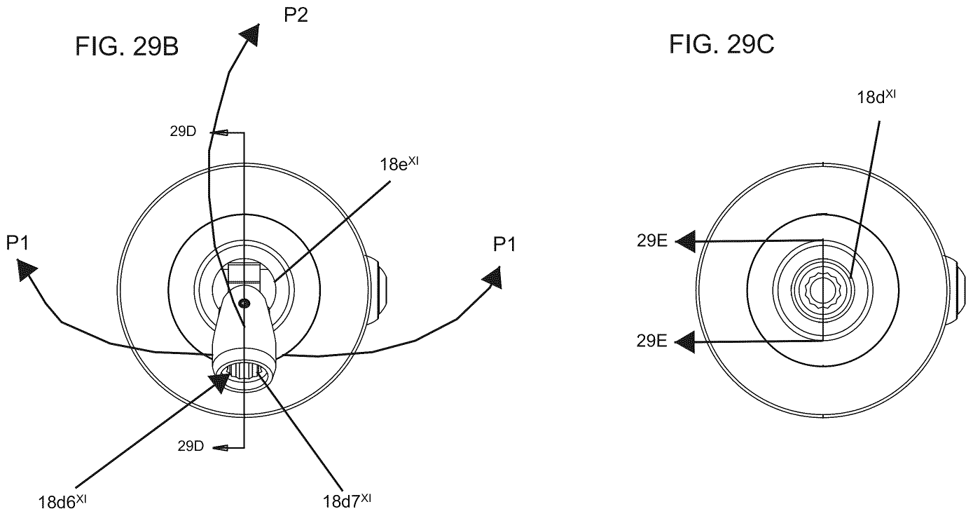

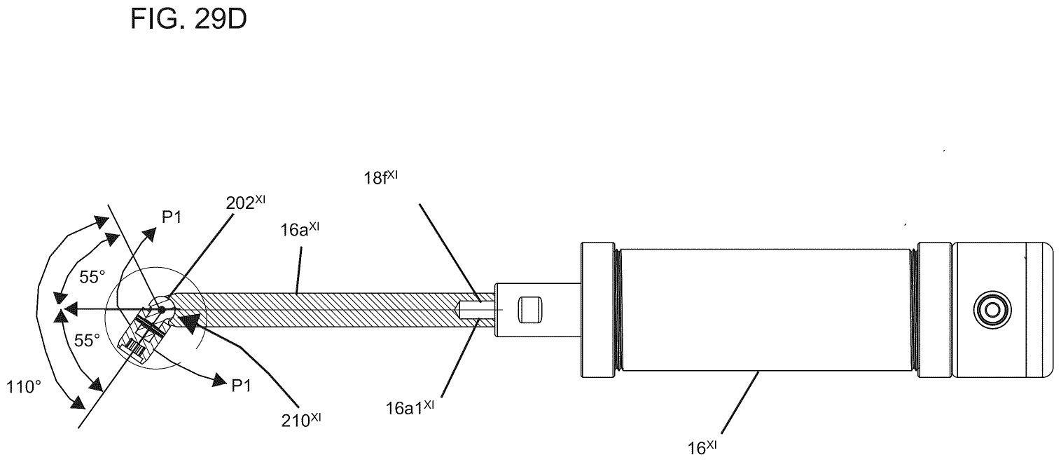

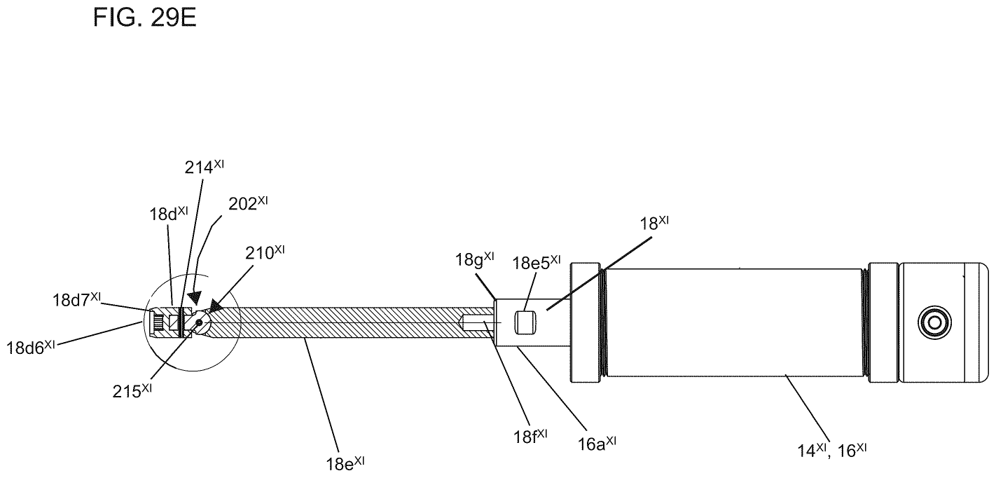

Referring now to FIGS. 29A-32I, several other embodiments of the ultrasonic fastener tool 16^{XI} and system 100^{XI} are shown. For ease of illustration and description, like or similar parts in each of the embodiments are identified with the like part numbers, except that an additional prime mark, such as a roman numeral xi, xii, etc. are used.

In the embodiments of FIGS. 29A-32I, another fastener tool 16^{XI} and system 100^{XI} is shown that comprises a unique at least one or a plurality of flexible ultrasonic joints 202^{XI}. As with the prior embodiments, the system 100^{XI} comprises the acoustic/ultrasonic generator 14^{XI} that operates and is adapted to function as described earlier herein relative to the acoustic/ultrasonic generator 14^{XI} of the prior embodiments of FIGS. 1-28.

In the embodiments of FIGS. 29A-32I, the system 100^{XI} comprises the fastener tool 16^{XI} having the armature 16a^{XI} and a threaded aperture 16a1^{XI} (FIG. 29D) that is adapted and sized to receive the threaded projection 18f^{XI} which is also threadably received in a threaded area 18g^{XI} (FIG. 29E) in the horn 18^{XI}. The embodiments of FIGS. 29A-32I comprise the at least one or a plurality of universal flexible ultrasonic joints 202^{XI} that permits pivoting of the horn end 18d^{XI} relative to the horn body 18e^{XI} that provide maximum contact between or among parts to facilitate ultrasonic energy transfer as described herein.

In FIG. 29D, it should be noted that the at least one or a plurality of universal flexible ultrasonic joints 202^{XI} is shown in one of four angled positions (shown at angles of 55 degrees) from the centerline of the extension shaft of FIG. 29E shows the fastener tool 16^{XI} shown in a straight position.

In the illustration being described, the at least one or a plurality of universal flexible ultrasonic joints 202^{XI} pivotally couples the horn end 18d^{XI} that is sized and adapted to receive the head 12a^{XI} of the fastener 12^{XI} as in the prior embodiments. In this regard, notice that the horn 18^{XI} in the embodiments of FIG. 29B has the socket or working end 18d7^{XI} that is monolithically formed in the horn end 18d^{XI} and the apertures 18d6^{XI}. It should be appreciated that the horn 18^{XI} is similar to the horn 18 illustrated in FIG. 16A. It should be understood, however, that the horn end 18d^{XI} may be threaded as in the embodiment shown in FIG. 17F to receive a detachable socket that has a male thread 119a (FIG. 17B) that is threadably received in a female aperture in the horn end 18d^{XI}. Alternatively, and as described earlier herein, other means and apparatus could be used and adapted for detachably coupling the socket or working end 18d7^{XI} to the horn 18^{XI}. For example, the coupling may be a conventional male hex or snap-on coupling. Other manners of connecting the socket are possible, as long as there is good contact and enough surface contact to transmit or permit the ultrasonic or acoustic energy to pass through the tool. Although not shown, the intersections among engaging surfaces may be lubricated, which the inventors have found to facilitate ultrasonic or acoustic energy transfer and also keeps the universal joint 202 from seizing.

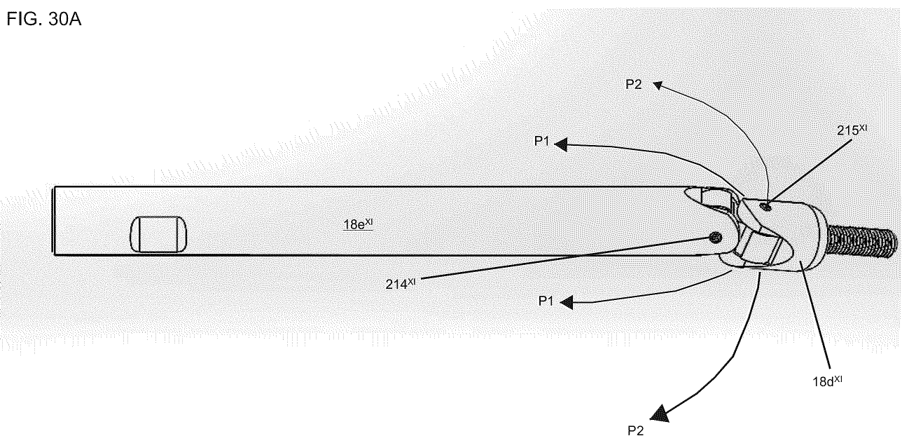

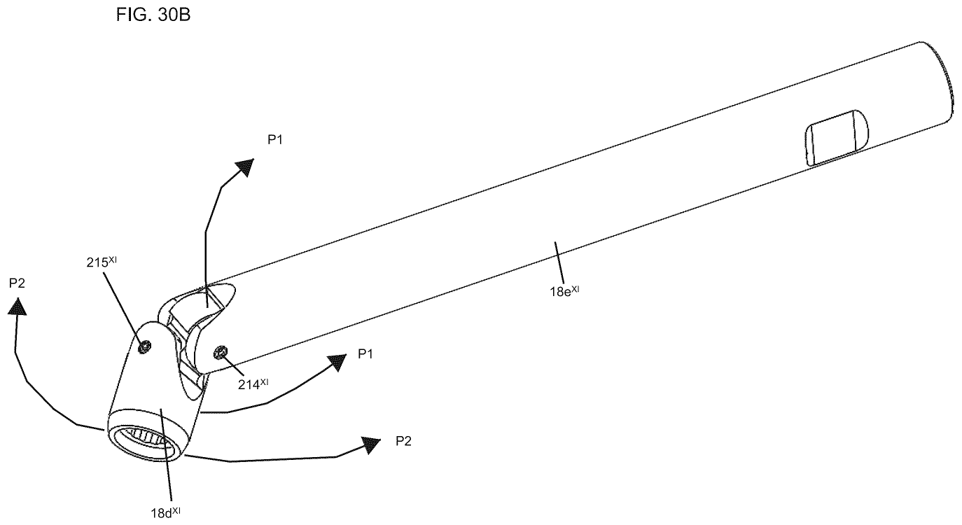

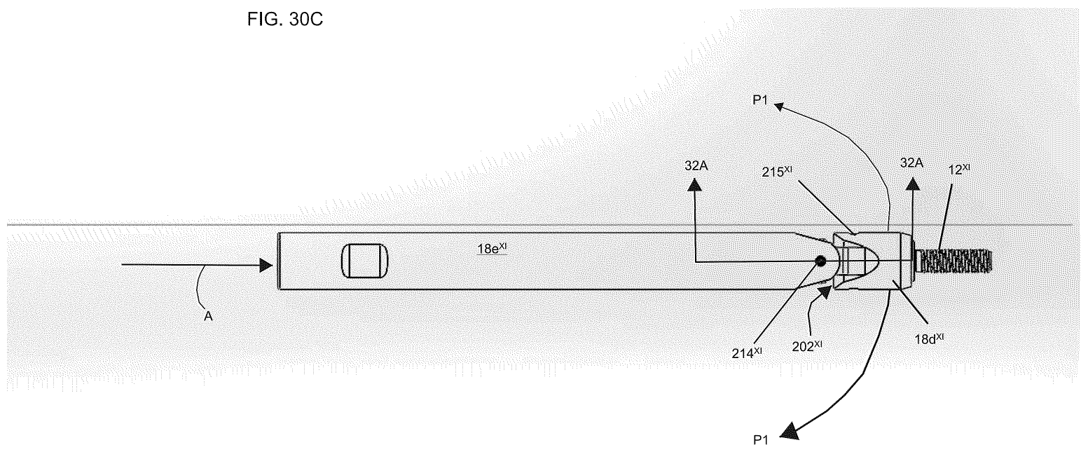

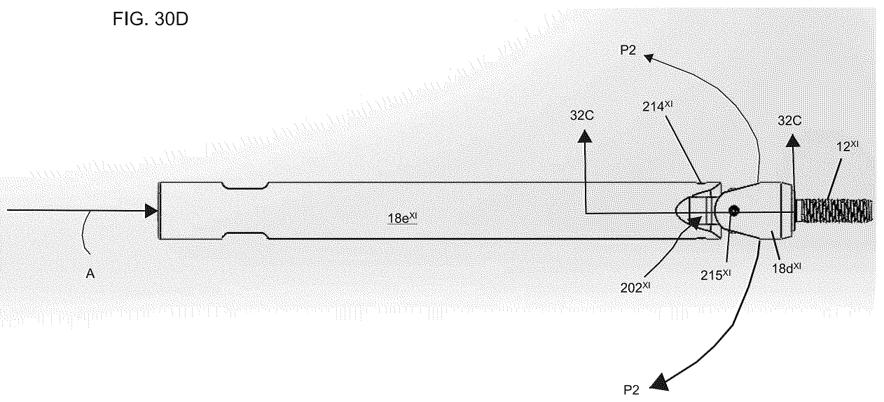

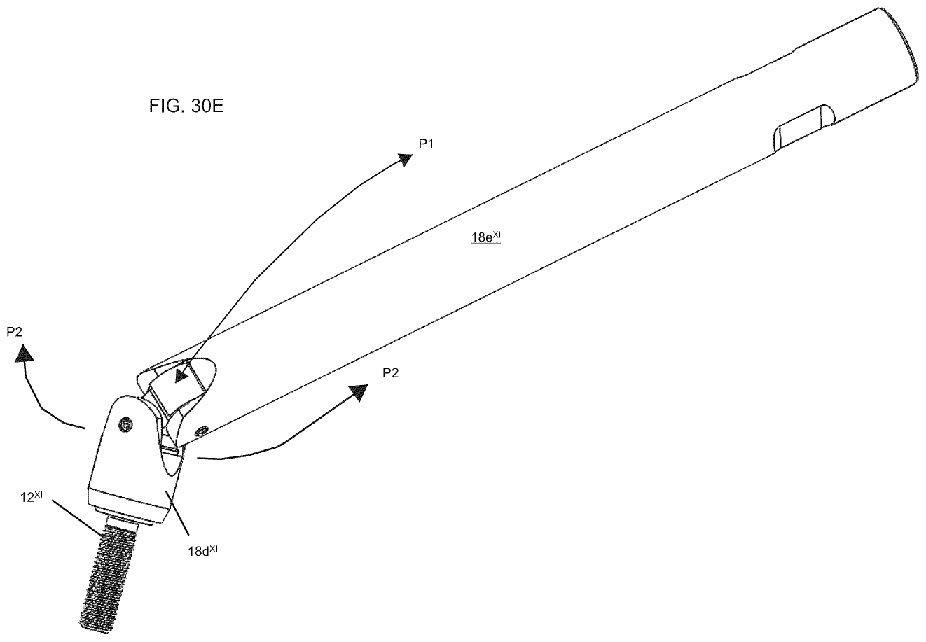

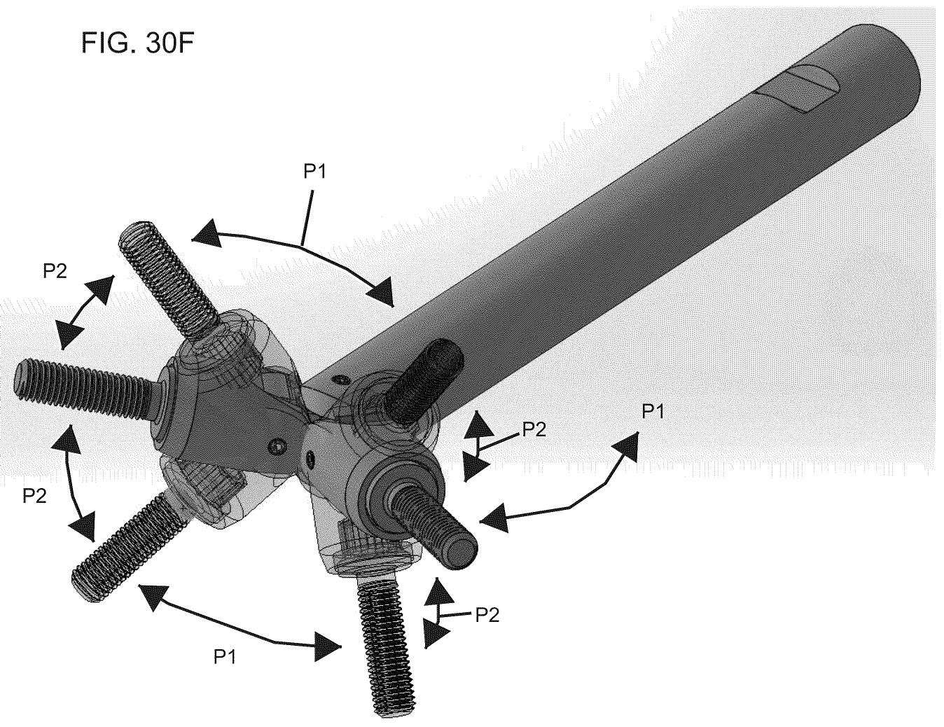

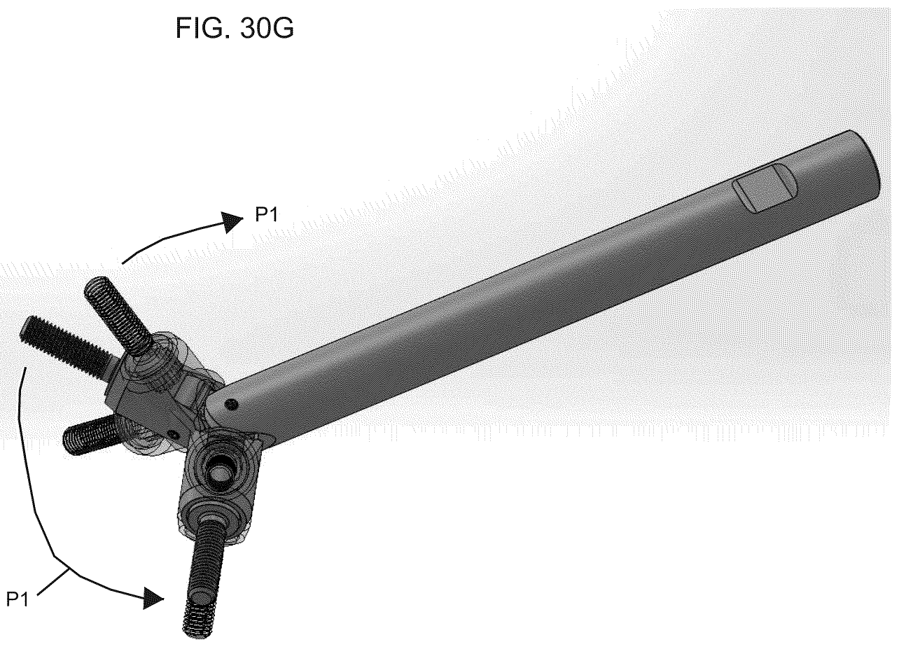

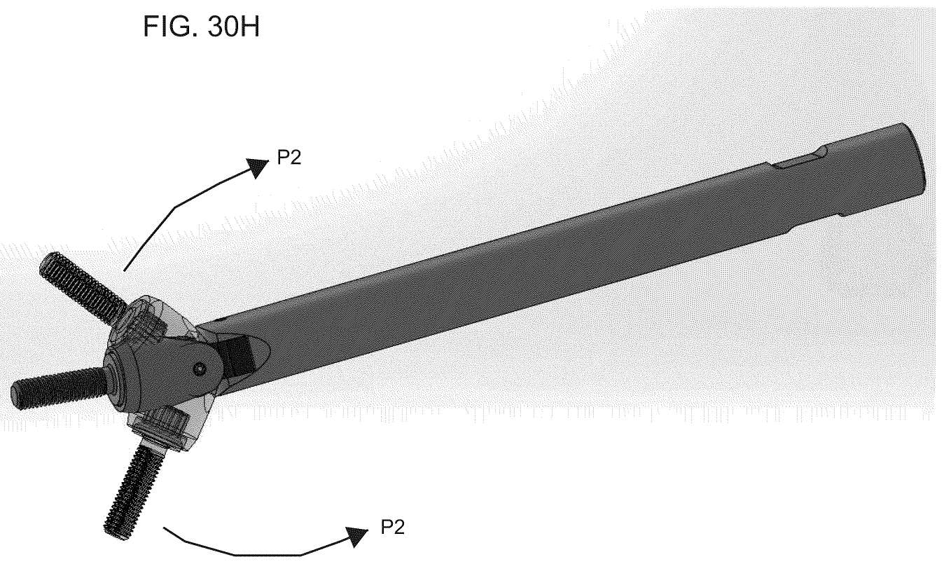

The at least one or a plurality of universal flexible ultrasonic joints 202^{XI} comprise internal parts and structure described herein to provide a “dry” connection between or among them and provides maximum ultrasonic contact and energy transfer among the components in order to efficiently transmit the ultrasonic energy from the fastener tool 16^{XI} to the fastener 12^{XI}, even after the at least one or a plurality of universal flexible ultrasonic joints 202^{XI} is pivoted and an axis of the horn end 18d^{XI} is not co-axial with the horn body 18e^{XI}. The at least one or a plurality of universal flexible ultrasonic joints 202^{XI} has several features which permit a user to pivot the socket or working end 18d7^{XI} (FIG. 30A) of the horn end 18d^{XI} into a desired position relative to the fastener head 12a^{XI}. Notice in FIGS. 29A-32I that the at least one or a plurality of universal flexible ultrasonic joints 202^{XI} permits the socket or working end 18d7^{XI} of the horn end 18d^{XI} to pivot in a plurality of planes, such as planes P1 and P2 (FIG. 30A). Although the embodiment shown in FIG. 29D shows only a single pivoting joint 202^{XI}, it should be understood that the horn body 18e^{XI} may have multiple joints 202^{XI}. Details of the at least one or a plurality of universal flexible ultrasonic joints 202^{XI} illustrated in FIGS. 29A-29E will now be described.

In this embodiment, the at least one or a plurality of universal flexible ultrasonic joints 202^{XI} enables maximum pivoting of the horn end 18d^{XI} and substantially simultaneously enables the efficient application or transmission of the ultrasonic energy to pass through the horn 18^{XI}, through the dry connection of the at least one or a plurality of universal flexible ultrasonic joints 202^{XI} and ultimately to the horn end 18d^{XI} and into the fastener 12^{XI}. The inventors have found that by providing a loose pivotal coupling between the horn end 18d^{XI} of the horn body 18e^{XI}, it enables the user to easily place the horn end 18d^{XI} on the fastener head 12a^{XI} of the fastener 12^{XI}.

The at least one or a plurality of flexible universal joints 202^{XI} comprises at least one or a plurality of pivoting knuckles 210^{XI} that pivotably couples the horn end 18d^{XI} to the horn body 18e^{XI} such that the horn end 18d^{XI} can pivot in the plurality of different planes, such as planes P1 and P2. The “loose” coupling provides a predetermined amount of play so that the horn body 18e^{XI} can move and pivot freely, for example, in the first plane P1 (FIG. 29D) and the second plane P2 (FIG. 30B), to permit universal pivoting and increase ultrasonic and acoustic energy transfer through the fastener tool 16^{XI}. Thus, the fastener tool 16^{XI} and system 100^{XI} comprises the at least one or a plurality of universal flexible ultrasonic joints 202^{XI} that provides the pivot coupling for pivotably coupling the horn end 18d^{XI} to the horn body 18e^{XI} such that the socket or working end 18d7^{XI} or horn end 18d^{XI} can pivot in the plurality of different planes. After pivoting and placement of the horn end 18d^{XI} on the fastener 12^{XI}, the fastener tool 16^{XI} may be energized to transmit ultrasonic or acoustic energy into the fastener 12^{XI}.

FIGS. 30A-30H show how the at least one or a plurality of flexible ultrasonic joints 202^{XI} enables the relative pivoting movement of the horn end 18d^{XI} relative to the horn body 18e^{XI}. The pivoting movement is illustrated in FIGS. 30A-30H, with the FIGS. 30A-30E being line drawings and FIGS. 30F-30H, which show the pivoting movement of the horn end 18d^{XI} relative to the horn body 18e^{XI}. The pivoting movement of the horn end 18d^{XI} enables the user to easily and accurately place the socket or working end 18d7^{XI} of the horn end 18d^{XI} onto the head 12a^{XI} of the fastener 12^{XI}. To accomplish this pivoting motion, features of the at least one or a plurality of flexible ultrasonic joints 202^{XI} will now be described.

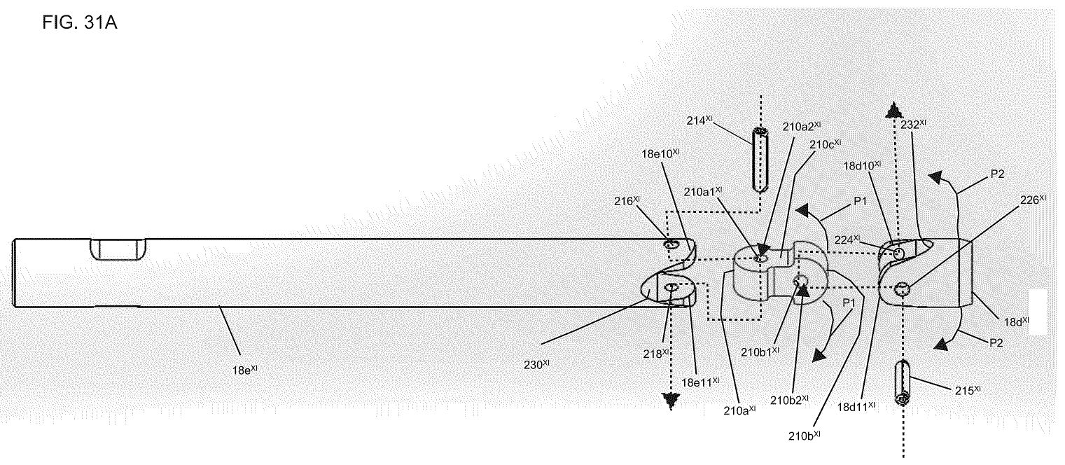

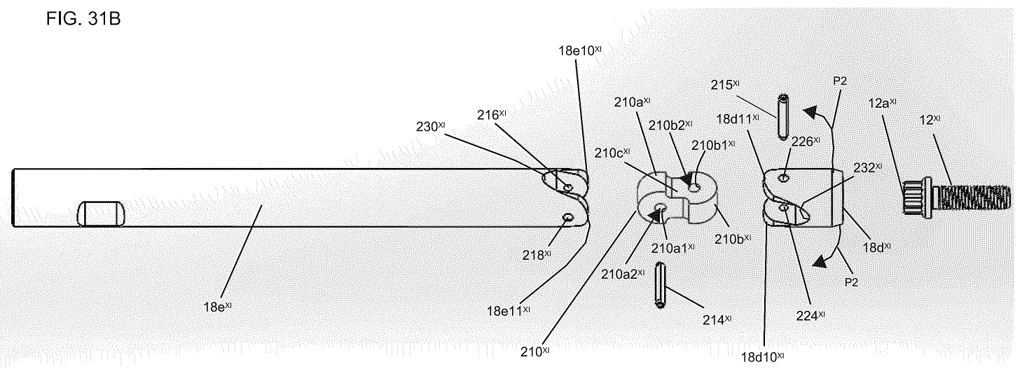

In FIGS. 30A-31F, the horn body 18e^{XI} is shown without other components for ease of illustrating the features of the at least one or plurality of universal flexible ultrasonic joints 202^{XI}. Note that FIGS. 30C and 30D illustrate the horn body 18e^{XI} rotated approximately 90 degrees compared to the horn body 18e^{XI} in FIG. 31B. These figures, as well as FIGS. 30A-30H illustrate the pivotal movement of the horn end 18d^{XI}. Advantageously, the at least one or a plurality of flexible ultrasonic joints 202^{XI} enables the horn end 18d^{XI} to pivot in the plurality of planes, such as planes P1 and P2, so that it can pivot a predetermined angle relative to the axis A of the horn body 18e^{XI}. In one illustrative embodiment, the predetermined angle is in excess of 90 degrees and in one illustrative embodiment, the angle is about 110 degrees (FIG. 29D), but it could be greater or less if desired.

FIGS. 29D, 30A-30B and 30E-30F illustrate the horn end 18d^{XI} and the horn body 18e^{XI} pivoted downward in plane P1 (as viewed in the figures). Note the solid views in FIGS. 30F-30H illustrate the horn body 18e^{XI} pivoting in multiple planes, such as planes P1 and P2 and pivoted to a plurality of positions.

Thus, it should be understood that the at least one or a plurality of flexible ultrasonic joints 202^{XI} is adapted to enable the horn end 18d^{XI} to be pivotally moved in the plurality of planes, such as planes P1 and P2, to be advantageous when the user is using the fastener tool 16^{XI} in a tight compartment or area, such as when repairing a jet engine. FIGS. 30F-30H illustrate the pivoting capability of the horn end 18d^{XI} relative to the horn body 18e^{XI}. Note that the horn end 18d^{XI} can pivot in multiple planes, such as planes P1 and P2, which enables the user to accurately and easily pivot the horn end 18d^{XI} onto the fastener 12^{XI} to be tightened or loosened.

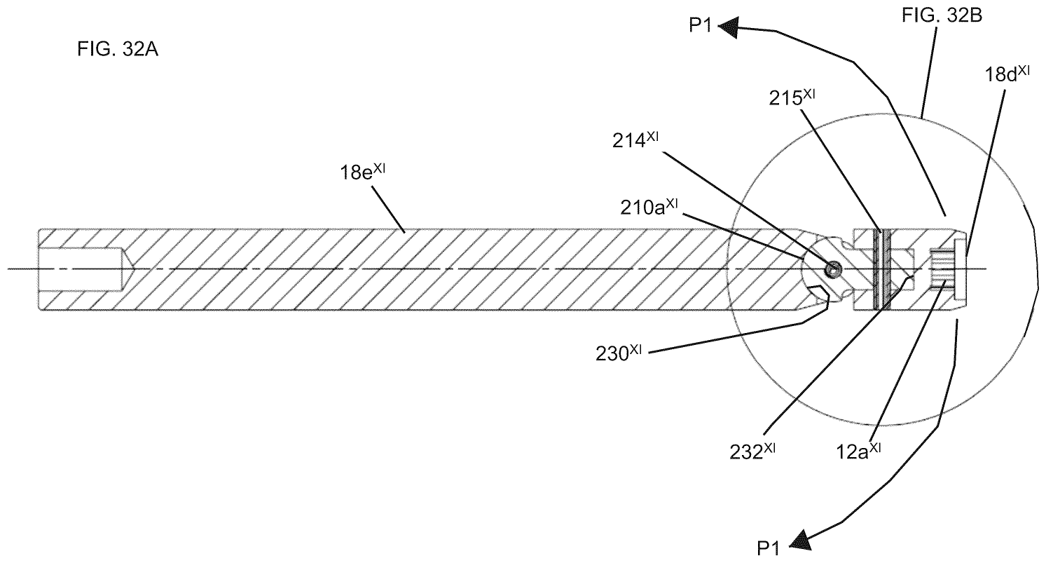

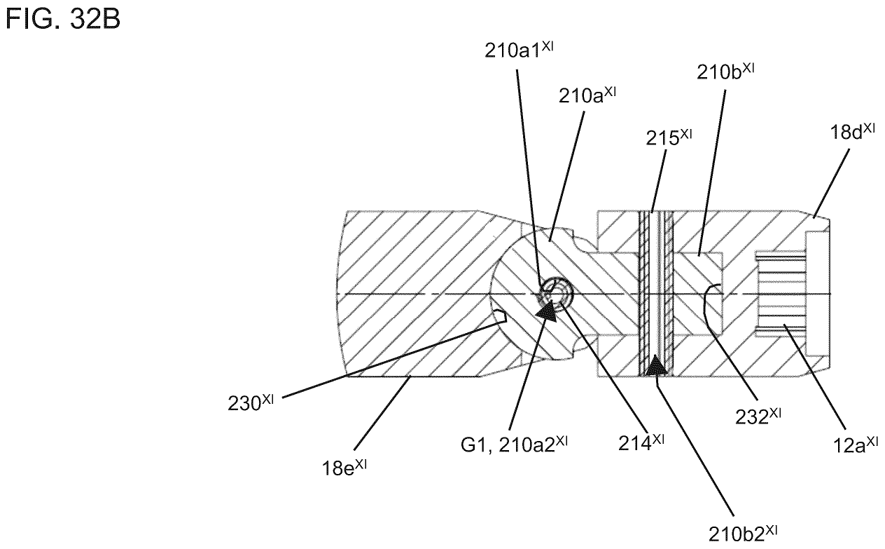

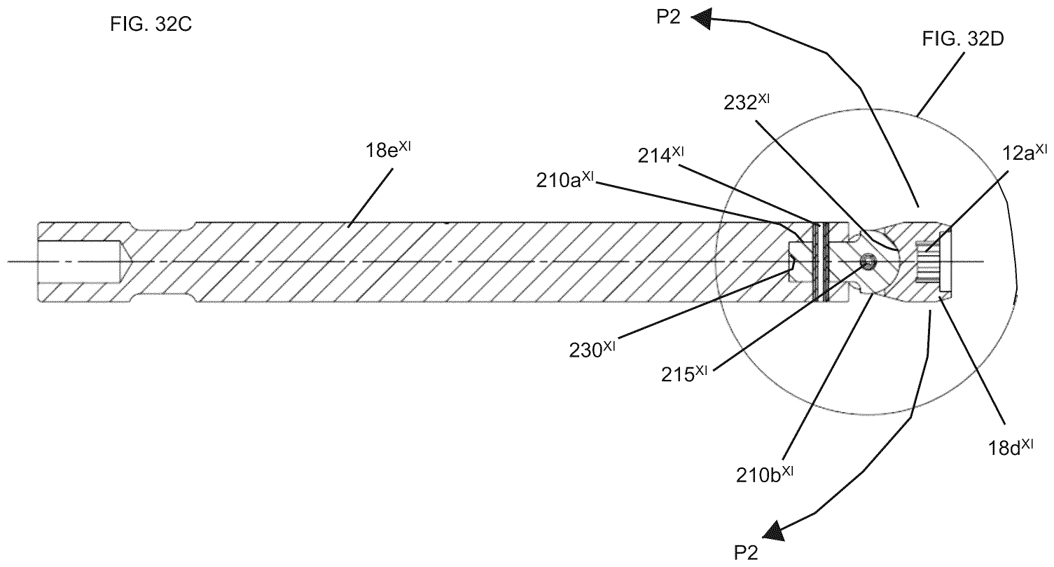

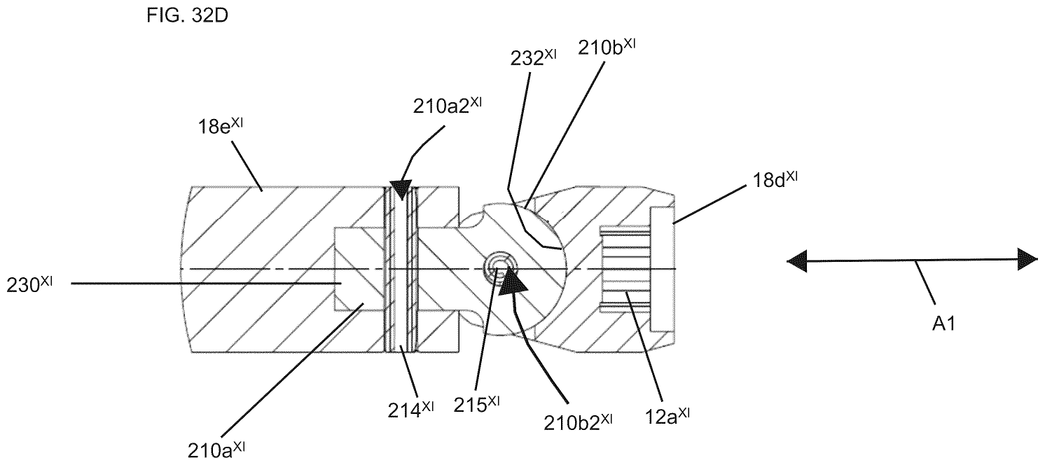

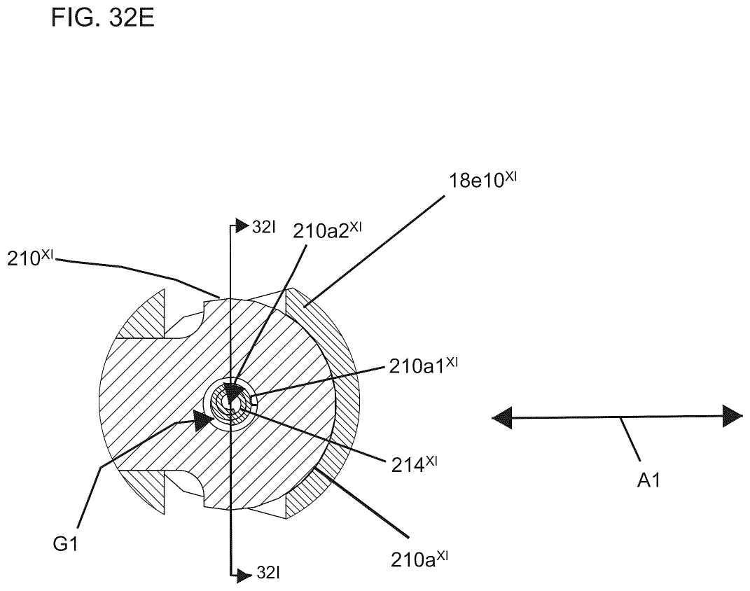

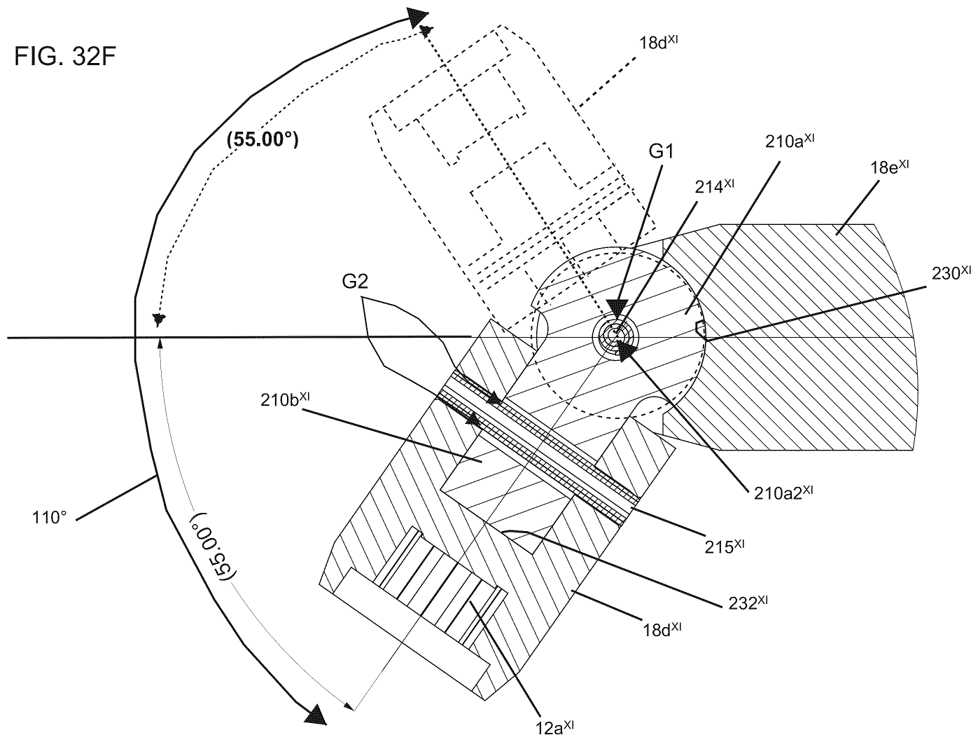

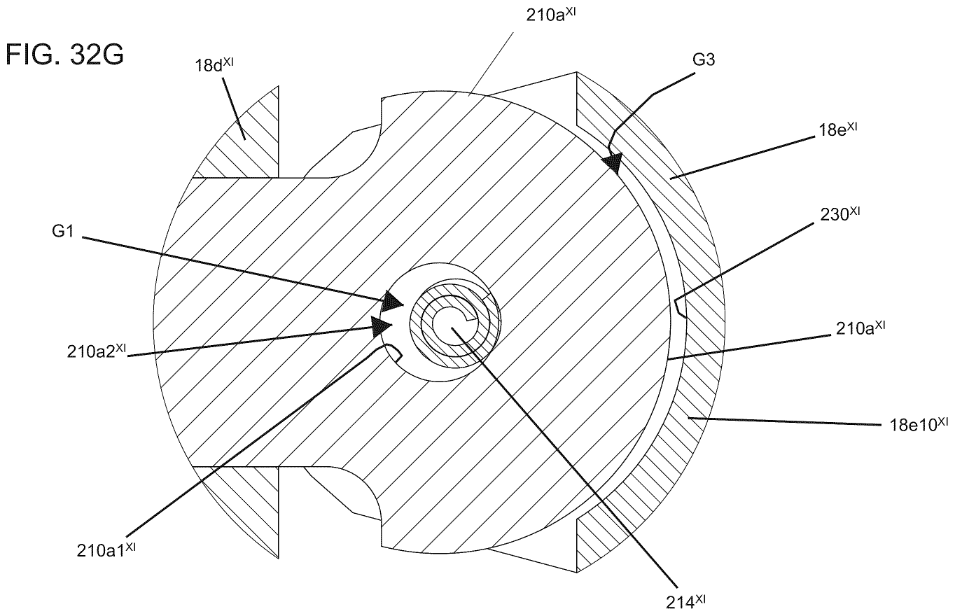

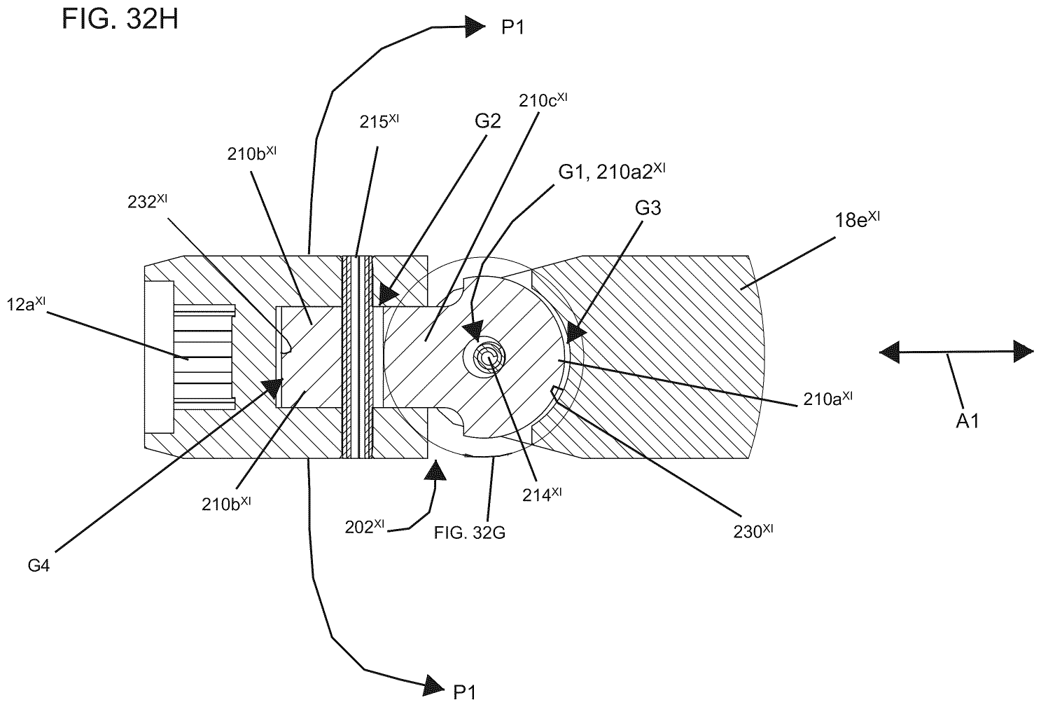

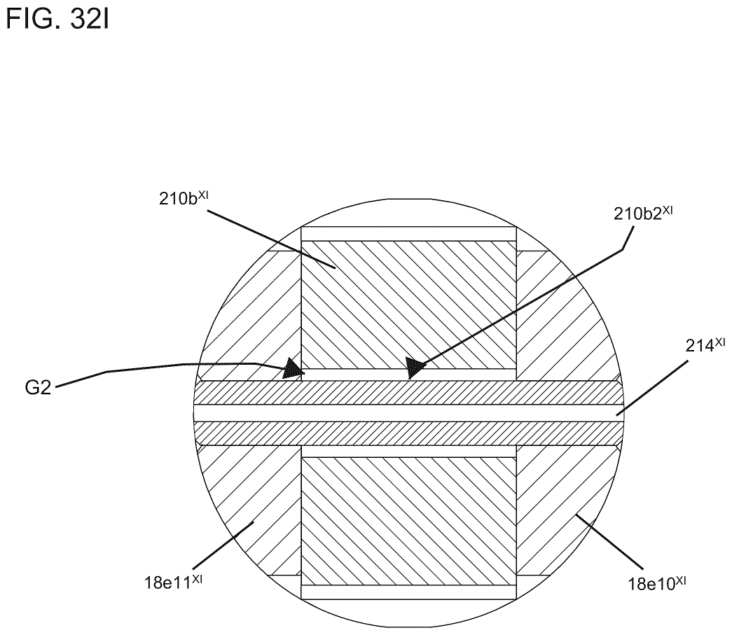

Advantageously, the embodiments of FIGS. 29A-32I utilize the unique universal maximum force pivotal joint 202^{XI} to provide maximum ultrasonic energy transfer through the fastener tool 16^{XI}. This will now be described relative to FIGS. 31A-32I, features and components of the at least one or a plurality of flexible ultrasonic joints 202^{XI} will now be described. Notice in the illustration being described, that the horn body 18e^{XI} and the horn end 18d^{XI} are pivotally coupled by a knuckle 210^{XI} ((FIGS. 29D-29E, 31A-31B). The knuckle 210^{XI} comprises a first knuckle portion 210a^{XI} and a second knuckle portion 210b^{XI}. The first and second knuckle portions 210a^{XI} and 210b^{XI} are joined by a joining portion 210c^{XI} as illustrated. Notice that the knuckle 210^{XI} has a cross-sectional dimension that narrows or is “pinched” at the joining portion 210c^{XI} which permits large pivotal movement of the horn end 18d^{XI} relative to the horn body 18e^{XI}. Each of the knuckle portions 210a^{XI} and 210b^{XI} are generally planar and lie in different planes offset by approximately 90° as shown. Note that each of the knuckle portions 210a^{XI} and 210b^{XI} have a first arcuate engaging or camming surface or wall 210a1^{XI} and a second arcuate engaging or camming surface or wall 210b1^{XI}, respectively, that will be described later herein.

It should be understood that the cross-section dimension of the knuckle portion 210c, horn body and horn end will change depending on the application of the tool. For example, the cross-sectional dimension of the parts of the tool when applied to a jet engine bolt will likely be much greater than a comparable dimension of a tool made and used in an application or environment where the fastener sizes are smaller or larger. The dimension will typically be driven by the application or environment in which the tool is used and the size of the fastener. The first knuckle portion 210a^{XI} of the knuckle 210^{XI} (FIG. 29E) is pivotally coupled to the horn body 18e^{XI} with the first spring pin 214^{XI} (FIG. 31A). In this regard, the horn body 18e^{XI} comprises a first fork or projection 18e10^{XI} and a second fork or projection 18e11^{XI}. The first fork or projection 18e10^{XI} and the second fork or projection 18e11^{XI} have apertures 216^{XI} and 218^{XI}, respectively, that receive and secure the spring pin 214^{XI} therebetween. It should be appreciated that the first knuckle portion 210a^{XI} of the knuckle 210^{XI} has the first arcuate engaging or camming surface or wall 210a1^{XI} and an aperture 210a2^{XI}. The diameter defined by the first arcuate engaging or camming surface or wall 210a1^{XI} and the size of the aperture 210a2^{XI} is selected and sized to comprise a predetermined amount of play and movement so that it can permit the horn body 18e^{XI} to move and not be rigidly locked to the knuckle 210^{XI}. The spring pin 214^{XI} is press-fit into the apertures 216^{XI} and 218^{XI} and through the aperture 210a2^{XI} of the first knuckle portion 210a^{XI} defined by the arcuate engaging or camming surface or wall 210a1^{XI} in the knuckle 210^{XI} to pivotally and loosely secure the knuckle 210^{XI} to the horn body 18e^{XI}. Features of the play and pivotal movement will be described later herein.

Similarly, the horn end 18d^{XI} has a first fork or projection 18d10^{XI} with a first aperture 224^{XI} and a second fork or projection 18d11^{XI} with a second aperture 226^{XI} that are sized and adapted to receive a second spring pin 215^{XI} that is press-fit into the first and second apertures 224^{XI} and 226^{XI}.

The second knuckle portion 210b^{XI} of the knuckle 210^{XI} has an aperture 210b2^{XI} that becomes situated between the apertures 224^{XI} and 226^{XI} and receives the spring pin 215^{XI} to loosely couple the second knuckle portion 210b^{XI} therebetween.

As mentioned earlier, it should be appreciated that the apertures 210a2^{XI} and 210b2^{XI} of the first knuckle portion 210a^{XI} and the second knuckle portion 210b^{XI}, respectively, are sized and adapted to be slightly larger than the diameter of the spring pins 214^{XI} and 215^{XI}, respectively, after the are mounted in the horn end 18d^{XI} and horn body 18e^{XI}. This is illustrated in FIGS. 32A-32I.

The horn body 18e^{XI}, horn end 18d^{XI} and knuckle 210^{XI} are assembled so that the spring pins 214^{XI} and 215^{XI} loosely secure the knuckle 210^{XI} therebetween. FIGS. 31A-32I illustrate further details of the assembled fastener tool 16^{XI}. Notice in FIG. 31A that the knuckle 210^{XI} pivotally couples the horn end 18d^{XI} to the horn body 18e^{XI} and the spring pins 214^{XI} and 215^{XI} are used to loosely secure the first knuckle portion 210a^{XI} to the horn body 18e^{XI} and the second knuckle portion 210b^{XI} to the horn end 18d^{XI}. Notice that because the diameter of the apertures 224^{XI} and 226^{XI} is slightly larger than the diameter of the spring pins 214^{XI} and 215^{XI} as illustrated in FIGS. 31A and 31B, the horn body 18e^{XI} becomes loosely secured to the horn end 18d^{XI}.

Referring now to FIGS. 32A-32D, various cross sections of the assembled fastener tool 16^{XI} show further details of the at least one or a plurality of flexible ultrasonic joints 202^{XI}. Notice in FIG. 31A that the horn body 18e^{XI} comprises the pair of forks or projections 18e10^{XI} and 18e11^{XI} between which the first knuckle portion 210a^{XI} is received and mounted. Notice in FIGS. 32A-32B that the horn body 18e^{XI} comprises the arcuate engaging or camming surface 230^{XI} that is engaged by and receives the complementary shaped arcuate engaging or camming surface or wall 210a1^{XI} of the first knuckle portion 210a^{XI} of the knuckle 210^{XI} (FIG. 32B). Likewise, the horn end 18d^{XI} comprises an arcuate engaging or camming surface 232^{XI} (FIGS. 32C-32D) that mates with the arcuate engaging or camming surface or wall 210b1^{XI} as illustrated in FIGS. 32B-32D. Notice in FIGS. 32E and 32F that because the spring pin 214^{XI} is slightly smaller than the diameter of the aperture 210a2^{XI} (FIG. 32E), a play gap G1 (FIG. 32E) is created. Likewise, note in the horn end 18d^{XI} that a similar play gap G2 is created between the arcuate engaging or camming surface or wall 210b1^{XI} (FIG. 32E) and the spring pin 215^{XI} as illustrated in FIGS. 31A-31G and 32D-32F. The gap G2 (FIG. 32F) between the spring pin 215^{XI} permits the horn end 18d^{XI} an amount of play in the direction of double arrow A1 (FIG. 32D). The gap G1 between the spring pin 214xl and the first arcuate engaging or camming surface or wall 210a1^{XI} of the knuckle 210^{XI} permits a predetermined amount of play in the direction of double arrow A1. The amount of play and free movement provided by the gaps G1 and G2 permit the horn end 18d^{XI} to freely pivot and move relative to the horn body 18e^{XI}, which enables a user to easily and accurately place the horn end 18d^{XI} on the head 12a^{XI} of the fastener 12^{XI}.

Regarding FIG. 32E, the at least one or a plurality of flexible ultrasonic joints 202 is engaged and placed at 0.004 oversize in relation to the spring pin 214^{XI} to maximize the radial mating surface contact and increase the ultrasonic output when a downward or axial movement or pressure is applied to the knuckle 210^{XI} during use.

Several views in FIGS. 31A-32F illustrate the fastener tool 16^{XI} after the horn body 18e^{XI} and horn end 18d^{XI} are engaged and an ultrasonic or acoustic energy is ready to be passed therethrough. When engaged, the engaging camming surface or wall 210a1^{XI} of the first knuckle portion 210a^{XI} and the arcuate engaging or camming surface 230^{XI}, as well as the engaging or camming surface or wall 210b1^{XI} of the second knuckle portion 210b^{XI} engages the arcuate engaging or camming surface 232^{XI} and are in direct “dry” contact and engagement when the fastener tool 16^{XI} is energized. In contrast, note in FIGS. 32G and 32H, that during placement of the fastener tool 16^{XI} by the user, gaps G1, G2, G3 and G4 (FIGS. 32G and 32H) permit the horn end 18d^{XI}, horn body 18e^{XI} and knuckle 210^{XI} to move axially forward and away from each other in the direction of double arrow A1 in FIG. 32H. This design and freedom of movement generates the plurality of gaps or areas of play G1-G4 (FIG. 32H) that permit these components to freely move relative to each other before the ultrasonic or acoustic energy is applied. After the user positions the horn end 18d^{XI} onto the head 12a^{XI} of the fastener 12^{XI}, the working or engaging surfaces of the components are forced together and into engagement by the user such that the gaps G3 and G4 are eliminated and so that the first arcuate engaging or camming surface or wall 210a1^{XI} is in direct contact and engagement with arcuate engaging or camming surface 230^{XI} and the second arcuate engaging or camming surface or wall 210b1^{XI} comes into direct engagement with the arcuate engaging or camming surface 232^{XI} as best illustrated in FIGS. 32A-32F. Notice in FIG. 32G that during placement of the fastener tool 16^{XI}, the spring pin 214^{XI} will typically not be centered in the aperture 210a2^{XI} as illustrated in FIG. 32G. Notice also in FIG. 32G that the spring pin 214^{XI} is sized and dimensioned to be smaller than the aperture 210a2^{XI} defined by the first arcuate engaging or camming surface or wall 210a1^{XI} so that the gap G1 is created. This gap G1 is further illustrated in FIG. 32H. As mentioned earlier herein, the gaps G1-G4 permit a predetermined or reasonable amount of play which enables the user to easily and accurately position the horn end 18d^{XI} on the fastener 12^{XI}.

The spring pin 215^{XI} is slightly smaller than the diameter of the aperture 210b2^{XI} that is defined by arcuate engaging or camming surface or wall 210b1^{XI} which permits the knuckle 210^{XI} to move relative to the horn body 18e^{XI} and along an axis thereof. Notice that the predetermined amount of play also provides a gap, spacing or area of play G1-G4, such as G3 between the knuckle 210^{XI} and the arcuate engaging or camming surface 230^{XI} in the horn body 18e^{XI}. As mentioned earlier, the second knuckle portion 210b^{XI} has the arcuate engaging or camming surface or wall 210b1^{XI} that is adapted to come into contact with the arcuate engaging or camming surface 232^{XI} defined in the horn end 18d^{XI}.

During use and after the components of the horn end 18d^{XI}, the horn body 18e^{XI} and knuckle 210^{XI} are coupled or assembled together, the fastener tool 16^{XI} may be used in a working environment. In this regard, the horn end 18d^{XI} pivots freely in the plurality of planes, such as planes P1 and P2, illustrated in FIGS. 30A-30H during placement of the horn onto the head 12a^{XI} of the fastener 12^{XI} during fastening or loosening of the fastener 12^{XI}. During placement, the gaps G1-G4 do not permit the ultrasonic or acoustic energy to be transmitted through the fastener tool 16^{XI}, through the horn 18^{XI}, horn end 18d^{XI} and to the fastener 12^{XI} because the gaps G1-G4 interrupt the transmission of the ultrasonic or acoustic energy. However, once the horn end 18d^{XI} is situated on the head 12a^{XI} of the fastener 12^{XI}, the gaps G1-G4 can be eliminated by simply moving the horn body 18e^{XI} toward the horn end 18d^{XI} which closes the gaps G1-G4 as illustrated in FIGS. 31A-32F. Again, notice FIG. 32F shows the gaps G1 and G2 shown in FIGS. 32G-32H have all been eliminated so that there is direct contact and engagement between the arcuate engaging or camming surface 230^{XI} of the horn body 18e^{XI} and the first arcuate engaging or camming surface or wall 210a1^{XI} of the first knuckle portion 210a^{XI} as well as the arcuate engaging or camming surface or wall 210b1^{XI} of the second knuckle portion 210b^{XI} and its engagement with the arcuate engaging or camming surface 232^{XI} in the horn end 18d^{XI}. Notice in FIGS. 32A-32F that all of the gaps G1-G4 are eliminated and that the knuckle 210^{XI} provides direct contact and mechanical engagement with both the horn body 18e^{XI} and the horn end 18d^{XI} as illustrated. When the user applies the force to cause the components to engage as shown, the ultrasonic generator 14^{XI} can be energized to generate the ultrasonic or acoustic energy which passes through the horn body 18e^{XI}, through the knuckle 210^{XI}, into the horn end 18d^{XI} and into the fastener 12^{XI} in the manner described earlier herein relative to all other embodiments. FIG. 32I illustrates a close-up view of the knuckle 210^{XI} and the spring pin 214^{XI} fitment.

As shown in FIGS. 31A-32I, the first and second arcuate engaging or camming surfaces or walls 210a1^{XI} and 210b1^{XI} are generally arcuate and cam or ride against mating or complementary-shaped arcuate engaging or camming surfaces 230^{XI} and 232^{XI}, respectively. In this regard, notice that the horn body 18e^{XI} and horn end 18d^{XI} comprise the arcuate engaging or camming surface 230^{XI} (FIG. 32H) and the first knuckle portion 210a^{XI} comprises the first arcuate engaging or camming surface or wall 210a1^{XI}. Likewise, the second knuckle portion 210b^{XI} comprises the second arcuate engaging or camming surface or wall 210b1^{XI} which is also arcuate and has a shape which generally complements and mates with the arcuate engaging or camming surface 232^{XI} of the knuckle 210^{XI}. Because the knuckle portions 210a^{XI} and 210b^{XI} are offset by approximately 90 degrees, the horn end 18d^{XI} may pivot and travel in the plurality of different planes so that the horn end 18d^{XI} can be easily placed onto a fastener 12^{XI}.

### ADDITIONAL CONSIDERATIONS

Advantageously, one embodiment of this invention is that it removes the risk of breaking bolts; reduced manual labor; and reduced skilled labor. In other words, one would not need to be a skilled machinist to extract bolts, which would reduce overall maintenance time.

Advantageously, one embodiment of this invention facilitates eliminating the need to drill out broken bolts and reduces risk of damage to engines/other components, which also removes the possibility for debris to fall into the engine or undesirable locations through a drilled through hole.

The fastener tool 16, 16′, 16″, 16′″, 16^{XI} may comprise a transducer that is directly connected to the ultrasonic generator 14, 14′, 14″, 14′″, 14^{XI} and a booster (not shown). The horns 18, 18′, 18″, 18′″, 18^{XI} are screwed directly into the booster so that the horn 18, 18′, 18″, 18′″, 18^{XI} may be directly coupled to the transducer, which may or may not have a booster installed. The Dukane device referenced earlier herein may facilitate such coupling and operation.

It should be understood that the bolt head 12a1, 12a1′, 12a1″, 12a1′″, 12a1^{XI} may comprise any predetermined shape adapted or capable of transferring ultrasonic energy and/or receiving a complementary shaped socket for rotatably driving the fastener 12, 12′, 12″, 12′″, 12^{XI}. Thus, the fastener tool 16, 16′, 16″, 16′″, 16^{XI} is adapted to accommodate any polygonal or other head shape.

Thus, it should be appreciated that the fastener tool 16, 16′, 16″, 16′″, 16^{XI} may comprise a transducer that may comprise a booster with the armature 16a, 16a′, 16a″, 16a′″, 16a^{XI}. The booster is typically installed to boost the amplitude ˜2.5× but the transducer can operate also without the booster.

As mentioned earlier herein, it should be understood that the cross-section dimension of the knuckle portion 210c, horn body and horn end will change depending on the application of the tool. For example, the cross-sectional dimension of the parts of the tool when applied to a jet engine bolt will likely be much different than a comparable dimension of a tool made and used in an application or environment where the fastener sizes are smaller or larger. The dimension will typically be driven by the application or environment in which the tool is used and the size of the fastener. The arcuate engaging or camming surfaces 230^{XI} and 232^{XI} are also arcuately shaped and have a generally complementary radius. This provides direct mating engagement between and among the components so that the acoustic or ultrasonic energy can be efficiently transferred to the horn end 18d^{XI}. The knuckle 210^{XI} is manufactured from materials suitable for ultrasonic energy transfer. One suitable material is titanium. As mentioned earlier, a lubrication (not shown) may be added to the ultrasonic joint 202 to facilitate ultrasonic transfer and preventing seizing. Note that the knuckle 210^{XI} has the arcuate engaging or camming surfaces or walls 210a1^{XI} and 210b1^{XI} that permit the horn 18^{XI} to pivot approximately 110 degrees about the axis of the tool 16^{XI}. The arcuate engaging or camming surfaces or walls 210a1^{XI} and 210b1^{XI} may have other defined radii and have surface lengths along their arcuate portions that are either shorter or longer. Note that the joining portion 210c^{XI} of the knuckle 210^{XI} may be dimensioned and sized to permit greater or lesser pivotal movement by the horn end 18d^{XI}. For example, the joining portion 210c^{XI} may have a dimension that is “pinched” or narrowed further so that a pivoting angle of greater than 110 degrees can be achieved. Alternatively, the joining portion 210c^{XI} may be enlarged which may cause a reduction in the pivot angle. The important thing to note is that the knuckle 210^{XI} is adapted to permit the horn end 18d^{XI} to pivot in a plurality of different planes while permitting the horn end 18d^{XI} to be loosely coupled to the horn body 18e^{XI} for ease of placement of the horn end 18d^{XI} onto the head 12a^{XI} of the fastener 12^{XI}.

It should be understood that a distance BETWEEN the apertures in the first knuckle portion 210a^{XI} and the second knuckle portion 210b^{XI} facilitate universal pivotal movement in multiple planes and enable the horn end 18d^{XI} to have a shorter axial dimension. Notice that the horn end 18d^{XI} in the embodiment being described is shorter when compared to the horn end and tips/sockets in the prior embodiments.

The first and second knuckle portions 210a^{XI} and 210b^{XI} are offset along their axis by approximately 90 degrees; however, they could be offset by greater or fewer than 90 degrees if desired.

It should be appreciated that the arcuate engaging or camming surfaces or walls 210a1^{XI} and 210b1^{XI} cooperate with the arcuate engaging or camming surface 230^{XI} and 232^{XI}, respectively, during use. It has been found that over time these surfaces cooperate to smooth or hone themselves, which further facilitates the transmission of the ultrasonic or acoustic energy through the horn end 18d^{XI}.

Advantageously, another embodiment of this invention, including all embodiments shown and described herein, could be used alone or together and/or in combination with one or more of the features covered by one or more of the claims set forth herein, including but not limited to one or more of the features or steps mentioned in the Summary of the Invention and the claims.

While the system, apparatus and method herein described constitute preferred embodiments of this invention, it is to be understood that the invention is not limited to this precise system, apparatus and method, and that changes may be made therein without departing from the scope of the invention which is defined in the appended claims.

What is claimed is:

1. A fastener tool for loosening or tightening a fastener mounted on a structure, said fastener tool comprising:
a horn adapted and sized to apply an acoustic or ultrasonic energy into said fastener said horn having a horn body and horn end; and an acoustic/ultrasonic generator for generating said acoustic or ultrasonic energy that passes through said horn and into said fastener to facilitate fastening or loosening said fastener; and a universal pivot joint coupling said horn body to said horn end, said universal pivot joint enabling said horn end to move freely and pivot in a plurality of predetermined planes wherein said horn end and said horn body have axes that are not co-axial during positioning of the tool, and after placement of the horn end on said fastener, said acoustic/ultrasonic generator may apply said acoustic or ultrasonic energy through the horn body, directly through said universal pivot joint, through said horn end and into said fastener;
said horn focusing or applying said acoustic or ultrasonic energy a predetermined distance into said fastener in order to reduce a coefficient of friction between said fastener and said structure when said horn is in operative relationship with fastener and acoustic or ultrasonic energy is applied thereto.

2. The fastener tool as recited in claim 1 wherein said universal pivot joint comprises:
a knuckle having a first portion and a second portion;
said first portion having a first aperture and said second portion having a second aperture;
said first portion being pivotally coupled to said horn body with a first pivot pin;
said second portion being pivotally coupled to said horn end with a second pivot pin.

3. The fastener tool as recited in claim 2 wherein said first and second apertures are larger than a diameter or dimension of said first pivot pin and said second pivot pin, respectively, thereby permitting the loose coupling between said horn body and said horn end to facilitate the user's pivoting and placement of the horn end onto the fastener.

4. The fastener tool as recited in claim 2 wherein said first pivot pin and said second pivot pin is a spring pin adapted to be secured to said horn body and passing through said first aperture to pivotally support said first portion on said horn body; said second pivot pin and said second pivot pin is a spring pin adapted to be secured to said horn end and passing through said second aperture to pivotally support said second portion on said horn end; said first and second apertures permitting said knuckle to float or move freely to facilitate placement of said horn end on said fastener, said knuckle becoming locked into energizing engagement with both said horn body and said horn end so that ultrasonic and acoustic energy can be passed therethrough after placement of the horn end on the fastener.

5. The fastener tool as recited in claim 3 wherein said first portion is offset a predetermined offset angle relative to said second portion.

6. The fastener tool as recited in claim 5 wherein said predetermined offset angle is about 90 degrees.

7. The fastener tool as recited in claim 2 wherein said horn body has a horn body camming or engaging surface that generally compliments a first portion camming or engaging surface on said knuckle and said horn end has a horn end camming or engaging surface that generally compliments a second portion camming or engaging surface on said knuckle.

8. The fastener tool as recited in claim 7 wherein a camming or engaging surface of said horn body cams or engages a camming or engaging surface of said first portion and a camming or engaging surface of said horn end cams or engages a camming or engaging surface of said second portion with a tolerance of less than about 0.0005 inch.

9. The fastener tool as recited in claim 8 wherein during placement of said horn end, said camming or engaging surface of said horn body does not cam or engage said camming or engaging surface of said first portion and said camming or engaging surface of said horn end does not cam or engage said camming or engaging surface of said second portion with a tolerance of less than about 0.0005 inch.

10. The fastener tool as recited in claim 8 wherein said horn body camming or engaging surface cooperates with said first portion camming or engaging surface to hone such said horn body camming or engaging surface and said first portion camming or engaging surface; horn end camming or engaging surface cooperates with said second portion camming or engaging surface to hone such said horn end camming or engaging surface and said second portion camming or engaging surface.

11. The fastener tool as recited in claim 2 wherein said horn body, said horn end and said knuckle comprises material that is normalized at least once to facilitate orienting a grain to a predetermined grain pattern. such that said grain flows generally coaxially within said horn.

12. The fastener tool as recited in claim 2 wherein said knuckle permits said horn end to pivot a predetermined maximum pivot angle relative to sad horn body, said predetermined maximum pivot angle is greater than 90 degrees.

13. The fastener tool as recited in claim 12 wherein said predetermined maximum pivot angle is at least 110 degrees or more.

14. The fastener tool as recited in claim 1 wherein said fastener tool comprises a rotational torque applicator for applying a rotational torque to said fastener while said ultrasonic or acoustic energy passes into said fastener; wherein said rotational torque is at least one of mechanical torque or an acoustic/ultrasonic torque that is applied substantially simultaneously as said horn causes said acoustic or ultrasonic energy to pass into said fastener.

15. The fastener tool as recited in claim 14 wherein said horn is adapted to apply said rotational torque substantially simultaneously as said ultrasonic or acoustic energy passes into said fastener.

16. The fastener tool as recited in claim 1 wherein said horn end comprises a socket, screwdriver bit, and/or torque bit sized and adapted to receive a head and/or nut of said fastener.

17. The fastener tool as recited in claim 1 wherein said fastener comprises a head and/or nut, said ultrasonic or acoustic energy being at a predetermined location being along a length of said fastener so that when said ultrasonic or acoustic energy is applied to said fastener, a friction or pressure between the head and/or nut mating surfaces and mating thread surfaces between said fastener and said structure is at least partly reduced.

18. The fastener tool as recited in claim 17 wherein the fastener comprises threads that mate with mating threads at a thread-engagement location, said the predetermined location to be between the head and/or nut and its mating structure surface(s) along with the mating threads of the fastener and structure(s).

19. The fastener tool as recited in claim 18 wherein said the predetermined location is between the head and/or nut and its mating structure surface(s) along with the mating threads of the fastener and structure(s).

20. The fastener tool as recited in claim 18 wherein said predetermined location is between said head and/or nut and a distal end of the bolt, and a first thread of mating female threads.

21. The fastener tool as recited in claim 1 wherein said tool comprises a housing, said acoustic/ultrasonic generator is situated inside said housing.

22. The fastener tool as recited in claim 1 wherein said fastener has a head and/or nut, said horn being adapted and sized to receive or engage said head and/or nut to apply a tightening or loosening torque to said head and/or nut when said acoustic or ultrasonic energy passes therethrough.

23. The fastener tool as recited in claim 22 wherein said horn comprises a socket, screwdriver bit, and/or torque bit tip that is sized and adapted to engage said head and/or nut and apply a rotational torque when said ultrasonic or acoustic energy passes into said fastener.

24. The fastener tool as recited in claim 1 wherein said fastener tool comprises a plurality of horns that are sized and adapted for a plurality of fasteners that have a plurality of heads, respectively, of different shapes or sizes.

25. The fastener tool as recited in claim 1 wherein said fastener tool comprises a plurality of horns that are sized and adapted for a plurality of fasteners that have a plurality of heads, respectively, of different shapes or sizes.

26. The fastener tool as recited in claim 1 wherein said horn end is configured or adapted to receive a plurality of sockets, screwdriver bits, and/or torque bit tips of different sizes so that said horn may be used to apply said ultrasonic or acoustic energy directly into and through said socket, screwdriver bit, and/or torque bit tip and into said fastener when said fastener is being tightened or loosened.

27. The fastener tool as recited in claim 1 wherein said horn body comprises:
at least one replaceable tip that is removably coupled to said horn body.

28. The fastener tool as recited in claim 1 wherein said fastener tool comprises a plurality of interchangeable or replaceable tips of different shapes or sizes to accommodate fasteners of different shapes or sizes, respectively, at least one interchangeable or replaceable tip being selected from said plurality of interchangeable or replaceable tips.

29. The fastener tool as recited in claim 3 wherein said horn body comprises a plurality of replaceable tips to accommodate fasteners of different sizes.

30. The fastener tool as recited in claim 29 wherein said horn body is threaded and at least one of said plurality of replaceable tips comprises mating threads, a thread direction of threads of said horn body being a direction opposite a thread direction of threads of said fastener.

31. The fastener tool as recited in claim 29 wherein said horn body is threaded and at least one of said plurality of replaceable tips comprises mating threads, mating thread on the horn being of a larger diameter than the mating threads on said fastener.

32. The fastener tool as recited in claim 28 wherein at least one of said plurality of interchangeable or replaceable tips comprises a generally optimized geometry and or flat fastener-engaging surface.

33. The fastener tool as recited in claim 28 wherein at least one of said plurality of interchangeable or replaceable tips is adapted to cause said acoustic or ultrasonic energy to cause a vortex or helical energy to be applied internally to said fastener, said vortex or helical energy being in a predetermined direction.

34. The fastener tool as recited in claim 33 wherein said predetermined direction is at least one of opposite a thread direction of threads on said fastener when loosening said fastener or said thread direction is the same as thread direction of threads when it is desired to tighten said fastener.

35. The fastener tool as recited in claim 1 wherein said horn end comprises a helical or frusto-conical surface for engaging said fastener to apply a longitudinal signal during loosening or tightening of said fastener.

36. The fastener tool as recited in claim 1 wherein said acoustic/ultrasonic generator applies said ultrasonic or acoustic energy at a frequency equal to or larger than 1 kHz.

37. A system for rotating a fastener that is fastened to a structure; said system comprising:
an acoustic/ultrasonic wave generator for generating an acoustic/ultrasonic signal that passes longitudinally through said fastener to elongate said fastener and to introduce a cyclic strain and heating within said fastener to reduce a frictional force between threads on said fastener and mating threads on said structure;
a tool having a horn for transmitting said acoustic/ultrasonic signal into said fastener; a universal pivot joint coupling a horn body to a horn end, said universal pivot joint enabling said horn end to move freely and pivot in a plurality of predetermined planes wherein said horn end and said horn body have axes that are not co-axial during positioning of the tool, and after placement of the horn end on said fastener, said acoustic/ultrasonic generator may apply said acoustic/ultrasonic signal through the horn body, directly through said universal pivot joint, through said horn end and into said fastener;
wherein said acoustic/ultrasonic wave generator and said horn cooperate to focus or apply said acoustic/ultrasonic signal to a predetermined distance into said fastener in order to reduce a coefficient of friction between said fastener and said structure when said horn is in operative relationship with fastener and said acoustic/ultrasonic signal is applied thereto.

38. A fastener tool for loosening or tightening a fastener mounted on a structure, said fastener tool comprising:
a tool body having a horn adapted and sized to apply an acoustic or ultrasonic energy into said fastener; and
an acoustic/ultrasonic generator for generating said acoustic or ultrasonic energy that passes through said horn and into the fastener to facilitate fastening or loosening said fastener;
said horn comprising a horn end, a horn body and a universal joint for pivotally joining said horn end and said horn body together such that said horn end and said horn body can be manipulated or moved independently of each other and into different planes to define at least one predetermined angle between said horn end and said horn body and said horn end having a working end for receiving a portion of said fastener;
said universal joint comprising a pivot coupling for pivotally coupling a first knuckle portion of at least one knuckle to said horn body and pivotally coupling a second knuckle portion of said at least one knuckle to said horn end, said pivot coupling having at least one knuckle comprising a first knuckle portion having a first camming surface, a second knuckle portion having a second camming surface and a joining portion joining said first and second knuckle portions, said first knuckle portion lying in a first plane and said second knuckle portion lying in a second plane, said first and second planes being generally offset or not coplanar with respect to each other by a predetermined offset amount;
said pivot coupling causing said first camming surface of said horn end to become situated in operative relationship or engagement with said first camming surface of said first knuckle portion, said pivot coupling simultaneously causing said second camming surface of said horn end to become situated in operative relationship or engagement with said horn end;
said pivot coupling enabling or providing a predetermined amount of play or clearance for permitting said at least one knuckle to float and move freely so that said working end can pivot and move in a plurality of different planes during placement of said horn end on the fastener to be tightened or loosened and also permitting said first bearing surface to engage said first camming surface of said horn body and said second bearing surface to engage said horn body when said acoustic/ultrasonic generator is energized to apply ultrasonic energy to the horn body, said ultrasonic energy being transferred through said horn end, through said at least one knuckle, through said horn end, through said working end and into said fastener.

39. A knuckle for use in a tool for loosening or fastening parts using an ultrasonic or acoustic energy; said knuckle comprising:
a first planar portion having a first aperture for receiving a first pivot pin in the tool;
a second planar portion having a second aperture for receiving a second pivot pin in the tool; and
a joining portion joining said first planar portion to said second planar portion;
wherein said first and second planar portions are offset by a predetermined angle relative to each other and said joining portion has cross section smaller than a cross section of at least a portion of both said first and second portion.

40. The knuckle as recited in claim 39 wherein said predetermined angle is at least 90 degrees.
